(19) United States
(12) Patent Application Publication
(10) Pub. No.: US 2023/0002540 A1
(43) Pub. Date: Jan. 5, 2023

(54) FOAMED POLYURETHANE COMPOSITIONS

(71) Applicant: Presidium USA, Inc, Dover, DE (US)

(72) Inventors: Brett Tyler Sherren, Kitchener (CA); Benjamin G. Freestone, Gloucester (CA); Mark Paul Kujawski, New York, NY (US); Natalie Roby, New York, NY (US); Michael Jeffrey Krause, London, Ontario (CA); Andrew John Tennant, Burlington (CA)

(21) Appl. No.: 17/779,939

(22) PCT Filed: Nov. 23, 2020
(86) PCT No.: PCT/US2020/061747

§ 371 Date: May 25, 2022

Related U.S. Application Data
(60) Provisional application No. 63/116,490, filed on Nov. 20, 2020.
(60) Provisional application No. 63/017,222, filed on Apr. 29, 2020.
(60) Provisional application No. 62/941,244, filed on Nov. 27, 2019.

(51) Int. Cl. C08G 18/08; C08G 18/12; C08G 18/32; C08G 18/28; C08J 9/12; C08J 9/14; C08G 18/61; C08G 18/48

(52) U.S. Cl. CPC C08G 18/14; C08G 18/12; C08G 18/3218; C08G 18/2815; C08J 9/125; C08J 9/142; C08G 18/61; C08G 18/4833; C08G 2101/00

(57) ABSTRACT

Disclosed are low-viscosity foamable polyurethane-forming compositions containing a polyol composition having monomeric and higher polyol components and optionally a polyhydroxylated aromatic compound; a polyisocyanate or latent polyisocyanate component or a combination thereof; a blowing agent; and optionally a cyclic carbonate having one or more hydroxyl groups. The monomeric and higher polyols each contain three or more hydroxyl groups, the higher polyol containing residues of the monomeric polyol and optionally residues of the polyhydroxylated aromatic compound, the residues being linked by one or more carbonate and/or ether groups. The Disclosed foamable polyurethane-forming compositions may contain the polyol compositions disclosed; an isocyanate functional component; and a blowing agent. The foamable compositions afford high strength, heat-resistant, low to moderate density foamed-polyurethane compositions useful in a variety of applications including construction, vehicle and packaging applications.

### FIELD

This disclosure relates to polyurethane compositions useful in a variety of modern commercial and scientific applications. In particular, this disclosure relates to foamable and foamed polyurethane compositions having outstanding manufacturability and superior physical properties.

### BACKGROUND

Polyurethane foams are important industrial polymeric materials used in a wide variety of applications and include both rigid and flexible foams. Such foams have many desirable properties such as low thermal conductivity and good load-bearing properties at low densities. The density of a polyurethane foam is a variable which may control the mechanical properties of such foam. Substantial effort has been expended to discover novel foamed polyurethane compositions which exhibit high strength at relatively low density. While progress in this area has been made, there remains a need for foamed polyurethane compositions exhibiting improved physical properties in order to meet the requirements of specific applications for these materials.

International patent application WO2020086470A1 filed Oct. 21, 2019 is commonly owned by the applicant and discloses polyol compositions useful in the preparation of high strength, temperature resistant non-foamed polyurethane materials. There remains a need in the art for high strength foamed polyurethane compositions having moderate density and high temperature resistance than are currently available. Further, there remains a need in the art for flexibility in the design of foamed polyurethane compositions such that their physical properties may be efficiently optimized to match the requirements of a particular application.

### BRIEF DESCRIPTION

This disclosure addresses many of the shortcomings of known foamed polyurethanes by providing a new class of foamable compositions and low to moderate density foamed polyurethanes having superior physical properties. The foamable compositions are adapted to provide structurally robust, temperature resistant, low to moderate density foamed polyurethanes, but are of sufficiently low viscosity to permit the use of currently available pumping and mixing equipment, such as meter mixing equipment and reaction injection molding (RIM) equipment, during manufacture of foamed polyurethane materials. Cream times, gel times, rise times and tack free times exhibited by this new class of foamable compositions are adapted for efficient manufacture in currently available foam-making equipment.

There is disclosed a foamable polyurethane composition comprising: (a) a polyol composition comprising: (i) at least one monomeric polyol comprising 3 or more hydroxyl groups; (ii) at least one higher polyol comprising 3 or more hydroxyl groups; and optionally (iii) at least one polyhydroxylated aromatic compound; (b) at least one polyisocyanate, latent polyisocyanate or mixture thereof; and (c) at least one blowing agent; wherein the at least one higher polyol comprises residues of either the at least one monomeric polyol or both of the at least one monomeric polyol and the polyhydroxylated aromatic compound, wherein the residues are linked by 1 or more carbonate groups, oxygen ether groups, or a combination thereof. Such foamable polyurethane composition may further comprise at least one cyclic carbonate comprising 1 or more hydroxyl groups which may be present in an amount from about 5 to about 40% by weight based on the total weight of the polyol composition. The polyol composition may have a viscosity of less than 1000 cps at 150° F.

There is disclosed a foamed article prepared from 1 or more of the foamable compositions disclosed herein, the foamed article comprising voids within a polyurethane matrix comprising residues of the polyol composition and residues of the at least one polyisocyanate, latent polyisocyanate or mixture thereof. The voids may define open cells, closed cells or a combination thereof. The foamed article may have a density of 220 kg/m³ or less, a compressive strength of 0.3 MPa or greater, and a compressive modulus of 10 MPa or greater.

There is disclosed a method of making a foamed polyurethane composition comprising contacting 1 or more of the foamable compositions disclosed herein under conditions sufficient to cause at least a portion of the hydroxyl groups of the at least one monomeric polyol, at least a portion of the hydroxyl groups of the at least one higher polyol and, when present, at least a portion of the hydroxyl groups of the at least one polyhydroxylated aromatic compound to react with isocyanate groups or latent isocyanate groups of the one or more polyisocyanates, latent polyisocyanates or mixture thereof to form urethane linkages in the presence of the at least one blowing agent to provide the foamed product polyurethane composition.

There is disclosed a foamed polyurethane composition prepared from 1 or more of the foamable compositions disclosed herein, the foamed polyurethane composition comprising (a) residues of the at least one polyol composition; (b) residues of the at least one polyisocyanate, latent polyisocyanate or mixture thereof; and optionally (c) residues of the at least one blowing agent; and wherein at least a portion of the residues of the polyol composition and the residues of the at least one polyisocyanate, latent polyisocyanate or mixture thereof are linked by urethane linkages within a polyurethane matrix comprising voids.

There is disclosed a foamed polyurethane composition comprising: (a) residues of at last 1 polyol composition; (b) residues of at least one polyisocyanate, latent polyisocyanate or mixture thereof; and optionally (c) residues of at least one blowing agent; wherein the polyol composition comprises (i) at least one monomeric polyol comprising 3 or more hydroxyl groups; (ii) at least one higher polyol comprising 3 or more hydroxyl groups; and optionally (iii) at least one polyhydroxylated aromatic compound comprising 2 or more hydroxyl groups; and wherein the at least one higher polyol comprises residues of either the at least one monomeric polyol or both of the at least one monomeric polyol and the polyhydroxylated aromatic compound linked by 1 or more carbonate groups, oxygen ether groups, or a combination thereof; and wherein at least a portion of the residues of the polyol composition and the residues of the at least one polyisocyanate, latent polyisocyanate or mixture thereof are linked by urethane linkages within a polyurethane matrix comprising voids. Residues of the at least one polyol composition may comprise residues of at least one cyclic carbonate comprising 1 or more hydroxyl groups. Residues of the at least one cyclic carbonate comprising may be present in an amount from about 5 to about 40% by weight based on the total weight of the residues of at least one polyol composition.

There is disclosed a method of making a foamed polyurethane composition comprising reacting a polyol composition comprising (i) at least one monomeric polyol comprising 3 or more hydroxyl groups; (ii) at least one higher polyol comprising 3 or more hydroxyl groups; and optionally (iii) at least one polyhydroxylated aromatic compound comprising 2 or more hydroxyl groups with at least one polyisocyanate, latent polyisocyanate, or mixture thereof to form urethane linkages of a first polymeric or oligomeric polyurethane product in a first zone of a mixing device; contacting the first polymeric or oligomeric polyurethane product with at least one blowing agent in a second zone of the mixing device to form a second polymeric or oligomeric polyurethane product containing the at least one blowing agent; and causing the blowing agent expand to provide the foamed polyurethane composition; wherein the at least one higher polyol comprises residues of either the at least one monomeric polyol or both of the at least one monomeric polyol and the polyhydroxylated aromatic compound linked by 1 or more carbonate groups, oxygen ether groups, or a combination thereof.

There is disclosed a foamable composition comprising: (a) a polyol composition comprising: (i) at least one polyol comprising 3 or more hydroxyl groups; (ii) at least one cyclic carbonate comprising 1 or more hydroxyl groups; and optionally (iii) at least one polyhydroxylated aromatic compound comprising 2 or more hydroxyl groups; (b) at least one isocyanate functional component comprising isocyanate groups, latent isocyanate groups, or a mixture thereof; and (c) at least one blowing agent; wherein the composition when subjected to conditions sufficient to cause the polyol composition and the isocyanate functional component to react, the composition cures by reaction of at least a portion of the hydroxyl groups of the at least one polyol and at least a portion of the hydroxyl groups of the at least one cyclic carbonate and, when present, at least a portion of the hydroxyl groups of the polyhydroxylated aromatic compound with the isocyanate groups, latent isocyanate groups, or a mixture thereof of the isocyanate functional component to form urethane linkages of a foamed polyurethane composition. The foamable composition may contain aromatic components, or may be essentially free of aromatic components, containing only aliphatic and/or cycloaliphatic polyol, cyclic carbonate and isocyanate functional components and exhibit excellent photostability. The polyol composition may have a viscosity of less than 1000 cps at 150° F. The cyclic carbonate may be present in an amount from about 5% to about 40% by weight based on the total weight of the polyol composition. The cyclic carbonate may be present in an amount from about 10% to about 30% by weight based on the total weight of the polyol composition.

There is disclosed a foamed article prepared from 1 or more of the cyclic carbonate-containing foamable compositions disclosed herein, the foamed article comprising voids within a polyurethane matrix comprising: residues of the at least one polyol composition, the residues of the at least one polyol composition comprising residues of the at least one polyol, residues of the at least one cyclic carbonate, and optionally residues of the polyhydroxylated aromatic compound; and residues of the at least one isocyanate functional component. The foamed article may contain aromatic component residues, or be essentially free of aromatic component residues, containing only aliphatic and/or cycloaliphatic polyol, cyclic carbonate and isocyanate functional component residues and exhibit excellent photostability. The foamed article may exhibit a compressive strength of 0.3 MPa or greater and a density of 220 kg/m³ or less.

There is disclosed a method of making a foamed polyurethane composition comprising: contacting 1 or more of the cyclic carbonate-containing foamable compositions disclosed herein, optionally in the presence of a catalyst, under conditions sufficient to cause at least a portion of the hydroxyl groups of the at least one polyol, at least a portion of the hydroxyl groups of the at least one cyclic carbonate and, when present, at least a portion of the hydroxyl groups of the polyhydroxylated aromatic compound to react with isocyanate groups, latent isocyanate groups or a mixture thereof of the at least one isocyanate functional component to form urethane linkages in the presence of the at least one blowing agent to form the foamed product polyurethane composition.

There is disclosed a foamed polyurethane composition comprising residues of 1 or more of the cyclic carbonate-containing foamable compositions disclosed herein, the residues of the foamable composition comprising: (a) residues of the at least one polyol composition comprising: (i) residues of the at least one polyol comprising 3 or more hydroxyl groups; (ii) residues of the at least one cyclic carbonate comprising 1 or more hydroxyl groups; and optionally (iii) residues of the polyhydroxylated aromatic compound; (b) residues of the at least one isocyanate functional component; and optionally (c) residues of the at least one blowing agent; wherein at least a portion of the residues of the at least one polyol, at least a portion of the residues of the at least one cyclic carbonate and, when present, at least a portion of the residues of the polyhydroxylated aromatic compound are bound by 1 or more urethane linkages to the residues of the at least one isocyanate functional component within a polyurethane matrix comprising voids. The foamed polyurethane composition may contain aromatic component residues, or may be essentially free of aromatic component residues, containing only aliphatic and/or cycloaliphatic polyol, cyclic carbonate and isocyanate functional component residues and exhibit excellent photostability.

There is disclosed a foamed polyurethane composition comprising: (a) residues of a polyol composition comprising: (i) residues at least one polyol having 3 or more hydroxyl groups; (ii) residues of at least one cyclic carbonate comprising 1 or more hydroxyl groups; and optionally (iii) residues a polyhydroxylated aromatic compound (b) residues of at least one isocyanate functional component comprising isocyanate groups, latent isocyanate groups, or a mixture thereof; and optionally (c) residues of at least one blowing agent; wherein at least a portion of the residues of the at least one polyol, at least a portion of the residues of the at least one cyclic carbonate and, when present, at least a portion of the residues of the polyhydroxylated aromatic compound are bound by 1 or more urethane linkages to the residues of the at least one isocyanate functional component within a polyurethane matrix comprising voids. The foamed polyurethane composition may be essentially free of aromatic component residues, containing only aliphatic and/or cycloaliphatic polyol, cyclic carbonate and isocyanate functional component residues and exhibit excellent photostability.

There is disclosed a method of making a foamed polyurethane composition comprising: contacting 1 or more of the cyclic carbonate-containing foamable compositions disclosed herein under conditions sufficient to form urethane linkages of a first polymeric or oligomeric polyurethane product in a first zone of a mixing device; contacting the first polymeric or oligomeric polyurethane product in a second zone of the mixing device to form a second polymeric or oligomeric polyurethane product containing the at least one blowing agent; and causing the blowing agent to expand to provide the foamed polyurethane composition.

There is disclosed a method of making a foamed polyurethane composition comprising: reacting at least one polyol composition comprising at least one polyol comprising 3 or more hydroxyl groups, at least one cyclic carbonate comprising 1 or more hydroxyl groups and optionally at least one polyhydroxylated aromatic compound, with at least one isocyanate functional component comprising isocyanate groups, latent isocyanate groups, or a mixture thereof, to form urethane linkages of a first polymeric or oligomeric polyurethane product in a first zone of a mixing device; contacting the first polymeric or oligomeric polyurethane product with at least one blowing agent in a second zone of the mixing device to form a second polymeric or oligomeric polyurethane product containing the at least one blowing agent; and causing the blowing agent expand to provide the foamed polyurethane composition. The product foamed polyurethane composition may be essentially free of aromatic component residues, containing only aliphatic and/or cycloaliphatic polyol, cyclic carbonate and isocyanate functional component residues and exhibit excellent photostability.

The foamable and foamed polyurethane materials provided by this disclosure are well suited for use in the manufacture of foamed articles for use in construction applications, vehicle applications and packaging applications.

The various foamable compositions, foamed polyurethanes, articles and methods disclosed herein address both the need in the art for access to high strength low to moderate density polyurethanes and articles, and the need for flexibility in the design of foamed polyurethane compositions having optimum properties for a particular application.

### BRIEF DESCRIPTION OF THE FIGURES

FIG. 1 shows a series of foamed polyurethane compositions prepared using the foamable compositions disclosed herein;

FIG. 2 shows microscope images of commercial reference foam (ρ=27 kg/m³) with 4× (a) and 10× (b) magnifications compared with microscope images of the i0.8C1 foam (ρ=87 kg/m³) of Example 1 with 4× (c) and 10× (d) magnifications;

FIG. 3 shows a negative ion mass spectrum of the polyol composition of Method 1 herein;

FIG. 4 shows a negative ion mass spectrum of the monomeric polyol PEP 450; and

FIG. 5 shows a cross section of a foamed polyurethane composition prepared from a foamable composition comprising carbon nanotubes.

### DETAILED DESCRIPTION

The explanations and illustrations presented herein are intended to acquaint others skilled in the art with the disclosure, its principles, and its practical application. The specific embodiments of the present disclosure as set forth are not intended as being exhaustive or limiting of the disclosure. The scope of the disclosure should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Definitions

As used herein, 1 or more means that at least one, or more than 1, of the recited components may be used as disclosed. Nominal as used with respect to functionality means the theoretical functionality. This can be calculated from the stoichiometry of the ingredients used. The actual functionality may be different due to imperfections in raw materials, incomplete conversion of the reactants and formation of by-products. Nominal with respect to molecular weight refers to the molecular weight of a particular structure. Nominal with respect to the molecular weight of a component of a chemical substance disclosed herein may differ from the actual molecular weight of the substance, for example as when the substance consists of a mixture of structurally related compounds as is the case with many commercially available polyether polyols.

Residual content of a component refers to the amount of the component present in free form or reacted with another material, such as a higher polyol or a cured product. The residual content of a component can be calculated from the ingredients utilized to prepare the component or composition. It may be determined utilizing known analytical techniques. Heteroatom means nitrogen, oxygen, sulfur, silicon, selenium and phosphorus. Heteroatoms may include nitrogen and oxygen.

As used herein, the term “hydrocarbyl” refers an organic radical, which may be of any molecular weight, and which may be any of an aromatic radical, a cycloaliphatic radical, or an aliphatic radical as those terms are defined in US patent application U.S. Ser. No. 10/053,533. Where the hydrocarbyl group contains heteroatoms, the heteroatoms may form 1 or more functional groups well known to one skilled in the art. Hydrocarbyl groups may contain cycloaliphatic, aliphatic, aromatic or any combination of such segments. The aliphatic segments can be straight or branched. The aliphatic and cycloaliphatic segments may include 1 or more double and/or triple bonds. Included in hydrocarbyl groups are alkyl, alkenyl, alkynyl, aryl, cycloalkyl, cycloalkenyl, alkaryl and aralkyl groups. Cycloaliphatic groups may contain both cyclic portions and noncyclic portions.

As used herein % by weight or parts by weight refer to, or are based on, the weight of the disclosed composition unless otherwise specified.

The term isocyanate-reactive compound as used herein includes any organic compound having nominally greater than one, or at least 2, isocyanate-reactive moieties. For the purposes of this disclosure, an active hydrogen containing moiety refers to a moiety containing a hydrogen atom which, because of its position in the molecule, displays significant activity according to the Zerewitinoff test described by Wohler in the Journal of the American Chemical Society, Vol. 49, p. 3181 (1927). Illustrative of such isocyanate reactive moieties, such as active hydrogen moieties, are —COOH, —OH, —NH₂, —NH—, —CONH₂, —SH, and —CONH—. Active hydrogen containing compounds include polyols, polyamines, polymercaptans and polyacids. The isocyanate reactive compound may be a polyol, and may be a polyether polyol.

As used herein, the term aliphatic polyol refers to a polyol comprising at least one aliphatic radical and not comprising a cycloaliphatic radical or an aromatic radical. As used herein, the term cycloaliphatic polyol refers to a polyol comprising at least one cycloaliphatic radical and not comprising an aromatic radical. As used herein, the term aromatic polyol refers to a polyol comprising at least one aromatic radical.

As used herein the term FRP tooling refers to fiber reinforced plastic tooling.

As used herein residue means the remainder of a compound utilized to form a reaction product remaining in the reaction product wherein the residue is covalently bonded into the formed reaction product. The term residue as applied to blowing agents, additives and fillers is defined to include either or both covalently bonded and unbound forms.

As used herein methylene ether means a linking oxygen atom comprised within an alkylene chain. As used herein amino ether means a linking nitrogen atom comprised within an alkylene chain.

As used herein, the term polyol, when used within the context of foamable compositions comprising at least one cyclic carbonate comprising 1 or more hydroxyl groups, includes both monomeric polyols, higher polyols and combinations thereof.

Disclosed herein are foamable compositions, foamed articles prepared from such foamable compositions, methods of preparing foamed compositions, and foamed compositions of matter, each relying on the use of polyol compositions recently developed by the Applicants and disclosed in U.S. Ser. No. 10/053,533 and WO2020086470A1 which are incorporated by reference herein in their entirety for all purposes and which surprisingly confer unique advantages upon such foamable compositions, articles, methods and foamed compositions of matter.

For convenience and brevity, any required or optional constituents disclosed herein: polyol compositions, polyisocyanates, latent polyisocyanates, mixtures thereof, blowing agents, additives, fillers, catalysts, additional polyols, chain extenders, branching agents, or other constituent should be read as being a potential constituent, or potential residual constituent, of any of the disclosed foamable compositions, foamed articles, and foamed compositions of matter. Similarly, any required or optional constituents disclosed herein should be read as being a potential constituent, or potential residual constituent, of any of the disclosed methods of preparing foamed articles and foamed compositions.

The foamable compositions disclosed herein may be used to produce foamed polyurethane compositions and articles of low to moderate density having high strength relative to foamed compositions and articles produced from foamable compositions known in the art. This is believed to be due in part to the unique structural and physical characteristics of the polyol compositions employed in the instant foamable compositions. It is possible to balance the high strength of such foamed compositions and articles against density, and this provides flexibility in the design of foamed polyurethane compositions for a particular application. Various techniques may be employed to lower the density of a low to moderate density-high strength composition without unduly reducing its strength. Such techniques may include the addition of one or more density-reducing polyols to the base foamable composition, the inclusion of lightweight fillers such as carbon nanotubes, organic microshpheres and the like, and optimization of blowing agent-catalyst combinations.

The various compositions, methods and articles may rely upon (a) a polyol composition comprising (i) at least one monomeric polyol comprising 3 or more hydroxyl groups; (ii) at least one higher polyol comprising 3 or more hydroxyl groups; and optionally (iii) at least one polyhydroxylated aromatic compound; (b) at least one polyisocyanate, latent polyisocyanate or mixture thereof; and (c) at least one blowing agent; wherein the at least one higher polyol comprises residues of either the at least one monomeric polyol or both of the at least one monomeric polyol and the polyhydroxylated aromatic compound, wherein the residues are linked by 1 or more carbonate groups, oxygen ether groups, or a combination thereof.

Any of the foamable compositions, foamed articles, methods of preparing foamed compositions, and foamed compositions of matter may include (a) the polyol composition or residues thereof in an amount from about 10 to about 70% by weight; (b) the at least one polyisocyanate, latent polyisocyanate, mixture thereof, or residues thereof in an amount from about 90 to about 30% by weight; and (c) the at least one blowing agent, or residues thereof, in an amount of from about 0.1% by weight to about 15% by weight; based on the total weight of the constituents employed to prepare the foamable composition, article, or foamed composition of matter, with the proviso that the blowing agent may be an optional constituent of product foamed articles and foamed compositions of matter in which the blowing agent diffuses out of, otherwise escapes, or is otherwise consumed after manufacture of the product foamed article or composition of matter.

At least a portion of the blowing agent, or residues thereof, may be present in the foamed articles and compositions of matter disclosed herein, or may be essentially absent from therefrom.

The foamable composition, or other mixture of the polyol composition and the polyisocyanate, latent polyisocyanate, or mixture thereof may have an initial ratio of isocyanate groups, latent isocyanate groups, or a combination thereof to hydroxyl groups in a range from about 1 to about 8. This ratio may at times be referred to herein as the isocyanate index or the index. For convenience, a series of exemplary foamable compositions having an isocyanate index of 0.8 to 2.0 may be designated “i0.8”, “i1.1”, “i1.2” . . . “i2.0”.

The at least one blowing agent may comprise 1 or more of a physical blowing agent, a chemical blowing agent, or a combination thereof. The at least one blowing agent may comprise water. Suitable blowing agents include any blowing agent known in the art and combinations thereof and include both chemical blowing agents exemplified by water and hydroxyl group containing species such as isopropanol as well as physical blowing agents such as nitrogen, carbon dioxide and cyclopentane.

The foamable composition, or other mixture of the polyol composition and the polyisocyanate, latent polyisocyanate, or mixture thereof, may comprise at least one catalyst which may promote the formation of voids within a polyurethane matrix as well as the formation of urethane linkages within a polyurethane matrix. Suitable catalysts may comprise at least one amine, an amine salt, or a combination thereof. The catalyst may comprise bis(dimethylaminoethyl) ether, a salt thereof, or a combination thereof. Further, suitable catalysts may include 1 or more of any of the catalysts disclosed herein. Residual catalyst may be present within a foamed article or foamed polyurethane composition of matter prepared from precursor polyol compositions and polyisocyanate compositions containing 1 or more catalysts.

Any of the foamable compositions, foamed articles, methods of preparing foamed compositions, and foamed compositions of matter may include 1 or more additives intended to enhance the performance characteristics of the foamable compositions, foamed articles, methods of preparing foamed compositions, and foamed compositions of matter. Exemplary additives include nucleating agents, surfactants, flame retardants, cell openers, thermal stabilizers, ultraviolet light stabilizers, colorants, mold release agents, antioxidants and combinations thereof. One or more additives may be present in an amount from about 0.01% by weight to about 15% by weight based on the total weight of the foamable composition, article, or foamed composition of matter. Such additives may be present in either or both of the polyol composition and the at least one polyisocyanate, latent polyisocyanate, or mixture thereof, or may be added to a precursor composition such as a first polymeric or oligomeric polyurethane precursor, or a second polymeric or oligomeric polyurethane precursor.

Suitable nucleating agents include any nucleating agent known in the art and combinations thereof.

Suitable surfactants include any surfactant known in the art and combinations thereof. These may include nonionic surfactants and wetting agents such as those prepared by the sequential addition of propylene oxide followed by ethylene oxide to propylene glycol, solid or liquid organosilicone surfactants such as Niax Silicone L-6888, and polyethylene glycol ethers of long chain alcohols, ionic surfactants such as tertiary amine or alkanolamine salts of long chain alkyl acid sulfate esters, alkyl sulfonic esters, and alkyl arylsulfonic acids, Niax™ L-618 and Niax™ L-1000 available from Momentive Performance Materials and Niax™ L2171 available from OSi Specialties. Exemplary surfactants include polyalkylene ether-polysiolxane copolymers such as are disclosed in US patent application 20120101175 and U.S. patent Ser. No. 10/717,872 which are incorporated by reference herein in their entirety for all purposes.

Suitable flame retardants include any flame retardant known in the art and combinations thereof.

Suitable cell openers include any cell opener known in the art and combinations thereof. Such cell openers may be included, when it may be desirable that at least a portion of the cells present in the polyurethane matrix be open cells. Cell openers present during foam formation function by breaking cell walls and therefore promote the formation of an open cell foam structure. In certain applications, for example noise and vibration dampening, a higher open cell content may be advantageous. Suitable cell openers may comprise ethylene oxide homopolymers or random copolymers of ethylene oxide and propylene oxide. Cell openers may have a hydroxyl functionality of 4 or more, or 6 or more.

Suitable thermal stabilizers include any thermal stabilizer known in the art and combinations thereof.

Suitable ultraviolet light stabilizers include any ultraviolet light stabilizer known in the art and combinations thereof.

Suitable colorants include any colorant known in the art and combinations thereof.

Suitable mold release agents include any mold release agent known in the art and combinations thereof.

Suitable antioxidants include any antioxidant known in the art and combinations thereof.

Any of the foamable compositions, foamed articles, methods of preparing foamed compositions, and foamed compositions of matter may include one or more fillers. Exemplary fillers include those disclosed herein. The one or more fillers may be present in an amount from greater than 0.001% to less than 60% by weight of the total weight of the foamable composition, foamed article or foamed composition of matter. The one or more fillers may be present in an amount from greater than 0.001% to less than 5% by weight of the total weight of the foamable composition, foamed article or foamed composition of matter. One or more fillers may be present in either or both of the polyol composition and the at least one polyisocyanate, latent polyisocyanate or mixture thereof, or may be added to a precursor composition such as a first polymeric or oligomeric polyurethane precursor, or a second polymeric or oligomeric polyurethane precursor. The filler may comprise an electrically conductive material. The filler may comprise an electrically conductive material comprising carbon nanotubes.

The polyol composition may comprise at least one monomeric polyol comprising 3 or more hydroxyl groups. The at least one monomeric polyol may be present in an amount corresponding to greater than 20%, 40%, 60%, or 80% by weight based on the total weight of the polyol composition. The at least one monomeric polyol may be present in an amount corresponding to less than 95%, 75%, 55%, or 35% by weight based on the total weight of the polyol composition. Further, the at least one monomeric polyol may be present in an amount greater than 10% and less than 90% by weight based on the total weight of the polyol composition. The at least one higher polyol may be present in an amount greater than 5%, 20%, 45%, or 65% by weight and less than 85%, 70%, 60%, or 50% by weight based on the total weight of the polyol composition.

The at least one monomeric polyol may comprise 3 or more secondary hydroxyl groups or 4 or more secondary hydroxyl groups. The at least one monomeric polyol may tetrafunctional comprising 4 or more hydroxyl groups. The at least one monomeric polyol may comprise 4 or more secondary hydroxyl groups. The least one monomeric polyol may comprise 1 or more oxygen ether groups. The at least one monomeric polyol may comprise a mixture of polyols having an average molecular weight of less than 500 g/mol as determined from its hydroxyl number obtained using ASTM E222. The at least one monomeric polyol may comprise an alkoxylated polyether polyol. The at least one monomeric polyol may comprise a C₂ to C4 alkoxylated polyether polyol.

The at least one higher polyol may comprise 3 or more secondary hydroxyl groups. The at least one higher polyol may comprise 1 or more carbonate groups and 2 or more residues of the at least one monomeric polyol. The at least one higher polyol may comprise 1 or more residues of both the at least one monomeric polyol and the polyhydroxylated aromatic compound. The at least one higher polyol may comprise a first higher polyol comprising 2 or more residues of the monomeric polyol linked by 1 or more carbonate groups, and a second higher polyol comprising 1 or more residues of both the at least one monomeric polyol and the polyhydroxylated aromatic compound. At least a portion of the residues of the at least one higher polyol may be linked by carbonate groups and/or oxygen ether groups. The at least one higher polyol may comprise 4 or more secondary hydroxyl groups. The at least one higher polyol may comprise 6 or more secondary hydroxyl groups. The at least one higher polyol may be a linear higher polyol.

The polyol composition may have a viscosity of less than 5000 cps at 150° F. The polyol composition may have a viscosity of less than 1000 cps at 150° F.

The polyhydroxylated aromatic compound optionally present in the polyol composition may be a free polyhydroxylated aromatic compound, such as a free bisphenol such are disclosed herein. At least a portion of the polyhydroxylated aromatic compound present in the polyol composition may be present as residues within a higher polyol. At least a portion of the at least one polyhydroxylated aromatic compound may comprise bisphenol A. The at least one polyhydroxylated aromatic compound may be present in an amount greater than 5%, 10%, 16% or 20% by weight and less than 30%, 20%, 10% or 5% by weight based on the total weight of the polyol composition.

The at least one polyisocyanate, latent polyisocyanate, or mixture thereof may comprise at least one polyisocyanate prepolymer, at least one blocked polyisocyanate, at least one monomeric polyisocyanate, at least one oligomeric polyisocyanate, at least one polymeric polyisocyanate, or a mixture thereof. The at least one polyisocyanate, latent polyisocyanate or mixture thereof may comprise 1 or more aromatic, cycloaliphatic, or aliphatic polyisocyanates, latent polyisocyanates or mixtures thereof. The at least one polyisocyanate, latent polyisocyanate, or mixture thereof may comprise 1 or more rigid or flexible polyisocyanates, latent polyisocyanates, or mixtures thereof. The at least one polyisocyanate, latent polyisocyanate or mixture thereof may comprise free diphenylmethane diisocyanate (MDI), residues of a diphenylmethane diisocyanate derivative, residues of free diphenylmethane diisocyanate, or a mixture thereof. The at least one polyisocyanate, latent polyisocyanate, or a mixture thereof may comprise free toluene diisocyanate (TDI), residues of a toluene diisocyanate derivative, residues of free toluene diisocyanate, or a mixture thereof. The at least one polyisocyanate, latent polyisocyanate, or a mixture thereof may comprise 1 or more polyisocyanurates, which may comprise one or more aromatic, cycloaliphatic, or aliphatic polyisocyanurates or a mixture thereof. The at least one polyisocyanurate may comprise residues of diphenylmethane diisocyanate (MDI), toluene diisocyanate (TDI), hexamethylene diisocyanate (HMDI) or mixtures of 2 or more of the foregoing residues.

There is disclosed a foamed article prepared from any of the foamable compositions disclosed herein, the foamed article comprising voids within a polyurethane matrix comprising residues of the polyol composition and residues of the at least one polyisocyanate, latent polyisocyanate, or mixture thereof.

The foamed article may have a density of less than 220, 180, 140, 100, 60, or 40 kg/m³, a compressive strength greater than 0.3, 0.6, 0.9, 1.2, 1.5, or 1.8 MPa and a compressive modulus greater than 10, 50, 70, 100, 120, or 130 MPa.

The voids within the polyurethane matrix may define closed cells, open cells, or a combination thereof, and may contain residues of 1 or more physical or chemical blowing agents. Alternatively, the voids defined within the polyurethane matrix may be free of residues of any physical or chemical blowing agents.

Residues of the at least one polyol composition and residues of the at least one polyisocyanate, latent polyisocyanate, or mixture thereof of may be present in the foamed article in an amount corresponding to an initial molar ratio of isocyanate groups, latent isocyanate groups, or a combination thereof to hydroxyl groups in a range from about 1 to about 8.

The foamed article may comprise any additives, fillers catalysts known in the art. The foamed article may comprise 1 or more of any of the exemplary additives, fillers, and catalysts disclosed herein.

The foamed article may be a molded article, an extruded sheet, strand, or otherwise shaped article.

The foamed article may be a component of a vehicle, a structural component of a building, or a packaging system.

There is disclosed a method of making a foamed polyurethane composition comprising contacting 1 or more of the foamable compositions disclosed herein under conditions sufficient to cause at least a portion of the hydroxyl groups of the at least one monomeric polyol, at least a portion of the hydroxyl groups of the at least one higher polyol, and, when present, at least a portion of the hydroxyl groups of the at least one polyhydroxylated aromatic compound to react with isocyanate groups or latent isocyanate groups of the one or more polyisocyanates, latent polyisocyanates, or mixture thereof to form urethane linkages in the presence of the at least one blowing agent to form the foamed product polyurethane composition. Contacting refers to causing, or allowing, the polyol composition constituents and polyisocyanate constituents of the foamable composition to come into contact with one another, this contacting may take place under conditions wherein the polyol composition constituents and polyisocyanate constituents of the foamable composition react to form urethane linkages in the presence of the blowing agent.

Conditions sufficient may comprise heating the foamable composition at a first pressure and thereafter reducing the pressure to allow the at least one blowing agent to form voids within a polyurethane matrix, which may include extruding the foamable composition from a first higher pressure zone within an extruder to a second lower pressure zone to form the foamed product polyurethane composition as an extruded foamed shape, such as a strand or sheet. Conditions sufficient may comprise allowing the polyol composition and polyisocyanate constituents of the foamable composition to react at ambient temperature and pressure in the presence of the blowing agent. Conditions sufficient may comprise allowing the polyol composition and polyisocyanate constituents of the foamable composition to react at higher than ambient temperature at ambient pressure in the presence of the blowing agent.

The conditions sufficient may comprise heating the foamable composition in an open or closed mold. The conditions sufficient may comprise allowing the polyol composition and polyisocyanate constituents of the foamable composition to react at ambient temperature or higher within an open or closed mold at ambient pressure or higher in the presence of the blowing agent.

The conditions sufficient may comprise heating the foamable composition at a temperature of about 50° F. or greater, 75° F. or greater, 100° F. or greater, about 140° F. or less, 120° F. or less or 110° F. or less for a time period of about 10 seconds or greater, 60 seconds or greater, 300 seconds or greater, about 60 minutes or less, 30 minutes or less or 10 minutes or less.

The method of making a foamed polyurethane composition may comprise contacting 1 or more of the foamable compositions disclosed herein in the presence of at least one catalyst or promotor. Exemplary catalysts and promotors include those disclosed herein.

There is disclosed a foamed polyurethane composition comprising: (a) residues of at least one polyol composition; (b) residues of at least one polyisocyanate, latent polyisocyanate, or mixture thereof; and optionally (c) residues of at least one blowing agent; wherein the polyol composition is as disclosed herein, and residues of the polyol composition are linked by urethane linkages to residues of the at least one polyisocyanate, latent polyisocyanate, or mixture thereof within a polyurethane matrix comprising voids. At least a portion of the residues of the at least one polyisocyanate, latent polyisocyanate, or mixture thereof may be linked by urea linkages to other residues of the at least one polyisocyanate, latent polyisocyanate, or mixture thereof as may be the case when the blowing agent comprises water.

At least a portion of the voids of the foamed polyurethane composition may be closed cells, open cells, or a combination thereof.

At least a portion of the voids within the polyurethane matrix may contain of 1 or more blowing agents, residues thereof or a combination thereof which may be 1 or more of a physical blowing agent, a chemical blowing agent, or a combination thereof. The blowing agent may comprise water. Exemplary blowing agents include those disclosed herein.

The foamed polyurethane composition may comprise at least one catalyst or residue thereof, which catalyst may be any catalyst disclosed herein as well as those known in the art. The catalyst may comprise at least one amine, an amine salt, or a combination thereof. The catalyst may comprise a tertiary amine. Exemplary catalysts may comprise bis(dimethylaminoethyl) ether, a salt thereof, or a combination thereof.

The foamed polyurethane composition may have a density of 220 kg/m³ or less.

The foamed polyurethane composition may comprise 1 or more additives and/or fillers known in the art, combinations thereof, and include those additives and fillers disclosed herein.

There is disclosed a method of making a foamed polyurethane composition comprising reacting a higher polyol-containing polyol composition as disclosed herein with at least one polyisocyanate, latent polyisocyanate, or mixture thereof to form urethane linkages of a first polymeric or oligomeric polyurethane product in a first zone of a mixing device; contacting the first polymeric or oligomeric polyurethane product with at least one blowing agent in a second zone of the mixing device to form a second polymeric or oligomeric polyurethane product containing the at least one blowing agent; and causing the blowing agent expand to provide the foamed polyurethane composition; wherein the at least one higher polyol comprises residues of either the at least one monomeric polyol or both of the at least one monomeric polyol and the polyhydroxylated aromatic compound wherein the residues are linked by 1 or more carbonate groups, oxygen ether groups, or a combination thereof.

The mixing device may be a reactive extruder, a meter mixing system, a reaction injection molding (RIM) machine or a combination of 2 or more of the foregoing. The second polymeric or oligomeric polyurethane product containing the at least one blowing agent may be transferred to an open or closed mold in which the second polymeric or oligomeric polyurethane product further cures in the presence of the blowing agent to provide the foamed polyurethane composition as a molded article. The blowing agent may be expanded by passing the second polymeric or oligomeric polyurethane product containing the at least one blowing agent through an aperture into an environment having a lower pressure than the second zone of the mixing device. The aperture may be an extrusion die, a mold inlet port and the like. The foamed polyurethane composition may be produced as a foamed sheet, rod, strand, or complex shape.

The foamed polyurethane composition may comprise any of the additives, fillers, blowing agents, and catalysts disclosed herein. Further, the foamed polyurethane composition may comprise residues of any of the disclosed additives, fillers, blowing agents, catalysts, and combinations thereof.

The polyol compositions employed in the preparation of the foamed articles and foamed compositions disclosed herein may provide important structural elements within the polyurethane matrix and account for the high strength-low density characteristics of these polyurethane foams. The at least one monomeric polyol and at least one higher polyol may have any structures affording the requisite physical characteristics in terms of polyol composition viscosity, foamable composition manufacturing characteristics and product foamed polyurethane physical properties such as product density, compressive strength and compressive modulus.

Exemplary monomeric polyols include glycerol, digylcerol, triglycerol, trimethylolethane, trimethylolethane, trimethylolpropane, 1,2,4-butanetriol, tris(hydroxymethyl)amine, tris(hydroxyethyl)amine, tris(hydroxypropyl)amine, pentaerythritol, dipentaerythritol, bis(trimethylolpropane), tris(hydroxymethyl)isocyanurate, tris(hydroxyethyl)isocyanurate, 1,3,5-benzenetrimethanol, 1,1,1-tris(4-hydroxyphenyl)methane, 1,1,1-tris(4-hydroxyphenyl)ethane, sugars, such as glucose, sugar derivatives, trifunctional or higher polyfunctional polyether polyols based on trihydric or higher polyhydric alcohols and ethylene oxide, ethylene carbonate, propylene oxide, 1,2-propylene carbonate, 1,3-propylene carbonate, butylene oxide, 1,2-butylene carbonate, 1,3-butylene carbonate or mixtures thereof, or polyester polyols. Of these, glycerol, trimethylolethane, trimethylolpropane, 1,2,4-butanetriol, pentaerythritol, dipentaerythritol and also their polyether polyols based on ethylene oxide or propylene oxide may confer especially beneficial characteristics to the foamble compositions themselves and to the methods, foamed articles and foamed compositions based on such foamable compositions.

The monomeric polyol may comprise 3 or more secondary hydroxyl groups, for example a monomeric polyol comprising 3 or more primary or secondary hydroxyl groups may be converted via alkoxylation as is known in the art with a sufficient amount a suitable mono-substituted oxirane such as propylene oxide, 1,2-butylene oxide, 1,2-pentylene oxide, or a suitable cyclic carbonate such as 1,2-propylene carbonate, 1,2-butylene carbonate, or 1,2-pentylene carbonate, to a mixture of monomeric polyols in which the principal components are polyether polyols comprising 3 or more secondary hydroxyl groups. Such monomeric polyols are illustrated by glycerol alkoxylated with 3, 4, 5, 6, or more equivalents of propylene oxide and for convenience abbreviated: glycerol 3×PO, glycerol 4×PO, glycerol 5×PO, glycerol 6×PO, etc. respectively; trimethylolpropane alkoxylated with 3, 4, 5, 6, or more equivalents of 1,2-butylene oxide and for convenience abbreviated: TMP 3×BO, TMP 4×BO, TMP 5×BO, TMP 6×BO, etc. respectively; pentaerythritol alkoxylated with 4, 5, 6, 7 or more equivalents of propylene oxide and for convenience abbreviated: PE 4×PO, PE 5×PO, PE 6×PO, PE 7×PO, etc. respectively; and dipentaerythritol alkoxylated with 5, 6, 7, 8 or more equivalents of propylene oxide and for convenience abbreviated: DiPE 5×PO, DiPE 6×PO, DiPE 7×PO, DiPE 8×PO, etc. respectively.

Exemplary monomeric polyols may also include alkoxylated polyether polyols comprising 3 or more primary hydroxyl groups, for example an alkoxylated monomeric polyol comprising 3 of more primary or secondary hydroxyl groups may be converted via alkoxylation as is known in the art with a sufficient amount a suitable oxirane such as ethylene oxide or a cyclic carbonate such as ethylene carbonate to a mixture of monomeric polyols in which the principal components are alkoxylated polyether polyols comprising 3 or more primary hydroxyl groups. Such alkoxylated polyether polyols may be single chemical species comprising 3 or more hydroxyl groups, but are typically mixtures of related chemical species.

The monomeric polyol may be tetrafunctional or greater and comprise 4 or more hydroxyl groups as is the case of pentaerythritol, dipentaerythritol and digylcerol (See additional illustrative monomeric polyols in Table 1 of this disclosure). The tetrafunctional polyol may comprise 4 or more secondary hydroxyl groups, for example an alkoxylated pentaerythritol or an alkoxylated dipentaerythritol, an alkoxylated digylcerol or an alkoxylated C₄-C₆ carbohydrate (See additional illustrative monomeric polyols in Table 1 of this disclosure). Alkoxylated monomeric polyols constitute polyether polyols and include C₂-C₄ alkoxylated polyols. Those skilled in the art will understand that C₂ alkoxylated polyols may be produced by reaction of a base polyol such as pentaerythritol with, for example ethylene oxide or ethylene carbonate. The product C2 alkoxylated polyol will comprise 1 or more primary hydroxyl groups as a result. C3 and C4 alkoxylated polyols may comprise 1 or more primary, secondary and, in some instances, tertiary hydroxyl groups depending on the manner in which they are prepared. For example, a base polyol such as trimethylol propane when reacted with 1,3-propylene carbonate will produce a C3 alkoxylated polyol comprising 1 or more primary hydroxyl groups. Whereas, a base polyol reacted with 1,2-propylene carbonate or propylene oxide will produce a C₃ alkoxylated polyol comprising 1 or more secondary hydroxyl groups. By way of further example, a base polyol such as dipentaerythritol reacted with 1,4-butylene carbonate will produce a C₄ alkoxylated polyol comprising 1 or more primary hydroxyl groups. Whereas, a base polyol reacted with 1,2- or 1,3-butylene carbonate or butylene oxide will produce a C₄ alkoxylated polyol comprising 1 or more secondary hydroxyl groups. By way of yet further example, a base polyol reacted with 2,2-dimethyl oxirane or 1,2-isobutylene carbonate will produce a C₄ alkoxylated polyol comprising 1 or more tertiary hydroxyl groups. The presence of secondary hydroxyl groups as opposed to primary or tertiary hydroxyl groups may beneficially control the nature and chemical properties of the polyol composition. For example, during the preparation of the polyol composition the use of 1 or more monomeric polyols comprising chiefly, or exclusively, secondary hydroxyl groups may result in higher polyol components of the polyol composition wherein residues of the monomeric polyol may be predominantly linked by carbonate groups. Primary hydroxyl groups within the monomeric polyol may have a greater susceptibility to produce oxygen ether linkages between constituent residues of the higher polyol, be they residues of the monomeric polyol or residues of the polyhydroxylated aromatic compound.

The monomeric polyol may have a molecular weight sufficient to provide the requisite properties of both the polyol composition itself as well as foamable and foamed polyurethanes incorporating the polyol composition. The molecular weight of the monomeric polyol may be calculated from its hydroxyl number which can be determined experimentally according to ASTM E222. The monomeric polyol may have a molecular weight of less than 1000 g/mol, less than 800 g/mol, less than 600 g/mol, or less than 400 g/mol as determined from its hydroxyl number obtained using ASTM E222. The monomeric polyol may have a molecular weight of greater than 200 g/mol, greater than 450 g/mol, greater than 700 g/mol, or greater than 900 g/mol as determined from its hydroxyl number obtained using ASTM E222. The molecular weight may be the actual molecular weight of the monomeric polyol when the monomeric polyol is predominately a single molecular species, or may represent an average molecular weight when the monomeric polyol is a mixture of structurally related polyols such as is the case of Pluracol PEP450 polyols which are a mixture of structurally related monomeric polyols encompassing both alkoxylated homologues and diastereomers thereof. Alternatively, the molecular weight used to describe a monomeric polyol may be a nominal molecular weight of the polyol based upon a specific chemical structure assigned to such monomeric polyol. By way of example, a monomeric polyol which is a polyether polyol may be prepared by alkoxylation of a single, substantially pure base polyol (such as pentaerythritol) with propylene oxide, however, the product polyether polyol may comprise a mixture of structurally related polyols differing in molecular weight from one another by some regular amount (or multiple thereof), for example by 58 g/mol (the group molecular weight of a propyleneoxy repeat unit). Such a product polyether polyol is defined as a monomeric polyol for purposes of this disclosure.

The polyol composition may comprise at least one monomeric polyol and at least one higher polyol comprising 1 or more residues of such monomeric polyol. The monomeric polyols include polyols having structure I

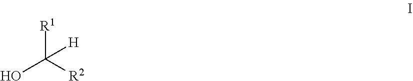

wherein R¹ and R² are independently at each occurrence a hydrogen atom, or a hydrocarbyl group such that R¹ and R², either alone or together, comprise at least 2 hydroxyl groups wherein R¹ and/or R² optionally contain an internal functional group containing a heteroatom. The hydrocarbyl group or groups may be chosen such that monomeric polyol I comprises 3 or more secondary hydroxyl groups. The hydrocarbyl group or groups may be chosen such that monomeric polyol I comprises 4 or more hydroxyl groups. The hydrocarbyl group or groups may be chosen such that monomeric polyol I comprises 4 or more secondary hydroxyl groups. The hydrocarbyl group or groups may be chosen such that monomeric polyol I comprises 1 or more internal functional groups containing a heteroatom. The hydrocarbyl group or groups may be chosen such that monomeric polyol I comprises 1 or more internal functional groups which are alkylene ether groups or polyalkylene ether groups. The hydrocarbyl group or groups may be chosen such that monomeric polyol I is an alkoxylated monomeric polyol. The hydrocarbyl group or groups may be chosen such that monomeric polyol I is an alkoxylated monomeric polyol comprising 1 or more C₂-C₄ alkylene oxide repeat units.

Additionally, R¹ and R² are independently at each occurrence a hydrogen atom, a C₁-C₆₀ aliphatic radical, a C₅-C₃₀ cycloaliphatic radical, a C₆-C₃₀ aromatic radical, or R¹ and R² may together form a C₅-C₃₀ cycloaliphatic radical or a C₆-C₀ aromatic radical; with the proviso that R¹ and R², either alone or together, comprise at least 2 hydroxyl groups, wherein R¹ and/or R² optionally contain an internal functional group containing a heteroatom.

Additionally, R¹ and R² are independently at each occurrence a hydrogen atom, a C₁-C₄₀ aliphatic radical, a C₅-C₂₅ cycloaliphatic radical, or a C5-C2s aromatic radical, or R¹ and R² may together form a C₅-C₃₀ cycloaliphatic radical or a C₆-C₃₀ aromatic radical; with the proviso that R¹ and R², either alone or together, comprise at least 2 hydroxyl groups, wherein R¹ and/or R² optionally contain an internal functional group containing a heteroatom.

Further, R¹ and R² are independently at each occurrence a hydrogen atom, a C1-C₂₅ aliphatic radical; with the proviso that R¹ and R², either alone or together, comprise at least 2 hydroxyl groups, wherein R¹ and/or R² optionally contain an internal functional group containing a heteroatom which is an oxygen atom, a sulfur atom or a nitrogen atom.

Specific examples of monomeric polyols I are given in Table 1.

TABLE 1
Illustrative Polyols I
Structure

| | |
|---|---|
| 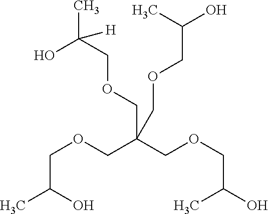 [SMILES: CC(O)COCC(COCC(C)O)(COCC(C)O)COCC(C)O] | Ia |
| 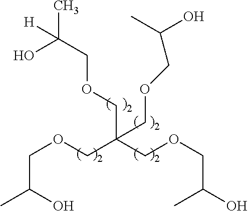 | Ib |
| 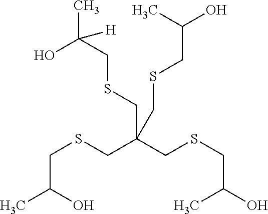 [SMILES: CC(O)CSCC(CSCC(C)O)(CSCC(C)O)CSCC(C)O] | Ic |
| 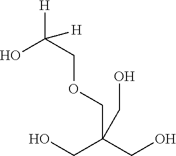 [SMILES: OCCOCC(CO)(CO)CO] | Id |
| 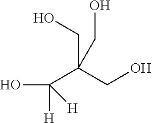 | Ie |
| 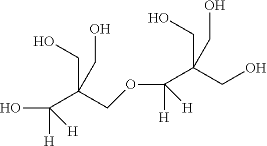 [SMILES: OCC(CO)(CO)COCC(CO)(CO)CO] | If |
| 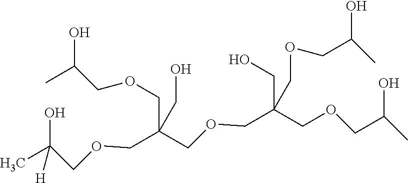 [SMILES: CC(O)COCC(CO)(COCC(C)O)COCC(CO)(COCC(C)O)COCC(C)O] | Ig |
| 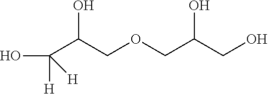 [SMILES: OCC(O)COCC(O)CO] | Ih |
| 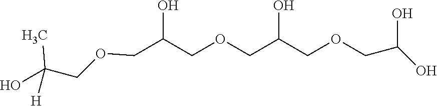 [SMILES: CC(O)COCC(O)COCC(O)COCC(O)O] | Ii |
| 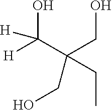 | Ij |
| 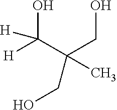 | Ik |
| 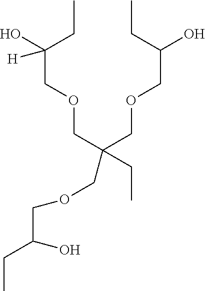 [SMILES: CCC(O)COCC(CC)(COCC(O)CC)COCC(O)CC] | Il |
| 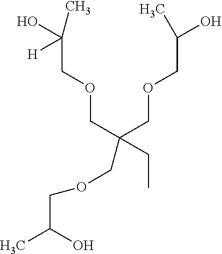 [SMILES: CCC(COCC(C)O)(COCC(C)O)COCC(C)O] | Im |
| 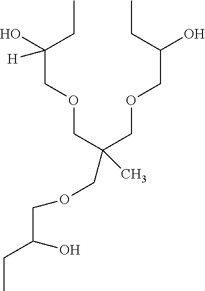 [SMILES: CCC(O)COCC(C)(COCC(O)CC)COCC(O)CC] | In |
| 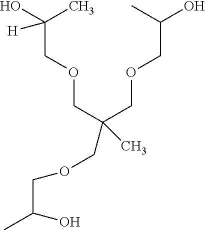 [SMILES: CC(O)COCC(C)(COCC(C)O)COCC(C)O] | Io |
| 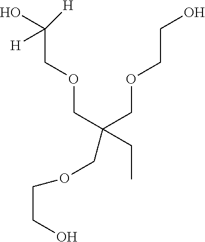 [SMILES: CCC(COCCO)(COCCO)COCCO] | Ip |
| 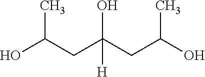 | Iq |
| 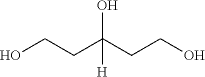 | Ir |
| 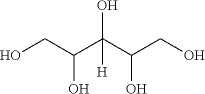 | Is |
| 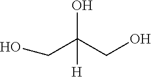 | It |
| 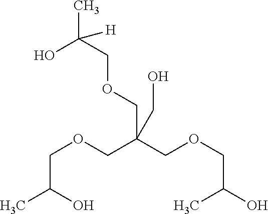 [SMILES: CC(O)COCC(CO)(COCC(C)O)COCC(C)O] | Iu |
| 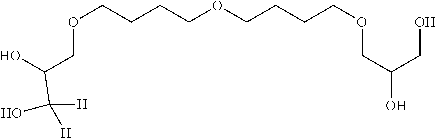 [SMILES: OCC(O)COCCCCOCCCCOCC(O)CO] | Iv |

Illustrative monomeric polyols are represented by aliphatic polyols, entries Ia-Iv. For convenience and simplicity, the fixed structures for monomeric polyols illustrated in Table I and throughout this disclosure may include structurally related homologues where the monomeric polyol represents an alkoxylated structure as in, for example, monomeric polyols which are polyether polyols Ia-Id, Ig, Il-Ip, Iu and Iv. Base polyols to which 1 or more of the illustrated polyether polyols may relate are; le pentaerythritol, If dipentaerythritol, Ih diglycerol, Ij trimethylolpropane, Ik trimethylolethane, Iq 2,4,6-trihydroxyheptane, Ir 3,5-diihydroxy-1-pentanol, Is 2,3,4,5-tetrahydroxy-1-pentanol and Iv glycerol. Monomeric polyols comprising hydroxyl groups present in the base polyol; Id, Ig and Ii may represent polyether polyols resulting from partial alkoxylation of the base polyol.

The higher polyol component of the polyol composition comprises 3 or more hydroxyl groups and residues of either the at least one monomeric polyol or both monomeric polyol and the polyhydroxylated aromatic compound linked by 1 or more carbonate groups, 1 or more oxygen ether groups, or a combination of 1 or more carbonate groups and 1 or more oxygen ether groups.

The major higher polyol components of the polyol composition comprise 2 or more residues of the monomeric polyol linked by 1 or more carbonate groups. Higher polyol components comprising 1 or more residues of the polyhydroxylated aromatic compound and 1 or more residues of the monomeric polyol may be present in the polyol composition but in lesser amounts than the higher polyols comprising 2 or more residues of the monomeric polyol. The higher polyol may contain 2-5 residues of the monomeric polyol linked by 1-4 carbonate linkages. In higher polyols comprising residues of the polyhydroxy aromatic compound, residues of the polyhydroxylated aromatic compound may be linked to residues of the monomeric polyol by 1 or more carbonate groups, 1 or more oxygen ether groups, or a combination of 1 or more carbonate groups and 1 or more oxygen ether groups. Higher polyol components of the polyol composition may have a molecular weight Mₙ of less than 2000 g/mol, less than 1500 g/mol, less than 1000 g/mol, or less than 750 g/mol. Higher polyol components of the polyol composition may have a molecular weight M, of greater than 500 g/mol, greater than 750 g/mol, greater than 1000 g/mol, or greater than 1500 g/mol. Number average molecular weights (Mₙ) of the higher polyol components may be determined by gel permeation chromatography using polystyrene molecular weight standards.

The higher polyol components of the polyol composition may be represented by (a) structure

### II

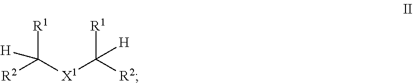

(b) structure III

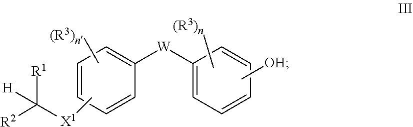

or
(c) structure IV

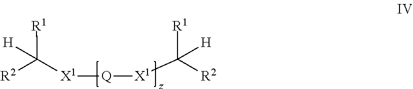

wherein R¹ and R² are as disclosed herein; R³ is independently at each occurrence a non-carbon substituent or a hydrocarbyl group; W is a bond or a linking group; the variables n and n′ are independently an integer from 0 to 4; X¹ is independently at each occurrence a carbonate group or an oxygen ether group; Q is independently at each occurrence a residue of a monomeric polyol within a higher polyol structure comprising at least 2 additional residues of the same or different monomeric polyols; and z is an integer from 1 to 5.

Specific examples of higher polyols having structure II are given in Table 2.

TABLE 2
Illustrative Higher Polyols II

| Entry | Structure |
|---|---|
| IIa | 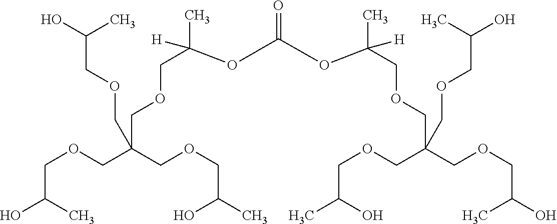 [SMILES: CC(O)COCC(COCC(C)O)(COCC(C)O)COCC(C)OC(=O)OC(C)COCC(COCC(C)O)(COCC(C)O)COCC(C)O] |
| IIb | 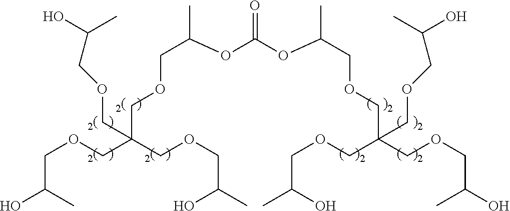 |
| IIc | 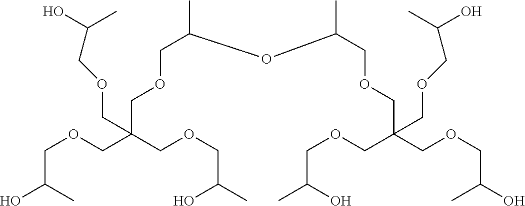 [SMILES: CC(O)COCC(COCC(C)O)(COCC(C)O)COCC(C)OC(C)COCC(COCC(C)O)(COCC(C)O)COCC(C)O] |
| IId | 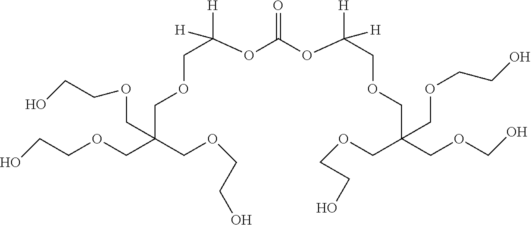 [SMILES: O=C(OCCOCC(COCO)(COCCO)COCCO)OCCOCC(COCCO)(COCCO)COCCO] |
| IIe | 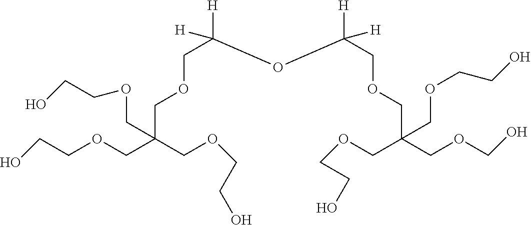 [SMILES: OCCOCC(COCO)(COCCO)COCCOCCOCC(COCCO)(COCCO)COCCO] |
| IIf | 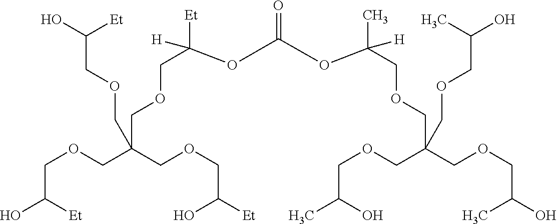 [SMILES: CCC(O)COCC(COCC(O)CC)(COCC(O)CC)COCC(CC)OC(=O)OC(C)COCC(COCC(C)O)(COCC(C)O)COCC(C)O] |
| IIg | 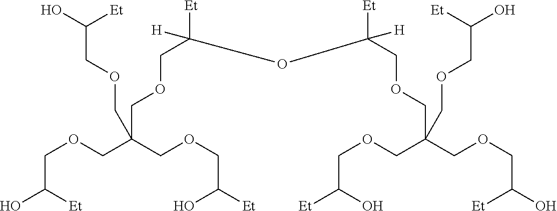 [SMILES: CCC(O)COCC(COCC(O)CC)(COCC(O)CC)COCC(CC)OC(CC)COCC(COCC(O)CC)(COCC(O)CC)COCC(O)CC] |
| IIh | 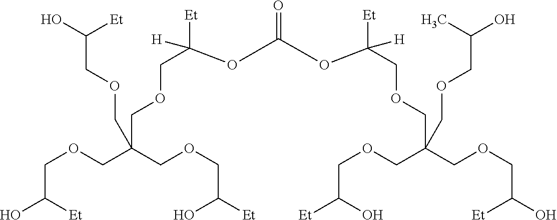 [SMILES: CCC(O)COCC(COCC(C)O)(COCC(O)CC)COCC(CC)OC(=O)OC(CC)COCC(COCC(O)CC)(COCC(O)CC)COCC(O)CC] |
| IIi | 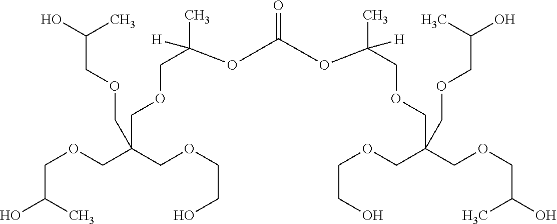 [SMILES: CC(O)COCC(COCCO)(COCC(C)O)COCC(C)OC(=O)OC(C)COCC(COCCO)(COCC(C)O)COCC(C)O] |
| IIj | 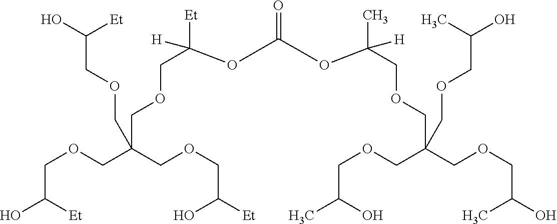 [SMILES: CCC(O)COCC(COCC(O)CC)(COCC(O)CC)COCC(CC)OC(=O)OC(C)COCC(COCC(C)O)(COCC(C)O)COCC(C)O] |
| IIk | 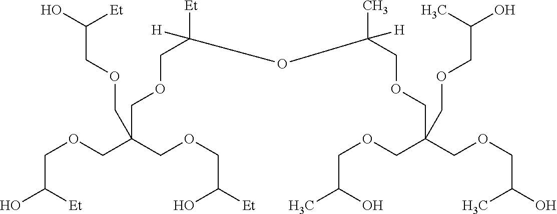 [SMILES: CCC(O)COCC(COCC(O)CC)(COCC(O)CC)COCC(CC)OC(C)COCC(COCC(C)O)(COCC(C)O)COCC(C)O] |
| IIl | 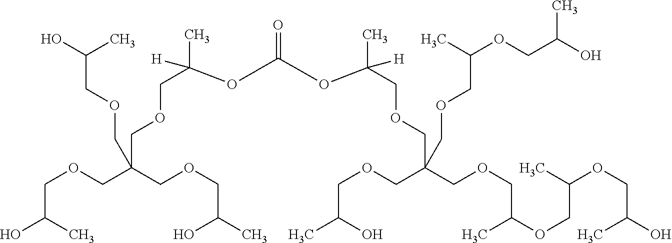 [SMILES: CC(O)COCC(COCC(C)O)(COCC(C)O)COCC(C)OC(=O)OC(C)COCC(COCC(C)O)(COCC(C)OCC(C)O)COCC(C)OCC(C)OCC(C)O] |
| IIm | 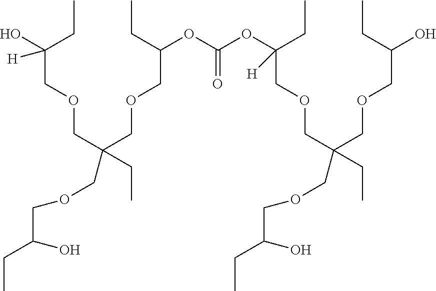 [SMILES: CCC(O)COCC(CC)(COCC(O)CC)COCC(CC)OC(=O)OC(CC)COCC(CC)(COCC(O)CC)COCC(O)CC] |
| IIn | 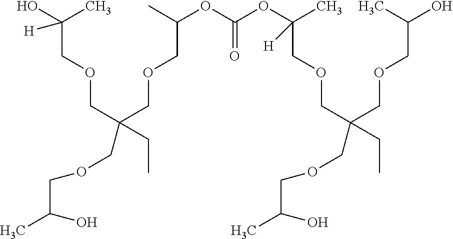 [SMILES: CCC(COCC(C)O)(COCC(C)O)COCC(C)OC(=O)OC(C)COCC(CC)(COCC(C)O)COCC(C)O] |

Illustrative higher polyols IIa-IIn represent aliphatic higher polyols in which 2 monomeric polyol residues are linked by a carbonate group (X¹═OCOO) or an oxygen ether group (X¹═O). Oxygen ether groups linking monomeric polyol groups are thought to arise via loss of carbon dioxide from a higher polyol in which 2 or more monomeric polyol residues are linked by 1 or more carbonate groups.

For convenience and simplicity, the fixed structures for higher polyols II illustrated in Table 2 and throughout this disclosure may include structurally related homologues comprising residues of a monomeric polyol which is itself comprised of structurally related homologs.

Specific examples of higher polyols having structure Ill are given in Table 3.

TABLE 3
Illustrative Higher Polyols III

| Entry | Structure |
|---|---|
| IIIa | 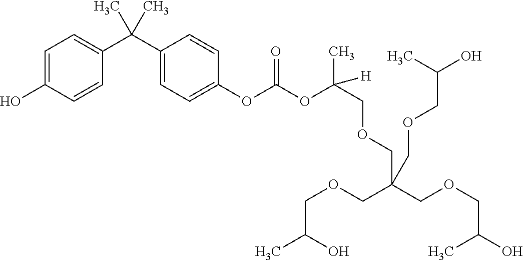 [SMILES: CC(O)COCC(COCC(C)O)(COCC(C)O)COCC(C)OC(=O)Oc1ccc(C(C)(C)c2ccc(O)cc2)cc1] |
| IIIb | 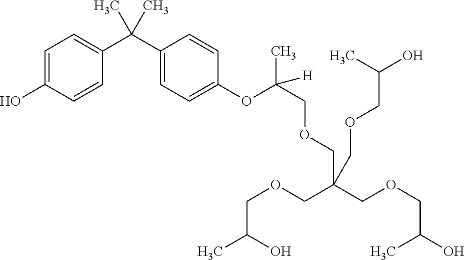 [SMILES: CC(O)COCC(COCC(C)O)(COCC(C)O)COCC(C)Oc1ccc(C(C)(C)c2ccc(O)cc2)cc1] |
| IIIc | 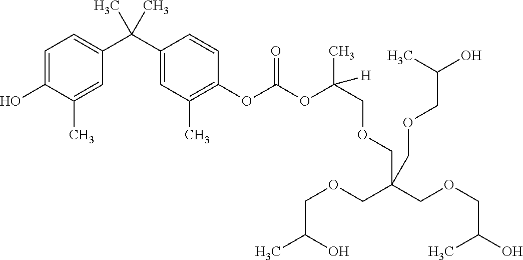 [SMILES: Cc1cc(C(C)(C)c2ccc(OC(=O)OC(C)COCC(COCC(C)O)(COCC(C)O)COCC(C)O)c(C)c2)ccc1O] |
| IIId | 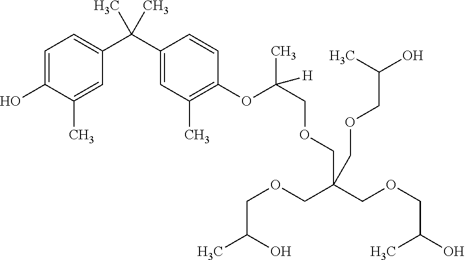 [SMILES: Cc1cc(C(C)(C)c2ccc(OC(C)COCC(COCC(C)O)(COCC(C)O)COCC(C)O)c(C)c2)ccc1O] |
| IIIe | 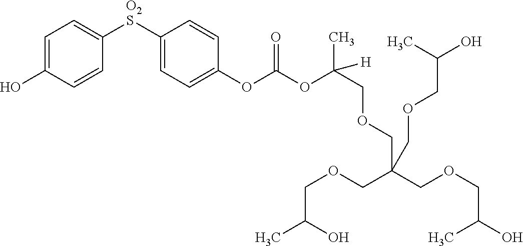 [SMILES: CC(O)COCC(COCC(C)O)(COCC(C)O)COCC(C)OC(=O)Oc1ccc(S(=O)(=O)c2ccc(O)cc2)cc1] |
| IIIf | 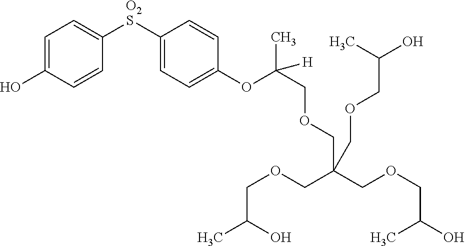 [SMILES: CC(O)COCC(COCC(C)O)(COCC(C)O)COCC(C)Oc1ccc(S(=O)(=O)c2ccc(O)cc2)cc1] |
| IIIg | 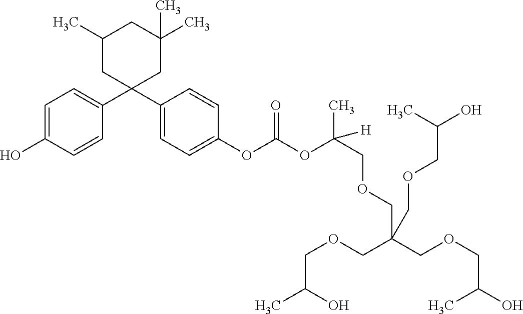 [SMILES: CC(O)COCC(COCC(C)O)(COCC(C)O)COCC(C)OC(=O)Oc1ccc(C2(c3ccc(O)cc3)CC(C)CC(C)(C)C2)cc1] |
| IIIh | 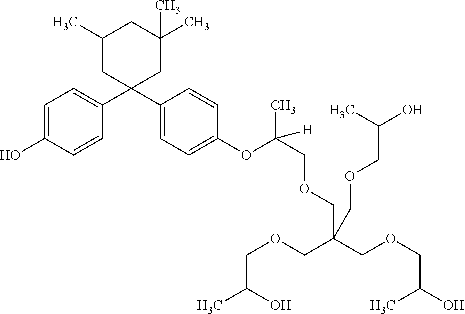 [SMILES: CC(O)COCC(COCC(C)O)(COCC(C)O)COCC(C)Oc1ccc(C2(c3ccc(O)cc3)CC(C)CC(C)(C)C2)cc1] |
| IIIi | 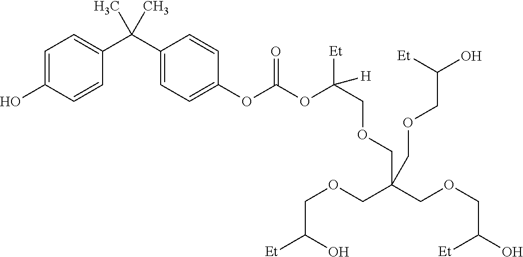 [SMILES: CCC(O)COCC(COCC(O)CC)(COCC(O)CC)COCC(CC)OC(=O)Oc1ccc(C(C)(C)c2ccc(O)cc2)cc1] |
| IIIj | 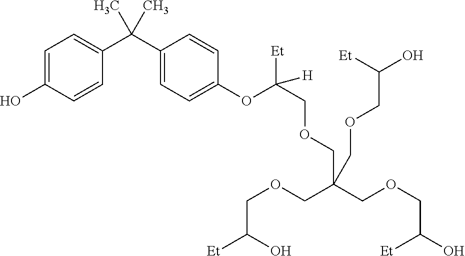 [SMILES: CCC(O)COCC(COCC(O)CC)(COCC(O)CC)COCC(CC)Oc1ccc(C(C)(C)c2ccc(O)cc2)cc1] |
| IIIk | 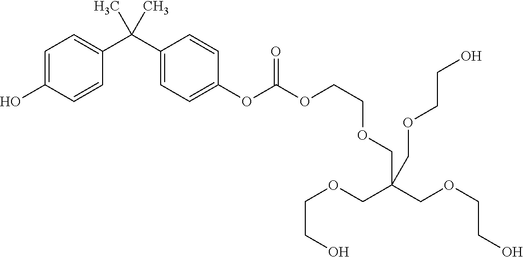 [SMILES: CC(C)(c1ccc(O)cc1)c1ccc(OC(=O)OCCOCC(COCCO)(COCCO)COCCO)cc1] |
| IIIl | 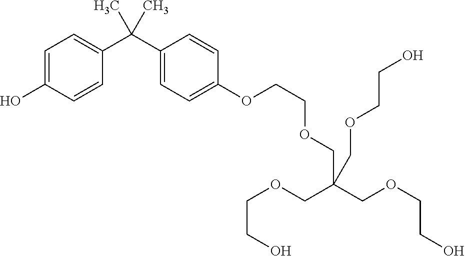 [SMILES: CC(C)(c1ccc(O)cc1)c1ccc(OCCOCC(COCCO)(COCCO)COCCO)cc1] |
| IIIm | 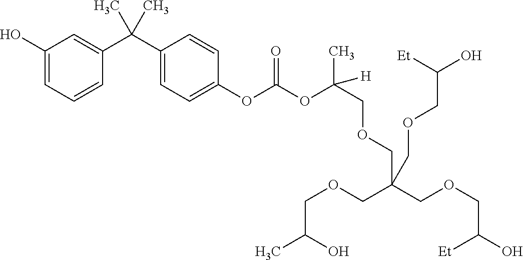 [SMILES: CCC(O)COCC(COCC(C)O)(COCC(O)CC)COCC(C)OC(=O)Oc1ccc(C(C)(C)c2cccc(O)c2)cc1] |
| IIIn | 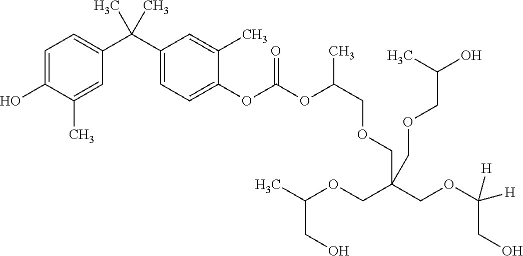 [SMILES: Cc1cc(C(C)(C)c2ccc(OC(=O)OC(C)COCC(COCCO)(COCC(C)O)COC(C)CO)c(C)c2)ccc1O] |
| IIIo | 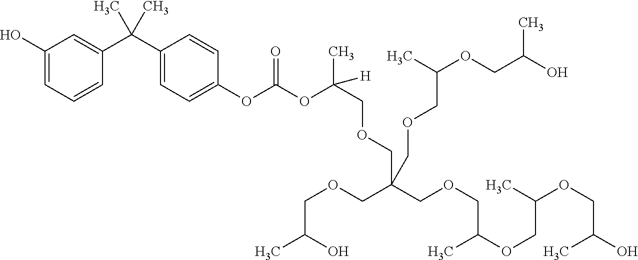 [SMILES: CC(O)COCC(COCC(C)OCC(C)O)(COCC(C)OCC(C)OCC(C)O)COCC(C)OC(=O)Oc1ccc(C(C)(C)c2cccc(O)c2)cc1] |
| IIIp | 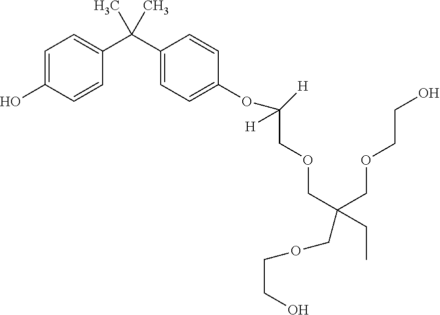 [SMILES: CCC(COCCO)(COCCO)COCCOc1ccc(C(C)(C)c2ccc(O)cc2)cc1] |
| IIIq | 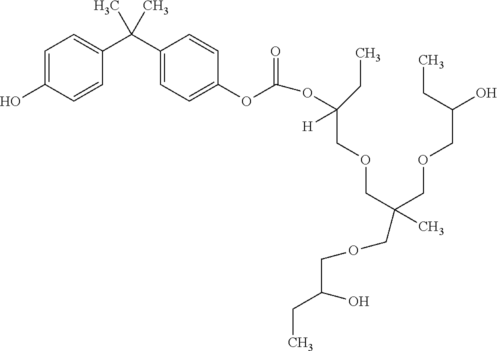 [SMILES: CCC(O)COCC(C)(COCC(O)CC)COCC(CC)OC(=O)Oc1ccc(C(C)(C)c2ccc(O)cc2)cc1] |
| IIIr | 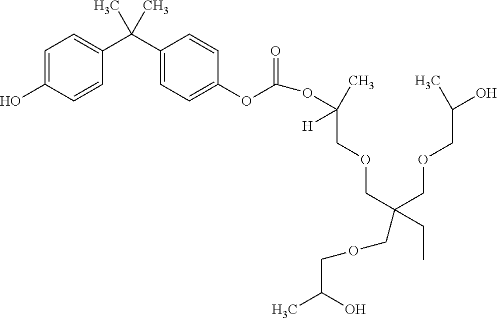 [SMILES: CCC(COCC(C)O)(COCC(C)O)COCC(C)OC(=O)Oc1ccc(C(C)(C)c2ccc(O)cc2)cc1] |

Illustrative higher polyols IIIa-IIIr represent aromatic higher polyols in which a monomeric polyol residue and a residue of a polyhydroxylated aromatic compound are linked by a carbonate group (X¹═OCOO) or an oxygen ether group (X¹═O). Oxygen ether groups linking a monomeric polyol residue to a residue of a polyhydroxylated aromatic compound are thought to arise via loss of carbon dioxide from a higher polyol in which the monomeric polyol residue and the residue of a polyhydroxylated aromatic compound are linked by 1 or more carbonate groups. For example, higher polyol IIIb is thought to arise by loss of carbon dioxide from precursor higher polyol IIIa. It should be noted that appropriately controlling conditions under which the polyol composition is formed can minimize the formation of oxygen ether-linked higher polyols such as IIIb, IIId, IIIf, IIIh, IIIj, IIIl and IIIp. The carbonate-linked higher polyols such as IIIa, IIIc, IIIe, IIIg, IIIi, IIIk, IIIm, IIIn, IIIo, IIIq and IIIr are susceptible to further reaction with monomeric polyol with displacement of the residue of the polyhydroxylated aromatic compound to form a higher polyol containing the residues of 2 monomeric polyols linked together by a carbonate linkage. For example, reaction of higher polyol IIIa with monomeric polyol Ia may afford higher polyol Ia and free polyhydroxylated aromatic compound, in this instance bisphenol A.

For convenience and simplicity, the fixed structures for higher polyols Ill illustrated in Table 3 and throughout this disclosure may include structurally related homologues comprising residues of a monomeric polyol which is itself comprised of structurally related homologs.

Specific examples of higher polyols having structure IV are given in Table 4.

TABLE 4
Illustrative Higher Polyols IV

| Entry | Structure |
|---|---|
| IVa | 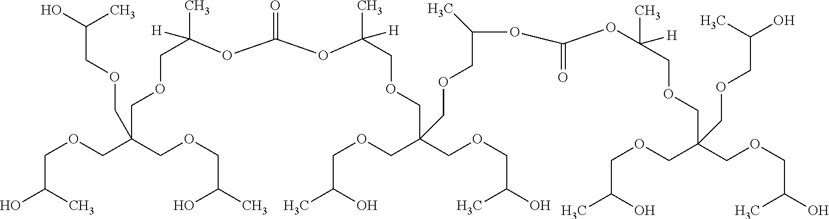 [SMILES: CC(O)COCC(COCC(C)O)(COCC(C)O)COCC(C)OC(=O)OC(C)COCC(COCC(C)O)(COCC(C)O)COCC(C)OC(=O)OC(C)COCC(COCC(C)O)(COCC(C)O)COCC(C)O] |
| IVb | 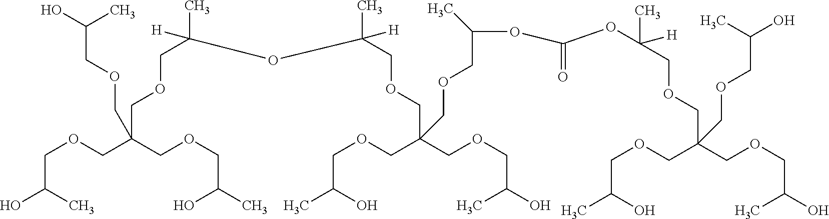 [SMILES: CC(O)COCC(COCC(C)O)(COCC(C)O)COCC(C)OC(=O)OC(C)COCC(COCC(C)O)(COCC(C)O)COCC(C)OC(C)COCC(COCC(C)O)(COCC(C)O)COCC(C)O] |
| IVc | 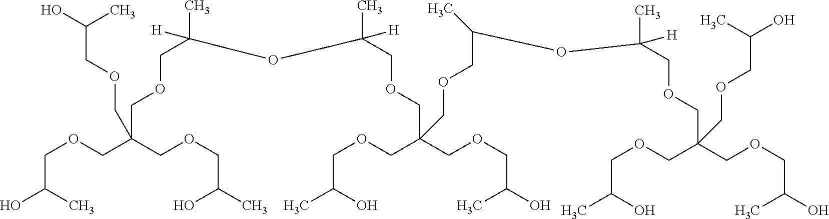 [SMILES: CC(O)COCC(COCC(C)O)(COCC(C)O)COCC(C)OC(C)COCC(COCC(C)O)(COCC(C)O)COCC(C)OC(C)COCC(COCC(C)O)(COCC(C)O)COCC(C)O] |
| IVd | 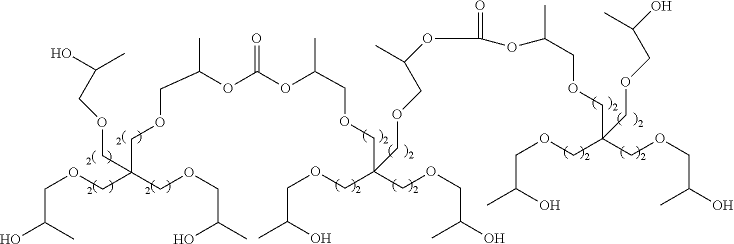 |
| IVe | 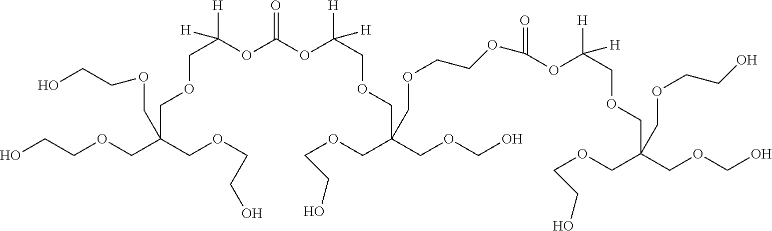 [SMILES: O=C(OCCOCC(COCO)(COCCO)COCCO)OCCOCC(COCO)(COCCO)COCCOC(=O)OCCOCC(COCCO)(COCCO)COCCO] |
| IVf | 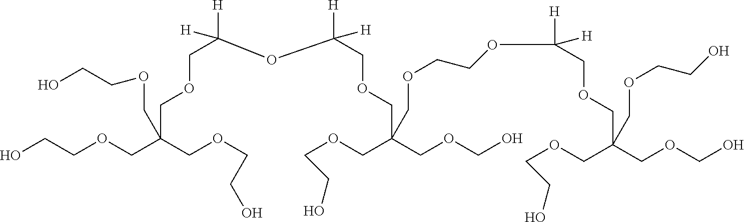 [SMILES: OCCOCC(COCO)(COCCO)COCCOCCOCC(COCO)(COCCO)COCCOCCOCC(COCCO)(COCCO)COCCO] |
| IVg | 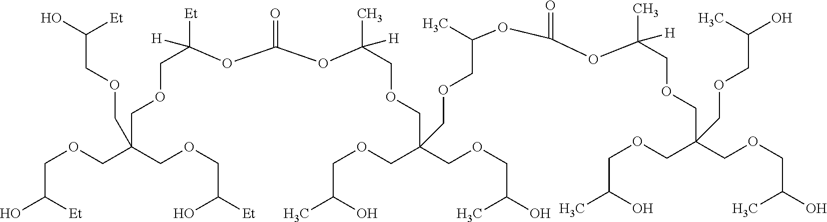 [SMILES: CCC(O)COCC(COCC(O)CC)(COCC(O)CC)COCC(CC)OC(=O)OC(C)COCC(COCC(C)O)(COCC(C)O)COCC(C)OC(=O)OC(C)COCC(COCC(C)O)(COCC(C)O)COCC(C)O] |
| IVh | 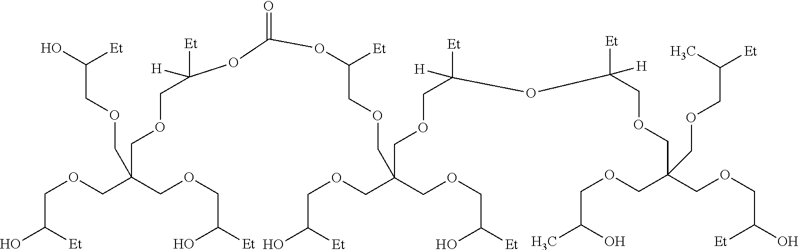 [SMILES: CCC(C)COCC(COCC(C)O)(COCC(O)CC)COCC(CC)OC(CC)COCC(COCC(O)CC)(COCC(O)CC)COCC(CC)OC(=O)OC(CC)COCC(COCC(O)CC)(COCC(O)CC)COCC(O)CC] |
| IVi | 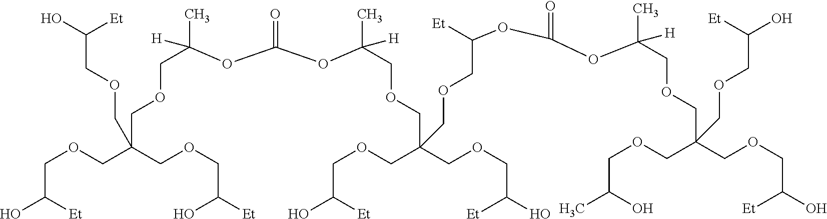 [SMILES: CCC(O)COCC(COCC(O)CC)(COCC(O)CC)COCC(C)OC(=O)OC(C)COCC(COCC(O)CC)(COCC(O)CC)COCC(CC)OC(=O)OC(C)COCC(COCC(C)O)(COCC(O)CC)COCC(O)CC] |
| IVk | 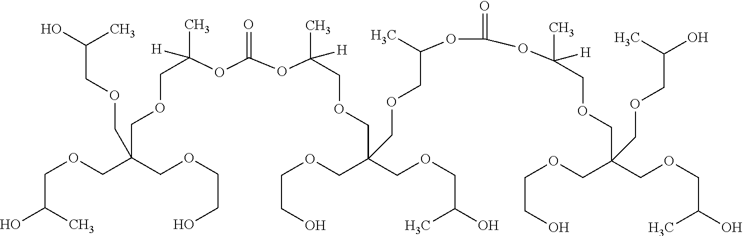 [SMILES: CC(O)COCC(COCCO)(COCC(C)O)COCC(C)OC(=O)OC(C)COCC(COCCO)(COCC(C)O)COCC(C)OC(=O)OC(C)COCC(COCCO)(COCC(C)O)COCC(C)O] |
| IVj | 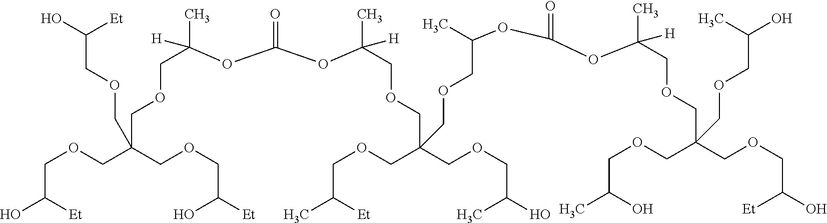 [SMILES: CCC(C)COCC(COCC(C)O)(COCC(C)OC(=O)OC(C)COCC(COCC(C)O)(COCC(C)O)COCC(O)CC)COCC(C)OC(=O)OC(C)COCC(COCC(O)CC)(COCC(O)CC)COCC(O)CC] |
| IVl | 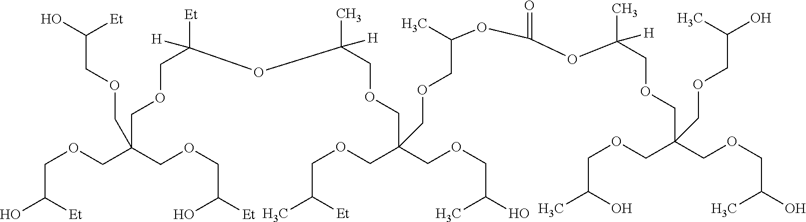 [SMILES: CCC(C)COCC(COCC(C)O)(COCC(C)OC(=O)OC(C)COCC(COCC(C)O)(COCC(C)O)COCC(C)O)COCC(C)OC(CC)COCC(COCC(O)CC)(COCC(O)CC)COCC(O)CC] |
| IVm | 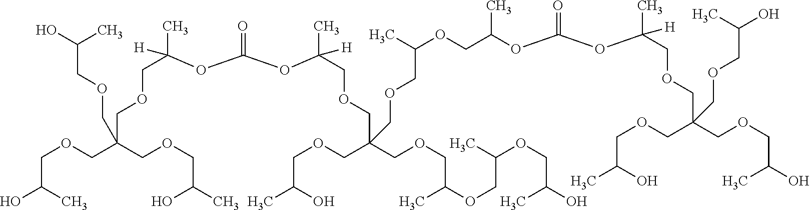 [SMILES: CC(O)COCC(COCC(C)O)(COCC(C)O)COCC(C)OC(=O)OC(C)COCC(COCC(C)O)(COCC(C)OCC(C)OCC(C)O)COCC(C)OCC(C)OC(=O)OC(C)COCC(COCC(C)O)(COCC(C)O)COCC(C)O] |
| IVn | 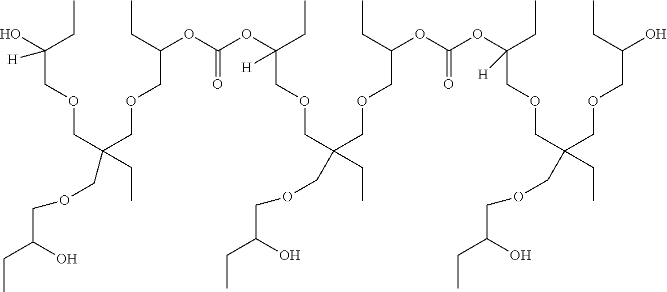 [SMILES: CCC(O)COCC(CC)(COCC(O)CC)COCC(CC)OC(=O)OC(CC)COCC(CC)(COCC(O)CC)COCC(CC)OC(=O)OC(CC)COCC(CC)(COCC(O)CC)COCC(O)CC] |
| IVo | 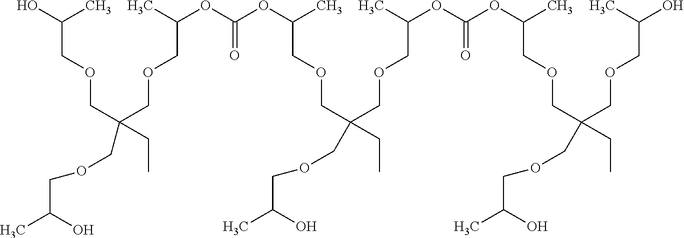 [SMILES: CCC(COCC(C)O)(COCC(C)O)COCC(C)OC(=O)OC(C)COCC(CC)(COCC(C)O)COCC(C)OC(=O)OC(C)COCC(CC)(COCC(C)O)COCC(C)O] |
| IVp | 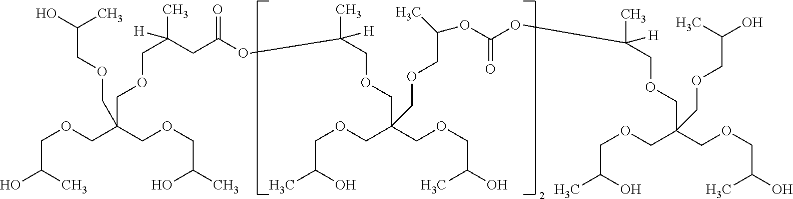 |
| IVq | 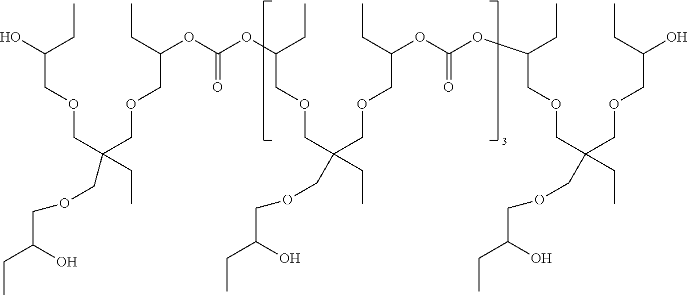 |
| IVr | 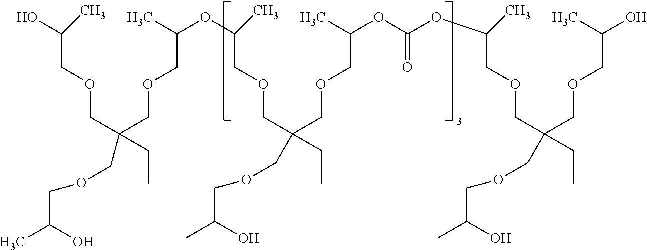 |

Illustrative higher polyols IVa-IVo represent aliphatic higher polyols IV comprising 3 monomeric polyol residues (z=1) and in which X¹ is a carbonate group or an oxygen ether group. Illustrative higher polyols IVp-IVr represent aliphatic higher polyols IV comprising more than 3 monomeric polyol residues (z=2 or more) and in which X¹ is a carbonate group or an oxygen ether group. Higher polyols IV are thought to arise via reaction of an initially formed higher polyol with a source of a carbonate group and a source of 1 or more additional monomeric polyol residues. For example, during the formation of the polyol composition an initially formed higher polyol such as IIa could react with an initially formed higher aromatic polyol such as IIIa which could serve both as the source of a carbonate group and a source of an additional monomeric polyol residue. Alternatively, a higher polyol such as IIa could react with a source of carbonate groups, such as an aliphatic or aromatic polycarbonate, in the presence of a monomeric polyol such as Ia.

For convenience and simplicity, the fixed structures for higher polyols IV illustrated in Table 4 and throughout this disclosure may include structurally related homologues comprising residues of a monomeric polyol which is itself comprised of structurally related homologs.

The presence of 1 or more polyhydroxylated aromatic compounds in the polyol compositions disclosed herein is optional. The polyol composition may comprise at least one polyhydroxylated aromatic compound. The at least one polyhydroxylated aromatic compound is a compound containing at least one aromatic ring and at least 2 hydroxyl groups each bonded directly to an aromatic ring of such compound. The polyhydroxylated aromatic compound may be present within the polyol composition as a free (meaning unbound) compound, for example monomeric bisphenol A. Residues of the polyhydroxylated aromatic compound represent bound polyhydroxylated compound and may be present as residues in at least a portion of the higher polyol components. The polyhydroxylated aromatic compound in its free form may be present in the polyol composition in any amount that affords useful product properties. The polyol compositions may show a special utility in the preparation of high strength, heat resistant polyurethanes when the amount of polyhydroxylated aromatic compound in its free form is less than 32% by weight, 28% by weight, or 24% by weight based on the total weight of the polyol composition. The polyol compositions may show a special utility in the preparation of high strength, heat resistant polyurethanes when the amount of polyhydroxylated aromatic compound in its free form is greater than 10% by weight, 16% by weight, or 20% by weight based on the total weight of the polyol composition. The amount polyhydroxylated aromatic compound in bound form may be less than 10%, 5%, or 3% of the of the weight of the polyhydroxylated aromatic compound present in the polyol composition in free form. The amount polyhydroxylated aromatic compound in bound form may be greater than 1%, 4%, or 6% of the of the weight of the polyhydroxylated aromatic compound present in the polyol composition in free form.

Polyhydroxylated aromatic compounds and residues to which they relate include compounds which correspond to the formula Ar—(OH)_{f} wherein Ar comprises an aromatic radical and f is an integer of about 2 to about 6, or 2 to 4. The polyhydroxylated aromatic compounds may be diphenols. Exemplary diphenols include hydroquinone, resorcinol, dihydroxybiphenyls, bis(hydroxyphenyl)-C₁-C₅ alkanes, bis-(hydroxy-phenyl)-C₅-C₆ cycloalkanes, bis(hydroxyphenyl)ethers, bis(hydroxyphenyl)sulfoxides, bis(hydroxy phenyl) ketones, bis(hydroxyphenyl)sulfones and 4,4′-bis(hydroxyphenyl)diisopropyl benzenes, as well as derivatives thereof which have brominated and/or chlorinated nuclei. Exemplary diphenols may be 4,4′-dihydroxybiphenyl, bisphenol A, 2,4-bis(4-hydroxyphenyl)-2-methylbutane, 1,1-bis(4-hydroxyphenyl)-cyclohexane, 1,1-bis(4-hydroxyphenyl)-3,3,5-trimethyl-cyclohexane, 4,4′-dihydroxydiphenyl sulfide and 4,4′-dihydroxydiphenyl sulfone, as well as di- and tetrabrominated or chlorinated derivatives thereof, such as 2,2-bis(3-chloro-4-hydroxyphenyl) propane, 2,2-bis-(3,5-dichloro-4-hydroxyphenyl)propane or 2,2-bis(3,5-dibromo-4-hydroxy-phenyl)propane. The diphenols can be used individually or as arbitrary mixtures.

The polyhydroxylated aromatic compounds may be polyhydroxylated aromatic compounds having structure V

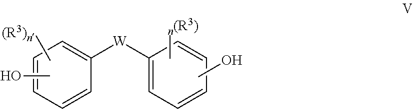

wherein R³, W, n and n′ are as disclosed herein.

Additionally, R³ may be independently at each occurrence a halogen atom, a nitro group, a C₁-C₁₀ aliphatic radical, a C₅-C₁₀ cycloaliphatic radical, or a C₆-C₂₀ aromatic radical; W may be a bond or a linking oxygen atom, a sulfur atom, a sulfur oxide linking group, a C₁-C₁₀ aliphatic radical, a C₅-C₁₀ cycloaliphatic radical, or a C₆-C₂₀ aromatic radical; and the variables n and n are independently an integer from 0 to 4.

Additionally, R³ may be independently at each occurrence a halogen atom, a nitro group, a C₁-C₅ aliphatic radical, a C₅-C₁₀ cycloaliphatic radical, or a C₆-C₁₀ aromatic radical; W may be a bond or a linking oxygen atom, a sulfur atom, a sulfur oxide linking group, a C₁-C₅ aliphatic radical, a C₅-C₁₀ cycloaliphatic radical, or a C₆-C₁₅ aromatic radical; and the variables n and n′ are independently an integer from 0 to 4.

Additionally, R³ may be independently at each occurrence a halogen atom, a C₁-C₂ aliphatic radical, a C₅-C₈ cycloaliphatic radical, or a C₆-C₁₀ aromatic radical; W may be a bond or a linking oxygen atom, a sulfur atom, a sulfur oxide linking group, a C₁-C₃ aliphatic radical, a C₅-C₉ cycloaliphatic radical, or a C₆-C₁₃ aromatic radical; and the variables n and n′ are independently an integer from 0 to 2.

Specific examples of polyhydroxylated aromatic compounds having structure V are given in Table 5.

TABLE 5
Illustrative Polyhydroxylated Aromatic Compounds V
Structure

| | |
|---|---|
| 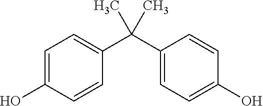 [SMILES: CC(C)(c1ccc(O)cc1)c1ccc(O)cc1] | Va |
| 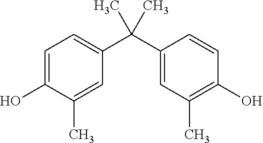 [SMILES: Cc1cc(C(C)(C)c2ccc(O)c(C)c2)ccc1O] | Vb |
| 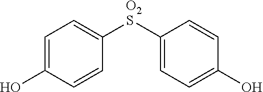 [SMILES: O=S(=O)(c1ccc(O)cc1)c1ccc(O)cc1] | Vc |
| 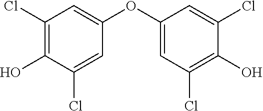 [SMILES: Oc1c(Cl)cc(Oc2cc(Cl)c(O)c(Cl)c2)cc1Cl] | Vd |
| 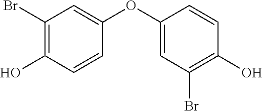 [SMILES: Oc1ccc(Oc2ccc(O)c(Br)c2)cc1Br] | Ve |
| 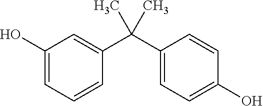 [SMILES: CC(C)(c1ccc(O)cc1)c1cccc(O)c1] | Vf |
| 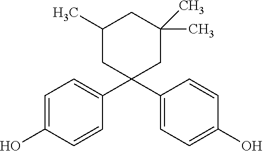 [SMILES: CC1CC(C)(C)CC(c2ccc(O)cc2)(c2ccc(O)cc2)C1] | Vg |
| 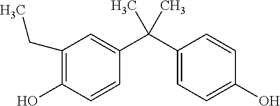 [SMILES: CCc1cc(C(C)(C)c2ccc(O)cc2)ccc1O] | Vh |
| 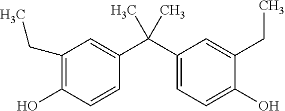 [SMILES: CCc1cc(C(C)(C)c2ccc(O)c(CC)c2)ccc1O] | Vi |
| 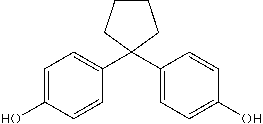 [SMILES: Oc1ccc(C2(c3ccc(O)cc3)CCCC2)cc1] | Vj |
| 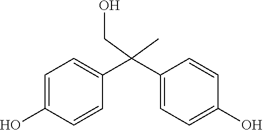 [SMILES: CC(CO)(c1ccc(O)cc1)c1ccc(O)cc1] | Vk |
| 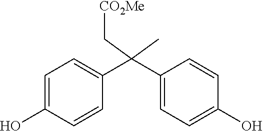 [SMILES: COC(=O)CC(C)(c1ccc(O)cc1)c1ccc(O)cc1] | Vl |
| 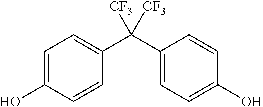 [SMILES: Oc1ccc(C(c2ccc(O)cc2)(C(F)(F)F)C(F)(F)F)cc1] | Vm |
| 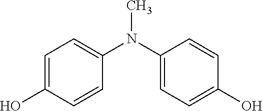 [SMILES: CN(c1ccc(O)cc1)c1ccc(O)cc1] | Vn |
| 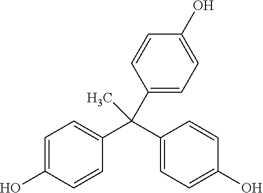 [SMILES: CC(c1ccc(O)cc1)(c1ccc(O)cc1)c1ccc(O)cc1] | Vo |
| 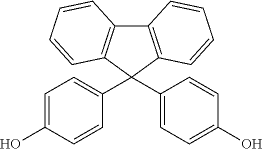 [SMILES: Oc1ccc(C2(c3ccc(O)cc3)c3ccccc3-c3ccccc32)cc1] | Vp |
| 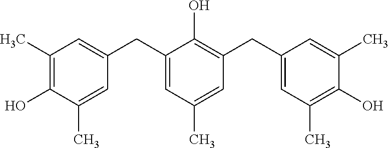 [SMILES: Cc1cc(Cc2cc(C)c(O)c(C)c2)c(O)c(Cc2cc(C)c(O)c(C)c2)c1] | Vq |
| 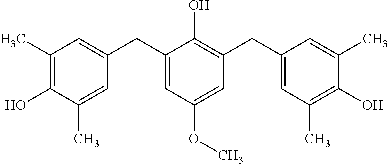 [SMILES: COc1cc(Cc2cc(C)c(O)c(C)c2)c(O)c(Cc2cc(C)c(O)c(C)c2)c1] | Vr |
| 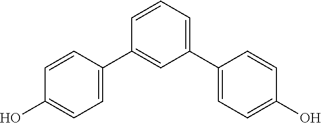 [SMILES: Oc1ccc(-c2cccc(-c3ccc(O)cc3)c2)cc1] | Vs |
| 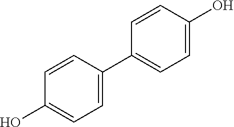 [SMILES: Oc1ccc(-c2ccc(O)cc2)cc1] | Vt |
| 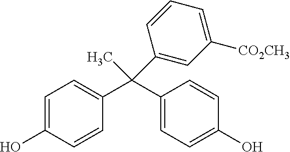 [SMILES: COC(=O)c1cccc(C(C)(c2ccc(O)cc2)c2ccc(O)cc2)c1] | Vu |
| 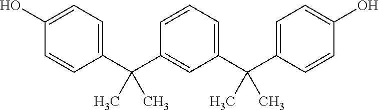 [SMILES: CC(C)(c1ccc(O)cc1)c1cccc(C(C)(C)c2ccc(O)cc2)c1] | Vv |

The polyol compositions are typically free flowing, low color, homogeneous liquids at 150° F. and are relatively viscous liquids at room temperature. The polyol compositions may have viscosities of less than 5000 cps, 2000 cps, 1000 cps or 200 cps at 150° F. The polyol compositions may have viscosities of greater than 100 cps, 400 cps, or 1000 cps at 150° F. While the chemical structures of the components of the polyol composition and their concentration may be the primary determinant of the utility of the polyol compositions in the preparation of foamable and foamed polyurethane compositions, the relatively low viscosity of the polyol compositions makes it possible to manufacture such foamed polyurethanes and articles comprising them using conventional manufacturing equipment, such as commercially available meter mixing systems, reaction injection molding machines and extruders. Commercially available meter mixing systems are ill suited for use with highly viscous polyols which may require specialized pumping and higher temperature handling capabilities than are currently available. The lower viscosity of the polyol compositions allows more complete mixing at lower temperature of the polyol composition (a), polyisocyanate (b) and blowing agent (c) components of a foamable polyurethane formulation prior to foaming of the formulation. This in turn may moderate the exotherm arising as the formulation foams and cures. Where foaming and curing takes place within a mold, lower in-mold peak exotherm temperatures make the use of FRP tooling more efficient by extending the useful life of such tooling. Similarly, cycle times may be reduced as a result of lower in-mold peak exotherm temperatures.

Chromatographic and mass spectral analysis (See Experimental Part) of the polyol composition indicates a mixture of the starting monomeric polyol, higher polyols and, when present, free polyhydroxylated aromatic compound. Both the complexity of exemplary commercially available monomeric polyols such as PEP-450 polyols (structure Ia, Table 1) and the nature of the exchange reactions taking place during the preparation of the polyol composition make direct chemical analysis of the product polyol composition exceedingly difficult. The polyol composition as disclosed herein may contain, based on the entire weight of the composition, about 25% by weight or greater monomeric polyol, about 20% by weight or greater of a first higher polyol comprising 2 residues of the monomeric polyol linked by a single carbonate group, about 10% by weight or greater of a second higher polyol comprising 3 residues of the monomeric polyol linked by 2 carbonate groups, about 5% by weight or greater of a third higher polyol comprising 4 residues of the monomeric polyol linked by 3 carbonate groups and about 1% by weight or greater of a fourth higher polyol comprising 5 residues of the monomeric polyol linked by 4 carbonate groups. The polyol composition as disclosed herein may contain, based on the entire weight of the composition, about 35% by weight or less monomeric polyol, about 30% by weight or less of a first higher polyol comprising 2 residues of the monomeric polyol linked by a single carbonate group, about 20% by weight or less of a second higher polyol comprising 3 residues of the monomeric polyol linked by 2 carbonate groups, about 10% by weight or less of a third higher polyol comprising 4 residues of the monomeric polyol linked by 3 carbonate groups and about 5% or less of a fourth higher polyol comprising 5 residues of the monomeric polyol linked by 4 carbonate groups.

Polyol compositions comprising the higher polyol component and the monomeric polyol component but being essentially free of any polyhydroxylated aromatic compound or residues thereof may be prepared by reacting a monomeric polyol or a suitable polyol derivative with a source of carbonate groups which is essentially free of both free polyhydroxy aromatic compounds and components comprising residues of any polyhydroxylated aromatic compound. Exemplary carbonate sources include aliphatic carbonates such as dimethyl carbonate, diethyl carbonate, dipropyl carbonate, dibutyl carbonate, diisobutyl carbonate, dipentyl carbonate, dihexyl carbonate, diheptyl carbonate, dioctyl carbonate, didecyl carbonate, and didodecyl carbonate. Exemplary carbonate sources include cycloaliphatic carbonates such as dicyclohexyl carbonate, methyl cyclohexyl carbonate, dicyclopenyl carbonate, ethyl cyclopentyl carbonate, 1,3-propanediol carbonate, 1,4-butanediol carbonate and 1,5-pentanediol carbonate.

Additional exemplary carbonate sources include dimethyl dicarbonate, diethyl dicarbonate, di-t-butyl dicarbonate (BOC anhydride), diisopropyl dicarbonate, dibutyl dicarbonate, dicyclopentyl dicarbonate, dicyclohexyl dicarbonate, dimethyl tricarbonate, diethyl tricarbonate, di-t-butyl tricarbonate and other aliphatic and cycloaliphatic bisorgano higher polycarbonates analogous to those disclosed above. Additional exemplary carbonate sources include bis((2-oxo-1,3-dioxolan-4-yl)methyl) carbonate (CAS No. 412312-38-0), (2-oxo-1,3-dioxolan-4-yl)methyl methyl carbonate, (2-Oxo-1,3-dioxolan-4-yl)methyl ethyl carbonate, (2-Oxo-1,3-dioxolan-4-yl)methyl propyl carbonate and (2-Oxo-1,3-dioxolan-4-yl)methyl butyl carbonate. Additional exemplary carbonate sources include phosgene equivalents such as carbonyl diimidazole, triphosgene and hexachloroacetone.

Such polyol compositions may be prepared by contacting the source of carbonate groups with at least one monomeric polyol comprising 3 or more hydroxyl groups under conditions sufficient to cause a portion of the hydroxyl groups of monomeric polyol to displace the groups attached to a carbonyl group of the carbonate source. This may be effected by contacting 1 or more monomeric polyols with a source of carbonate groups in the presence of a catalyst, a promotor or both a catalyst and a promotor or no catalyst or promoter, at a temperature ranging from about 0° C. to about 180° C. When, for example, dimethyl carbonate is the source of carbonate groups at least a portion of the hydroxyl groups of the monomeric polyol displace methoxy groups initially attached to the carbonyl group resulting in the formation of methanol. Similarly, where the source of carbonate groups is di-t-butyl dicarbonate (BOC ON) transfer of 1 of the carbonate groups of the di-t-butyl dicarbonate to hydroxyl groups of the monomeric polyol results in the formation of 2 molecules of t-butyl alcohol and 1 molecule of CO₂. The reaction may be driven towards completion by distilling residual components of the carbonate source (e.g. methanol and t-butanol) from the reaction mixture. The degree to which transfer of carbonate groups to the monomeric polyol and higher polyol species comprising residues of the monomeric polyol occurs can be determined by gravimetric and chemical analysis of the distillate. Proton NMR may be used for chemical analysis of the distillate. The product polyol composition may comprise a statistical mixture of the monomeric polyol and higher polyol species, the amounts of each being governed by the initial molar ratio of the monomeric polyol to carbonate groups of the carbonate source which are susceptible to transfer to the monomeric polyol and product higher polyol species containing resides of the monomeric polyol. Exemplary such initial molar ratios are greater than 1 to 1, greater than 1.5 to 1, greater than 2 to 1, greater than 3 to 1, and greater than 6 to 1. Exemplary such initial molar ratios are less than 15 to 1, less than 12 to 1, less than 9 to 1, less than 6 to 1, and less than 3 to 1. This initial molar ratio of the monomeric polyol to carbonate groups of the carbonate source which are susceptible to transfer may also be expressed as an initial molar ratio of hydroxyl groups of the monomeric polyol to susceptible carbonate groups of the carbonate source which may be greater than 4 to 1, greater than 6 to 1, greater than 8 to 1, greater than 10 to 1, less than 30 to 1, less than 25 to 1, less than 20 to 1, less than 15 to 1 and less than 12 to 1. Polycarbonate sources comprising multiple carbonate groups at least a portion of which are not susceptible to transfer include diorgano polycarbonates such as di-t-butyl dicarbonate which evolve a mole of carbon-dioxide for each mole of carbonate group transferred. Exemplary catalysts and promoters include those disclosed herein as well as those known in the art.

Polyol compositions comprising a polyhydroxylated aromatic compound may be prepared by reacting a monomeric polyol or a suitable polyol derivative with a polyhydroxylated aromatic compound, such as a bisphenol, or a polyhydroxylated aromatic compound derivative, such as a bisphenol derivative, under conditions promoting the formation of the higher polyol components of the polyol composition. The reaction may advantageously be carried out in the presence of a catalyst, a promoter or a combination thereof. Illustrative catalysts and promoters include organic bases, inorganic bases, metal oxides, and organometallics. Catalysts are distinguished from promoters in that promoters are consumed during the formation of the polyol composition whereas catalysts are not consumed. Illustrative organic bases include salts of carboxylic acids such as sodium acetate and tri-octyl ammonium isovalerate; salts of sulfonic acids such as sodium dodecyl sulfonate; amine bases, such as trialkyl amines exemplified by tri-butyl amine, N,N′-tetra-isopropyl ethylene diamine, polyhydroxylated amines such as tris(hydroxypropyl)amine and amine-containing monomeric polyols such as Vf-Vm of Table 5 of U.S. Ser. No. 10/053,533 which is incorporated herein by reference in its entirety; amidine bases such as N,N′-tri-isopropyl phenyl amidine and N,N′-tri-methyl butyl amidine, and guanidine bases such as Barton-Elliott bases illustrated by N,N′,N″-penta-isopropyl guanidine. Illustrative inorganic bases include metal carbonates such as sodium carbonate, potassium carbonate, magnesium carbonate and barium carbonate, and metal hydroxides such as lithium hydroxide, sodium hydroxide, potassium hydroxide and barium hydroxide. Illustrative metal oxides include aluminum oxide, silica, calcium oxide, magnesium oxide, tin oxide, and zinc oxide. Illustrative organometallics include tri-isopropyl aluminate, tetraalkyl zirconates, and organometallic transesterification catalysts such as tetra-isopropyl titanate and tetra-octyl titanate.

The formation of the polyol composition may occur by formation of carbonate linkages between one or more monomeric polyols to generate higher polyol components of the polyol composition. The carbonate linkages may be supplied by any suitable carbonate containing species, which include the exemplary carbonate species disclosed herein. Where it is desired that the polyol composition comprise a polyhydroxy aromatic compound, aromatic carbonate containing species are particularly well adapted to this purpose. The aromatic carbonate containing species may be a simple aromatic carbonate such as diphenyl carbonate or may be an oligomeric or polymeric species containing aromatic carbonate groups, such an aromatic polycarbonate or a polyester polycarbonate species containing aromatic carbonate linkages.

Aromatic carbonate linkages are defined herein as carbonate linkages which are linked via at least one oxygen atom directly to an aromatic ring. Both bisphenol A monomethyl carbonate (CAS No. 122890-41-9) and bisphenol A dimethyl carbonate (CAS No. 4824-74-2) are aromatic carbonates and contain aromatic carbonate linkages as that term is defined herein. Aromatic carbonate species containing fully aromatic carbonate groups are exemplified by diaryl carbonates such as diphenyl carbonate, bisphenol A monocarbonate (CAS No. 34074-60-7) and oligomeric and polymeric aromatic carbonates such as bisphenol A polycarbonate. Suitable carbonate species include aliphatic, cycloaliphatic and aromatic carbonate species and may at times herein be referred to as activating agents.

The aromatic polycarbonate employed may be either an oligomeric material or may be a high molecular weight material. In one or more aspects, an aromatic polycarbonate containing significant amounts of both high and low molecular weight polycarbonate may be employed in the same reaction mixture in which the polyol composition is formed. The polycarbonate may have a number average molecular weight of about 1000 g/mol or greater, about 10,000 g/mol or greater or about 20,000 g/mol or greater. The polycarbonate may have a number average molecular weight of about 100,000 g/mol or less, about 80,000 g/mol or less, or about 60,000 g/mol or less. Number average molecular weights of polycarbonates may be determined using gel permeation chromatography together with polystyrene molecular weight standards.

The polycarbonate may be a copolycarbonate comprising 2 or more different polyhydroxylated aromatic structural types. The polycarbonate may be a homopolymer comprising polyhydroxylated aromatic residues of a single structural type, for example bisphenol A residues. The polycarbonate may comprise endcap groups provided by common chain terminators such as cumyl phenol end groups or phenol end groups. The polycarbonate may comprise aromatic hydroxyl end groups only. The polycarbonate may be branched or linear and may be commercial grade polycarbonate or scrap polycarbonate recovered from a polycarbonate molding operation.

The polycarbonate may be in any suitable form such as polycarbonate-containing powders, polycarbonate-containing pellets, polycarbonate-containing flakes, polycarbonate-containing chips, polycarbonate-containing shards, polycarbonate-containing lumps, polycarbonate-containing solid cakes, polycarbonate-containing intact articles, polycarbonate-containing shredded articles, or a combination of any of the foregoing. The polycarbonate may be used in a molten form, as for example when a molten strand of polycarbonate is brought into initial contact with a suitable monomeric polyol and a catalyst at temperature sufficient to dissolve or prevent solidification of the strand. The polycarbonate may be comprised entirely of virgin polycarbonate, or may comprise from 1 to 100% post-consumer polycarbonate-containing material.

Exemplary polycarbonates for use in the preparation of the polyol composition component may be represented by generic structure VI

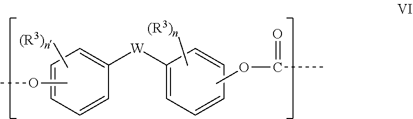

wherein R³; W, n and n′ are as disclosed herein.

Specific examples of exemplary aromatic polycarbonates are given in Table 6.

TABLE 6
Illustrative Polycarbonates VI
Structure

| | |
|---|---|
| 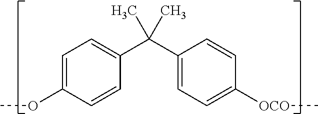 | VIa |
| 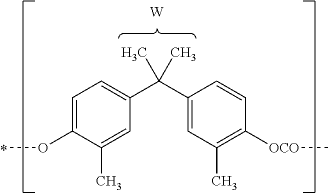 | VIb |
| 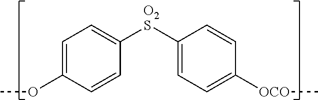 | VIc |
| 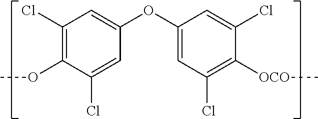 | VId |
| 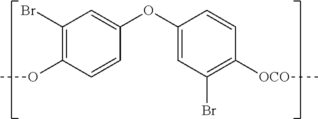 | VIe |
| 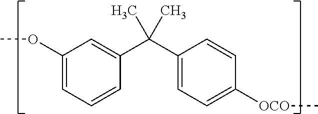 | VIf |
| 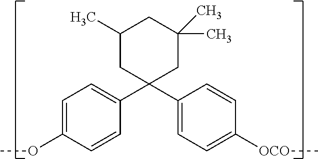 | VIg |
| 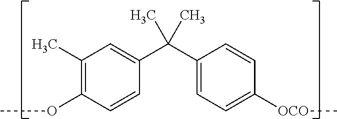 | VIh |
| 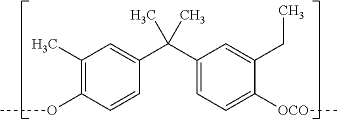 | VIi |
| 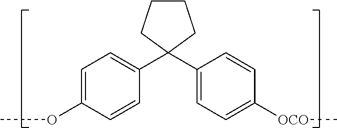 | VIj |
| 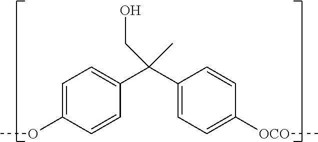 | VIk |
| 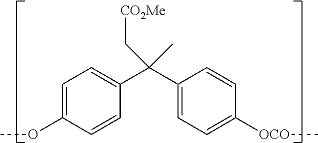 | VIl |
| 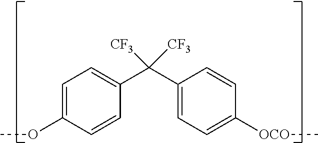 | VIm |
| 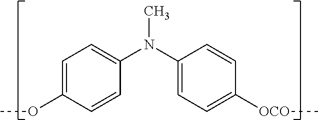 | VIn |
| 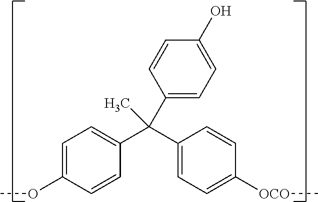 | VIo |
| 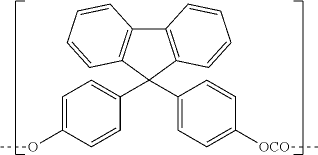 | VIp |
| 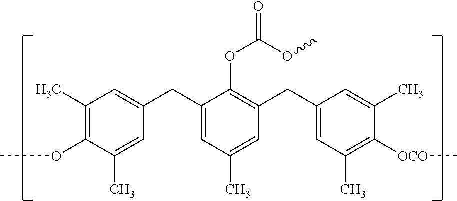 | VIq |
| 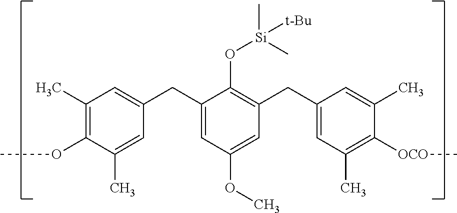 | VIr |
| 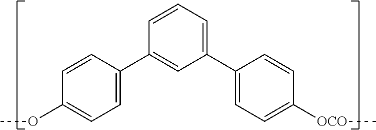 | VIs |
| 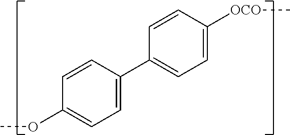 | VIt |
| 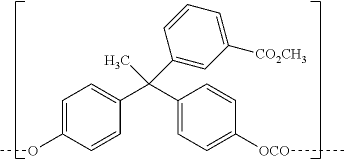 | VIu |

Copolycarbonates for use according to one or more aspects of the disclosure may be illustrated by polycarbonate materials comprising 2 or more of the structural units shown in illustrative Entries VIa-VIu, for example a copolycarbonate comprising both structural units VIa (bisphenol A polycarbonate) and VIf (m,p-bisphenol A polycarbonate) within the same polymeric material.

Where the carbonate source used in the preparation of the polyol composition is a polycarbonate, chain terminators present in the polycarbonate may be present in the polyol composition in both free and bound forms. Because such chain terminators are typically present at levels less than about 2% by weight in the polycarbonate composition itself, levels of chain terminators in any form in such polyol compositions will be less than 1%, less than 0.5%, or less than 0.25% by weight based on the total weight of the polyol composition. Exemplary chain terminators used in aromatic polycarbonates include phenolic compounds. Exemplary phenolic compounds include phenol, p-chlorophenol, p-tert-butylphenol, 4-(1,3-dimethyl-butyl)-phenol and 2,4,6-tribromophenol; and long chain alkylphenols, such as monoalkylphenols or dialkylphenols which contain a total of 8 to 20 carbon atoms in their alkyl substituents. Specific examples include 3,5-di-tert-butyl-phenol, p-iso-octylphenol, p-tert-octylphenol, p-dodecylphenol, 2-(3,5-dimethylheptyl)-phenol and 4-(3,5-dimethylheptyl)-phenol. Exemplary branching agents include tri- or multi-functional phenols for example phloroglucinol, 4,6-dimethyl-2,4,6-tris(4-hydroxyphenyl)-2-heptene, 4,4-dimethyl-2,4,6-tris(4-hydroxyphenyl) heptane, 1,3,5-tris(4-hydroxyphenyl)benzene, 1,1,1-tris(4-hydroxyphenyl)ethane, tris(4-hydroxyphenyl)-phenyl-methane, 2,2-bis[4,4-bis(4-hydroxyphenyl)cyclohexyl]-propane, 2,4-bis [1-(4-hydroxyphenyl)-1-methylethyl]phenol, tetrakis(4-hydroxyphenyl)-methane, 2,6-bis(2-hydroxy-5-methyl-benzyl)-4-methyl-phenol, 2-(4-hydroxyphenyl)-2-(2,4-dihydroxyphenyl) propane, and tetrakis(4-[1-(4-hydroxyphenyl)-1-methylethyl]-phenoxy)-methane.

When one or more of such other activating agents is employed instead of an oligomeric or polymeric polycarbonate, the monomeric polyol(s) and the bisphenol(s) may be reacted under conditions similar to those described in the Experimental Part of this disclosure, but may advantageously also include an additional step in which either or both of the monomeric polyol and the polyhydroxylated aromatic compound is first reacted with the activating agent to form aliphatic carbonate groups, fully aromatic carbonate groups, mixed aliphatic and aromatic carbonate groups and/or a mixture two or more of the foregoing carbonate groups. The initial reaction with the activating agent may be carried out at a lower or higher temperature than a subsequent conversion to the polyol composition, for instance of about 15° C. or greater, about 25° C. or greater, about 50° C. or greater, or about 75° C. or greater and about 250° C. or less, about 200° C. or less, about 175° C. or less, or about 150° C. or less. Monomeric polyols include polyols disclosed herein.

The polyol composition may be used in the preparation of foamable polyurethane compositions and foamed polyurethane compositions without a purification step.

Polyhydroxylated aromatic, diphenol, or bisphenol polycarbonates may serve as both the source of the free and bound polyhydroxylated aromatic compound present in the product polyol composition, and as the source of aromatic carbonate groups (the activating agent) needed to efficiently form the higher polyol components of the polyol composition. By way of example, a polyhydroxylated aromatic polycarbonate may be heated in the presence of a catalyst together with a monomeric polyol comprising at least 3 hydroxyl groups at a temperature sufficient to cause the formation of mixed carbonate linkages between polyhydroxylated aromatic polycarbonate moieties of lower molecular weight than the polycarbonate used as the initial starting material. A mixed carbonate linkage may undergo further exchange with a hydroxyl group of the monomeric polyol to form a first higher polyol comprising 2 residues of the monomeric polyol linked by a single carbonate group. The first higher polyol may itself undergo further exchange with a mixed carbonate to afford additional higher polyol components. A mixed carbonate linkage may lose carbon dioxide and form aromatic ether linkages between a polycarbonate moiety and the residue of the monomeric or higher polyol participating in the mixed carbonate linkage but this may be minimized by careful control of the reaction conditions. As the reaction between the polycarbonate, the monomeric polyol and higher polyols continues the concentration of carbonate linkages not including a participating polyhydroxylated aromatic moiety increases as molecular weight of the remaining polycarbonate moieties decreases. When a sufficient quantity of the monomeric polyol is used, essentially all of the carbonate linkages in the polycarbonate may be converted into mixed carbonates, or carbonates between one or more monomeric polyol residues. The product polyol composition may comprise a statistical mixture of products resulting from chain scission of the polycarbonate starting material and may include a substantial amount of free polyhydroxylated aromatic compound as well as unconsumed monomeric polyol.

The relative amounts of monomeric polyol and activating agent serving a source of carbonate groups of the higher polyols of the polyol composition are chosen such that physical and chemical properties of the polyol composition may be tuned as needed. The viscosity of the polyol composition may be controlled by varying the molar ratio of hydroxyl groups present in the starting monomeric polyol to carbonate groups, or equivalents thereof, in the activating agent. Where an aromatic polycarbonate serves as the source of carbonate groups in the polyol composition, the molar amount of activating agent is taken as moles of aromatic carbonate groups present in the given weight of the aromatic polycarbonate. Where the activating agent is bisphenol A polycarbonate, the molar amount of reactive carbonate groups is taken as the total weight of the polycarbonate divided by the group molecular weight of the repeat unit, 254 g/mol. The molar ratio of hydroxyl groups present in the starting monomeric polyol to carbonate groups, or equivalents thereof, in the activating agent may be greater than 5, greater than 6, or greater than 8. The molar ratio of hydroxyl groups present in the starting monomeric polyol to carbonate groups, or equivalents thereof, in the activating agent may be less than 14, less than 11, or less than 10. The molar ratio of the monomeric polyol to activating agent may be about 1.2:1 or greater, about 1.5:1 or greater or about 2:1 or greater. The molar ratio of the monomeric polyol to activating agent may be about may be about 4:1 or less, about 3:1 or less, or about 2:1 or less. Where a catalyst is present, any catalyst that is effective in causing the formation of the higher polyols may be used. The catalyst may be present in an amount based on the weight of the reaction mixture of about 0.0001% by weight or greater, about 0.01% by weight or greater, about 0.2% by weight or greater or about 1% by weight or greater. The catalyst may be present in an amount based on the weight of the reaction mixture of about 10% by weight or less, about 5% by weight or less, or about 2% by weight or less. Where a promoter is present, any promoter that is effective in causing the formation of the higher polyols may be used. The promoter may act to solubilize and/or compatibilize reactants used to create the polyol composition and enhance reaction rates of chemical transformations that result in the formation of the higher polyols. The promoter may be present in an amount based on the weight of the reaction mixture of about 0.01% by weight or greater, about 1.0% by weight or greater, or about 10% by weight or greater. The promoter may be present in an amount based on the weight of the reaction mixture of about 25% by weight or less, about 15% by weight or less, or about 9% by weight or less. The process may be performed wherein the reaction mixture comprises 1 or more polyhydroxylated amines, for example diisopropanol amine (DIPA) which contains a reactive secondary amine as well as 2 reactive secondary hydroxyl groups. The promoter may be a polyhydroxylated amine having 1 or more tertiary amine groups. The tertiary amine group can function as a catalyst and/or promoter. Where the process is performed wherein the monomeric polyol is at least one polyhydroxylated amine having a tertiary amine group, the polyhydroxylated amine having a tertiary amine group may be present in an amount of about 1% by weight or greater, about 5% by weight or greater or about 9% by weight or greater based on the total weight of the reactants used to form the polyol composition. Where the process is performed wherein the monomeric polyol is at least one polyhydroxylated amine having a tertiary amine group, the polyhydroxylated amine having a tertiary amine group may be present in an amount of about 30% by weight or less, about 20% by weight or less or about 9% by weight or less based on the total weight of the reactants used to form the polyol composition.

The polyol composition may be prepared using at least 2 or more monomeric polyols, a first monomeric polyol containing no amine groups, and a second monomeric polyol containing a tertiary amine wherein the polyol containing a tertiary amine can function as the catalyst or a promoter. The ratio of first monomeric polyol to the second monomeric polyol containing a tertiary amine can be any ratio that results in formation of the desired polyol composition. The molar ratio of the first monomeric polyol to the second monomeric polyol containing a tertiary amine may be about 2:1 or greater, about 4:1 or greater or about 10:1 or greater. The molar ratio of the first monomeric polyol to the second monomeric polyol containing a tertiary amine may be about 25:1 or less, about 15:1 or less or about 10:1 or less.

There are disclosed polyol compositions useful in the preparation of novel foamed polyurethane materials having excellent physical properties. The polyurethane materials and articles containing them may be prepared using the techniques disclosed herein as well as art-recognized polyurethane polymer preparation and processing techniques such as those disclosed in E. N. Doyle's The Development and Use of Polyurethane Products (McGraw-Hill, Inc. 1971), Saunders' et al. Polyurethanes Chemistry and Technology, Parts I-II (Interscience Publishers), Saunders' Organic Polymer Chemistry (Chapman and Hall), J. M. Burst's Developments in Polyurethanes (Applied Science Publishers) and the Kirk Othmer Encyclopedia of Chemical Technology which are incorporated herein by reference in their entirety for all purposes.

When reacted with one or more polyisocyanates or polyisocyanate equivalents in the presence of a blowing agent the polyol compositions are converted into low density polyurethane foams with superior strength and manufacturability when compared to analogous polyurethane foams not incorporating such polyol compositions. Foamable polyurethane formulations comprising one or more of the polyol compositions disclosed herein exhibit less intense reaction exotherms during curing than do analogous foamable polyurethane formulations lacking such polyol compositions. Articles comprising the foamed polyurethane compositions disclosed herein may exhibit excellent shrinkage resistance.

The polyol compositions disclosed herein can be employed as in an easy to use A plus B plus C foamable polyurethane-forming formulation; component A comprising one or more polyisocyanates or polyisocyanate equivalents, component B comprising the polyol composition, and Component C comprising a blowing agent. Component B may be a mixture of 1 or more of the polyol compositions disclosed herein, and may contain 1 or more art recognized components such as polyurethane catalysts, mold release agents (both internal and external), and additional polyols. Component A may contain one or more polyisocyanates of any type, such as 1 or more polyisocyanate prepolymers and/or one or more monomeric polyisocyanates such as MDI and/or one or more oligomerized polyisocyanates such as HMDI trimer (CAS No. 3779-63-3), or component A may comprise one or more polyisocyanate prepolymers and be essentially free of monomeric and oligomeric polyisocyanates. Such A plus B plus C foamable polymer systems provide a useful alternative to systems affording relatively low strength foamed materials. Because the polyol compositions typically have a relatively low viscosity under normal processing temperatures, they may be combined with one or more polyisocyanates and injected at low pressure and moderate temperatures eliminating the need for expensive hydraulic presses and steel tooling such as are used in thermoplastic injection molding, and BMC and SMC processing. Low cost aluminum tooling or even gel-coat FRP tooling may be used advantageously due to the low injection pressure needed to fill the mold and the relatively low exotherm observed when the polyol compositions are reacted with polyisocyanates to form foamed polyurethanes. Significant advantages may attend the use of low cost tooling and processing equipment. Ease of processing during molding for example, will enhance the attractiveness of foamed polyurethanes comprising structural units derived from the disclosed polyol compositions relative to harder to process thermoplastics.

Foamable polyurethane formulations comprising the polyol compositions disclosed herein may be processed into foamed polyurethane-containing parts using one or more known processing techniques including extrusion, meter mixing, Reaction Injection Molding (RIM), Poured Open Molding, Poured Closed Molding, Sprayed Open Molding, and combinations thereof.

The polyol compositions disclosed herein may be incorporated into foamable polyurethane elastomer precursor formulations which provide for rapid set up times to produce foamed polyurethanes having enhanced physical properties required for certain applications.

The foamable composition may comprise a polyisocyanate or residue thereof having structure VII

R⁴—(NCO)ₘ VII

wherein R⁴ is a hydrocarbyl group and m is an integer, to form useful polyurethane materials. Such polyisocyanates or residue thereof may be referred to herein as an isocyanate functional component.

The isocyanate functional components VII can be in the form of isocyanate functional prepolymers, blocked polyisocyanates, monomers, oligomers, polymers or mixtures thereof having on average greater than 1 isocyanate group, and preferably 2 or more isocyanate groups. The isocyanate functional prepolymers can be any prepolymers prepared by reaction of an isocyanate functional compound with 1 or more compounds having on average more than 1 isocyanate reactive functional groups, such as hydroxyl, amine, thiol, carboxyl and the like, under conditions such that the prepolymers prepared have on average more than 1 isocyanate moiety (group) per molecule. The isocyanate functional compound may be any art recognized monomeric polyisocyanates, for example monomeric diphenylmethane diisocyanate (MDI), monomeric hexamethylene diisocyanate, monomeric isophorone diisocyanate, or mixtures thereof. The isocyanate functional blocked polyisocyanates may be any art recognized blocked polyisocyanates. The isocyanate functional oligomers may be any art recognized oligomeric polyisocyanates, for example oligomeric diphenylmethane diisocyanate (oligomeric MDI). Oligomeric aromatic polyisocyanates useful in the preparation of foamed polyurethanes as disclosed herein include those available from The Dow Chemical Company under the trademarks PAPI and VORANATE, such as VORANTE M220, PAPI 27 and PAPI 20 polymeric isocyanates. The isocyanate functional components are present in the foamable composition in a sufficient amount to form a cured foamed polyurethane component when exposed to curing conditions. Exemplary polyisocyanates useful in the invention and in preparing isocyanate functional prepolymers include any aliphatic, cycloaliphatic, araliphatic, heterocyclic or aromatic polyisocyanates, or mixtures thereof. The polyisocyanates used may have an average isocyanate functionality of about 2.0 or greater and an equivalent weight of about 80 or greater. The isocyanate functionality of the polyisocyanates may be about 2.0 or greater, about 2.2 or greater, or about 2.4 or greater; and may be about 4.0 or less, about 3.5 or less, or about 3.0 or less. Higher functionality may be used, but may cause excessive cross-linking and result in a foamable composition which is too viscous to handle and apply easily, and can cause the cured foamed polyurethane composition to be too brittle. The equivalent weight of the polyisocyanates may be about 80 or greater, about 110 or greater, or about 120 or greater; and may be about 300 or less, about 250 or less, or about 200 or less. Exemplary aliphatic polyisocyanates include those disclosed by Wu, U.S. Pat. No. 6,512,033 at column 3, line 3 to line 49, incorporated herein by reference. Exemplary isocyanates include, isophorone diisocyanate (cycloaliphatic), tetramethylxylene diisocyanate (aromatic), 1,6-hexa-methylene diisocyanate (aliphatic) and oligomeric or polymeric derivatives thereof, bis(4-isocyanatocylohexyl) methane, and trimethyl hexamethylene diisocyanate. The aliphatic isocyanates may be hexamethylene diisocyanate and oligomeric and polymeric derivatives thereof. Examples of cycloaliphatic isocyanates include trimers of hexamethylene diisocyanate, such as those available from Bayer under the trademark and designation DESMODUR N3300, DESMODUR N3400, DESMODUR N-100. Exemplary aromatic polyisocyanates may include those disclosed by Wu, U.S. Pat. No. 6,512,033 at column 3, line 3 to line 49, incorporated herein by reference. Aromatic isocyanates may include diphenylmethane diisocyanate (MDI), toluene diisocyanate and oligomeric and polymeric derivatives thereof.

Foamed polyurethane compositions and articles may be obtained by reacting the polyol composition in the presence of a blowing agent with a polyisocyanate or residue thereof having structure VII wherein R⁴ is a C₂-C₃₀ aliphatic radical, a C₅-C₂₀ cycloaliphatic radical, or a C₆-C₃₀ aromatic radical and m is an integer from 2 to 6, to provide a foamed polyurethane material. R⁴ may be a C₂-C₂₅ aliphatic radical, a C₅-C₁₅ cycloaliphatic radical, or a C₆-C₂₅ aromatic radical and m is an integer 2 or greater and 4 or less, or 3 or less. R⁴ may be a C₂-C₁₇ aliphatic radical, a C₅-C₁₃ cycloaliphatic radical, or a C₆-C₂₂ aromatic radical and m is an integer 2 or greater and 3 or less.

Exemplary polyisocyanates having structure VII are given in Table 7 and include aliphatic polyisocyanates VIIa-VIIe, cycloaliphatic polyisocyanates VIIf-VIIk, and aromatic polyisocyanates VIIl-VIIp.

TABLE 7
Illustrative Polyisocyanates VII
Structure

| | |
|---|---|
| 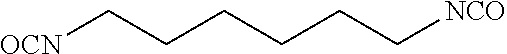 | VIIa |
| 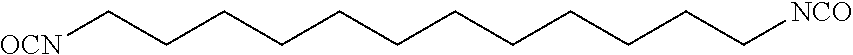 | VIIb |
| 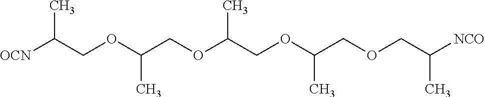 | VIIc |
| 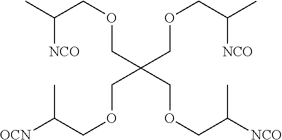 | VIId |
| 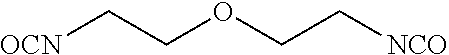 | VIIe |
| 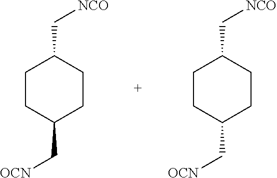 | VIIf |
| 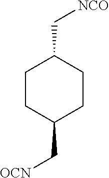 | VIIg |
| 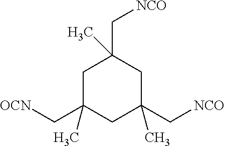 | VIIh |
| 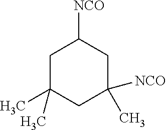 | VIIi |
| 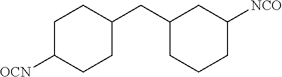 | VIIj |
| 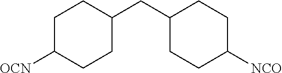 | VIIk |
| 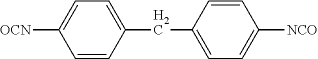 | VIIl |
| 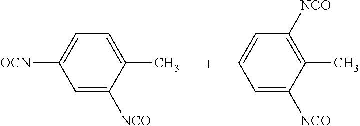 | VIIm |
| 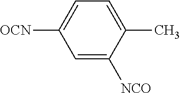 | VIIn |
| 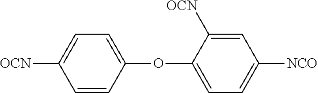 | VIIo |
| 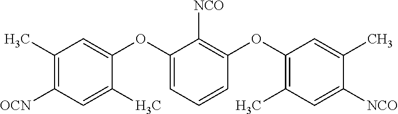 | VIIp |

There is disclosed a foamed polyurethane composition which may obtained by combining 1 or more polyisocyanates, for example polyisocyanates VIIl (4,4′-MDI) and VIIn (2,4-TDI), a prepolymer, or a latent polyisocyanate such as a blocked polyisocyanate such as are known in the art, with the polyol composition in the presence of 1 or more blowing agents to produce a foamable composition which upon curing in the presence of the blowing agent affords a foamed polyurethane composition. The polyol composition may be used as the crude reaction product in which it is formed, for example a crude reaction product obtained by contacting bisphenol A polycarbonate powder (2500 g) with a mixture of monomeric polyols Ia (7000 g) and Ie (500 g) in the presence of a metal hydroxide catalyst at a temperature in a range from about 140° C. to about 180° C. for a period of 20 minutes to 3 hours to provide a product polyol composition comprising either or both of monomeric polyols Ia and Ie, higher polyols derived from them, and free bisphenol A. The polyisocyanate may be combined with the polyol composition in amounts such that there is a slight excess of hydroxyl groups relative to isocyanate groups, thus assuring complete consumption of isocyanates VIIl and VIIn as the polyol composition is converted into a foamed polyurethane. The complexity of the polyol composition notwithstanding, such compositions can be converted to useful foamed polyurethane products without an intervening purification step. It may be useful to subject the polyol composition to a purification step prior to its conversion to a polyurethane. Exemplary purification steps include vacuum transfer removal of volatile components, filtration, basic and/or acidic extraction, microfiltration, nanofiltration, ultrafiltration, centrifugation, low temperature recrystallization, low temperature zone refining and trituration. If desired, essentially all of the free polyhydroxy aromatic compound, if present, in a polyol composition may be removed using a basic extraction protocol in which the polyol composition is dissolved in an organic solvent such as toluene, ethyl acetate, methylene chloride, and the like, for which the monomeric polyol and higher polyol components have a high affinity, and thereafter washing the solution of the polyol composition with aqueous base to deprotonate and extract the relatively acidic polyhydroxy aromatic compound, thereby separating it from the relatively non-acidic monomeric polyol and higher polyol components which remain in the organic phase. The aqueous base should be sufficiently basic to deprotonate and extract all of the polyhydroxy aromatic compound in 1 or more washes, but not so basic as to cause significant loss of carbonate groups present in the higher polyol. The aqueous base may comprise a solution of a metal hydroxide or metal carbonate in water, for example a solution of sodium hydroxide or potassium carbonate in water containing greater than 1% and less than 20% by weight sodium hydroxide or potassium carbonate.

In preparing the foamed polyurethane compositions and articles 1 or more additional polyols may be present in the foamable composition in addition to the monomeric and higher polyol components of the polyol composition. Such additional polyols are distinguished from monomeric polyols in that residues of the additional polyol are not present in the higher polyol component of the polyol composition. The additional polyol may be 1 or more of a polyalkylene oxide ether based polyol, a polyester polyol, a polyacrylate polyol or a polycarbonate polyol. Exemplary classes of polyols include polyether polyols, polyarylene ether polyols, polyester polyols, poly(alkylene carbonate)polyols, hydroxyl containing polythioethers and mixtures thereof. Polyether polyols may contain 1 or more alkylene oxide units in the backbone of the polyol. Exemplary alkylene oxide units are ethylene oxide, propylene oxide, butylene oxide and mixtures thereof. The alkylene oxides may contain straight or branched chain alkylene units. The polyol may contain propylene oxide units, ethylene oxide units or a mixture thereof. Where a mixture of alkylene oxide units is contained in a polyol, the different units can be randomly arranged or arranged in blocks of each alkylene oxide. The polyol may comprise propylene oxide chains with ethylene oxide chains capping the polyol. The polyols may be a mixture of diols and triols. The individual polyols may have a functionality of about 1.9 or greater, about 1.95 or greater, or about 2.0 or greater; and may have a functionality of about 6.0 or less, about 4.0 or less, about 3.5 or less, or about 3.0 or less. The equivalent weight of the additional polyols may be about 200 or greater, about 500 or greater, or about 1,000 or greater; and may be about 5,000 or less, about 3,000 or less, or about 2,500 or less. The additional polyols may be located in the second part of a foamable polyurethane composition. The additional polyols may be present in the composition in an amount of about 2% by weight or greater, about 10% by weight or greater or about 20% by weight or greater based on either the total weight of the polyol composition, the total weight of a foamable composition comprising (a) a first part comprising a polyisocyanate or latent polyisocyanate, (b) a second part comprising a polyol composition and (c) a third part comprising a blowing agent, or the weight of either the polyisocyanate component or the polyol composition component of the foamable composition. The additional polyol may be present in the composition in an amount of about 35% by weight or less, about 15% by weight or less or about 5% by weight or less based on either the total weight of the polyol composition, the total weight of a curable composition comprising (a) a first part comprising a polyisocyanate or latent polyisocyanate, (b) a second part comprising a polyol composition and (c) a third part comprising a blowing agent, or the weight of either the polyisocyanate component or the polyol composition component of the curable composition.

The foamable compositions may further comprise 1 or more compounds having 2 or more isocyanate reactive groups and a hydrocarbon backbone wherein the backbone may further comprise 1 or more heteroatoms. Such compounds may be of any molecular weight which provides useful physical characteristics in the product foamed polyurethane composition. Such compounds may be difunctional chain extenders, or crosslinkers having greater than 2 active hydrogen groups per compound. The chain extender may be a lower molecular weight, moderate molecular weight or higher molecular weight diamine; for example, ethylene diamine, 1,3-propylene diamine, 1,4 butylene diamine, N,N′-dimethyl hexamethylene diamine (lower molecular weight diamines); Jeffamine 400, Jeffamine 1000 (moderate molecular weight diamines); and Jeffamine 2000 and Jeffamine 4000 (higher molecular weight diamines). The compound having 2 or more isocyanate reactive groups may be a triamine such as bishexamethylene triamine (CAS No. 143-23-7), Jeffamine T-403, or Jeffamine T5000. The heteroatoms in the backbone may be oxygen, sulfur, nitrogen or a mixture thereof; oxygen, nitrogen or a mixture thereof; or oxygen. The molecular weight of such compounds having 2 or more isocyanate reactive groups and a hydrocarbon backbone wherein the backbone may further comprise 1 or more heteroatoms, be about 4000 g/mol or less, about 2000 g/mol or less, about 1000 g/mol or less, about 500 g/mol or less, or about 200 g/mol or less as determined by amine group titration, hydroxyl number, Zerewitinoff test, or a combination of two or more such methods. Such compounds having 2 or more isocyanate reactive groups may include a hydrocarbon backbone wherein the backbone may comprise 1 or more multifunctional alcohols, multifunctional alkanol amines, 1 or more adducts of a multifunctional alcohol and an alkylene oxide, 1 or more adducts of a multifunctional alkanol amine and an alkylene oxide or a mixture thereof. Exemplary multifunctional alcohols and multifunctional alkanol amines are ethane diol, propane diol, butane diol, hexane diol, heptane diol, octane diol, glycerin, trimethylol propane, pentaerythritol, neopentyl glycol, ethanol amines (diethanol amine, triethanol amine) and propanol amines (di-isopropanol amine, tri-isopropanol amine) and the like. Blends of such compounds having 2 or more isocyanate reactive groups may be used. The compound having 2 or more isocyanate reactive groups may be located in the second part of the foamable composition. Such compounds may be present in the composition in an amount of about 2% by weight or greater, about 3% by weight or greater or about 4.0% by weight or greater based on the total weight of the foamable composition. Such compounds may be present in the composition in an amount of about 16% by weight or less, about 12% by weight or less or about 10% by weight or less based on the total weight of the foamable composition.

Any of parts (a), (b), and (c) of the foamable composition part may comprise a catalyst for the reaction of hydroxyl groups with isocyanate groups and/or creating the blowing agent. Among exemplary catalysts are organometallic compounds as exemplified by organotin compounds, organozinc compounds, and organo copper compounds; metal alkanoates, and tertiary amines. Mixtures of classes of catalysts may be used, such as a mixture of a tertiary amine and 1 or more of organotin compounds or metal alkanoates. Such a mixture may include tertiary amines, such as dimorpholino diethyl ether, and a metal alkanoate, such as bismuth octoate. Included in organotin compounds are alkyl tin oxides, stannous alkanoates, dialkyl tin carboxylates and tin mercaptides. Stannous alkanoates include stannous octoate. Alkyl tin oxides include dialkyl tin oxides, such as dibutyl tin oxide and its derivatives. Exemplary organotin compounds are dialkyltin dicarboxylates and dialkyltin dimercaptides. Dialkyl tin dicarboxylates with lower total carbon atoms are preferred as they are more active catalysts in the compositions. Exemplary dialkyl dicarboxylates include 1,1-dimethyltin dilaurate, 1,1-dibutyltin diacetate and 1,1-dimethyltin dimaleate. Preferred metal alkanoates include bismuth octoate and bismuth neodecanoate. The organometallic compounds or metal alkanoates may be present in an amount of about 60 parts per million or greater, or about 120 parts by million or greater based on the total weight of the foamable composition. The organometallic compounds or metal alkanoates may be present in an amount of about 1.0% or less based on the weight of the composition, about 0.5% by weight or less or about 0.2% by weight or less based on the total weight of the foamable composition. Organotin compounds for use as catalysts are widely available commercially. Catalytically useful organozinc compounds, and organocopper compounds are exemplified by K-KaT XK 614 and NIAX LC-5636 and are available from King Industries and Momentive respectively. Exemplary tertiary amine catalysts include dimorpholinodialkyl ether, di((dialkyl-morpholino)alkyl)ethers, bis-(2-dimethylaminoethyl)ether and salts thereof, bis-(3-dimethylaminopropyl) amine and salts thereof, triethylene diamine, pentamethyldi-ethylene triamine, N,N-dimethylcyclohexylamine, N,N-dimethyl piperazine, 4-methoxyethyl morpholine, N-methylmorpholine, N-ethyl morpholine, diazabicyclo compounds and mixtures thereof. An exemplary dimorpholinodialkyl ether is dimorpholinodiethyl ether. An exemplary di((dialkylmorpholino)alkyl)ether is (di-(2-(3,5-dimethylmorpholino)ethyl)-ether). Diazabicyclo compounds are compounds which have diazobicyclo structures. Exemplary diazabicyclo compounds include diazabicycloalkanes and diazabicyclo alkene salts. Exemplary diazabicycloalkanes include diazabicyclooctane, available from Air Products under the trademark and designations, DABCO, DABCO WT, DABCO DC 1, DABCO DC 2, and DABCO DC 21. Diazabicycloalkene salts include diazabicycloundecene in the phenolate, ethylhexoate, oleate and formate salt forms, available from Air Products under the trademark and designations, POLYCAT SA 1, POLYCAT SA 1/10, POLYCAT SA 102 and POLYCAT SA 610. Tertiary amines may be employed in an amount, based on the weight of the composition of about 0.01% by weight or greater, about 0.05% by weight or greater, about 0.1% by weight or greater or about 0.2% by weight or greater and about 2.0% by weight or less about 1.5% by weight or less, or about 1.2% by weight or less based on the total weight of the foamable composition.

While foamed polyurethane compositions incorporating the polyol compositions disclosed herein are characterized by both low density and exceptional strength, such properties may be further enhanced through though the incorporation of 1 or more fillers. In the case of the 3-part foamable polyurethane composition, also referred to herein as a reactive mixture, any single part, any 2 parts or all 3 parts of may contain a filler. Fillers are added for a variety of reasons and 1 or more types of fillers may be utilized in the foamable composition. Fillers may be added to reinforce the foamed polyurethane composition, to impart the appropriate viscosity and rheology and to strike a balance between cost and the desired properties of the foamed polyurethane composition and the cost of the foamed polyurethane composition. Reinforcing fillers, such as 1 or more carbon blacks, 1 or more clays or non-pigmented fillers, 1 or more thixotropes or combinations thereof may be used. Such fillers are used in a sufficient amount to impart an acceptable balance of viscosity and cost to the formulation and to achieve the desired properties of the foamed polyurethane composition. Among fillers useful for this purpose are clays, untreated and treated talc, and calcium carbonates. Clays include kaolin, surface treated kaolin, calcined kaolin, aluminum silicates and surface treated anhydrous aluminum silicates. Kaolin is also known as Kaolinite and comprises compounds represented by the chemical formula Al₂Si₂O₅(OH)₄, and it most often occurs as clay-sized, plate like, hexagonally shaped crystals. The clays can be used in any form which facilitates formulation of a foamable polyurethane composition and product foamed polyurethane composition having the desired properties. The foamable polyurethane composition may further comprise fillers which function as a thixotrope (rheological additive). Such thixotropes are well known and include fumed silica and the like. Fumed silicas include organically modified fumed silicas. The thixotrope may be added to the foamable polyurethane composition in a sufficient amount to give the desired rheological properties. Additional exemplary fillers include glass flake, glass fibers carbon fiber and basalt fiber. Additional exemplary fillers include electrically conductive fillers which may include carbon nanotubes, such as Tuball 301.

The filler may be a fiber based material which may be present in woven and non-woven structures, individual fibers, rovings comprising a plurality of fiber strands, chopped fibers and the like. The filler may be applied to the outer surface of a foamed polyurethane article in order to further increase its dimensional stability and strength. The fillers may be glass, carbon, polymeric, metallic, ceramic and the like. The filler may be 1 or more of a continuous filament mat (CFM), a chopped or continuous strand mat (CSM), and an engineered stitched mat which may be used in single or multiple layers within a foamed polyurethane composite material prepared using the foamable compositions disclosed herein. Exemplary fillers include Continuous filament mat (CFM) fiberglass reinforcing materials available from Owens Corning, such as M8643, UNIFLO U500 series reinforcing materials, and UNIFLO U700 series reinforcing materials. Exemplary fillers include chopped strand mat (CSM) fiberglass reinforcing materials which include M6X1 CSM, M705 CSM and M723A CSM available from Owens Corning. Exemplary fillers include engineered knitted mat fiberglass reinforcing materials such as MULTIMAT reinforcing materials available from Owens Corning, ROVICORE reinforcing materials available from Chomarart, and FLOWMAT reinforcing materials available from Skaps Industries. Woven and non-woven reinforcing materials other than fiberglass may also be used, for example woven and non-woven carbon fibers. The reinforcing filler may comprise 1 or more sizing agents. The reinforcing filler may be essentially free of sizing agents. By essentially free of sizing agents it is meant that the reinforcing material was not treated with a sizing agent prior to contacting the foamable polyurethane composition or foamed polyurethane article.

The reinforcing material may be present in an amount 10% or greater, 20% or greater, 30% or greater, or 40% or greater based on the total weight of the foamable polyurethane composition, the foamed polyurethane composition or the foamed polyurethane article. The reinforcing material may be present in an amount 60% or less, 40% or less, or 20% or less based on the total weight of the foamable polyurethane composition, the foamed polyurethane composition or the foamed polyurethane article. Additionally, the reinforcing material may be present in an amount 90% or less, 80% or less, 70% or less, or 60% or less based on the total weight of the foamable polyurethane composition, the foamed polyurethane composition or the foamed polyurethane article prepared from it. Additionally, the reinforcing material may be present in an amount of 40% or greater, 60% or greater, or 80% or greater based on the total weight of the foamable composition, the foamed polyurethane composition or foamed polyurethane article prepared from it.

Foamed polyurethane composite materials incorporating the polyol compositions disclosed herein are conventionally prepared. The reinforcing material may be cut to fit within a tool cavity. Slits may be made in the reinforcing material to prevent buckling or puckering of the reinforcing material during mold filling. The reinforcing material is disposed within the tool and the tool is closed. A foamable polyurethane composition comprising a first part comprising 1 or more polyisocyanates or latent polyisocyanates, a second part comprising 1 or more polyol compositions disclosed herein, and a blowing agent is prepared in a meter mixing system and is delivered in an uncured state to the mold heated to a temperature greater than about 180° F. and less than about 220° F. and allowed to cure as voids are created in the nascent polyurethane matrix by the blowing agent. The blowing agent may be contained within either or both of the first and the second part of the foamable polyurethane composition, or may be introduced as an independent third component. Cure times and peak in-mold exotherms vary but are typically less than about 30 minutes and less than about 260° F. Cured composite parts may have excellent green strength and may be removed hot from the mold and may not require external support once removed in order to prevent deformation. The foamable polyurethane compositions disclosed herein, owing to the chemical structure and relatively low viscosity of the polyol composition component, flow easily around the reinforcing material as evidenced by the high quality (strength and appearance) of product composite parts and the mold fill times are the same whether a reinforcing material is present in the mold or not. Unfilled foamed polyurethane molded articles may be similarly prepared.

The foamable polyurethane compositions, foamed polyurethane compositions and foamed articles may further comprise a plasticizer commonly used in polyurethane compositions. The foamable polyurethane composition may contain plasticizers in any, in a portion of, or all of its constituent components. Exemplary plasticizers include straight and branched alkylphthalates, such as diisononyl phthalate, dioctyl phthalate and dibutyl phthalate, a partially hydrogenated terpene commercially available as “HB-40”, trioctyl phosphate, alkylsulfonic acid esters of phenol, toluene-sulfamide, adipic acid esters, castor oil, xylene, 1-methyl-2-pyrrolidinone and toluene. Exemplary plasticizers include branched plasticizers, such as branched chain alkyl phthalates, for example di-isononyl phthalates available under the Trademark PLATINOL N from BASF. The amount of plasticizer used is an amount sufficient to give the desired rheological properties and may act to homogeneously disperse the components in the foamable polyurethane composition upon mixing. The plasticizer may be present in about 1% by weight or greater of the composition, about 5% by weight or greater, or about 10% by weight or greater based on the total weight of the foamable polyurethane composition. The plasticizer may be present in about 50% by weight or less, 40% by weight or less or 20% by weight or less based on the total weight of the foamable polyurethane composition.

The various compositions, methods and articles disclosed herein may rely upon (a) a polyol composition comprising (i) at least one polyol comprising 3 or more hydroxyl groups and (ii) at least one cyclic carbonate comprising 1 or more hydroxyl groups; (b) at least one isocyanate functional component comprising isocyanate groups, latent isocyanate groups, or a mixture thereof; and (c) at least one blowing agent. Such polyol compositions may be used in a similar fashion to any of the various polyol compositions disclosed herein. The at least one polyol is exemplified by and may include any of the monomeric polyols and higher polyols disclosed herein. The polyol composition comprising the at least one polyol and cyclic carbonate may optionally include 1 or more polyhydroxylated aromatic compounds, such as those exemplified herein. Exemplary isocyanate functional components comprising isocyanate groups, latent isocyanate groups, or a mixture thereof, may include any of the polyisocyanates disclosed herein and any derivatives thereof. Exemplary blowing agents include any of the blowing agents disclosed herein. The polyol comprising 3 or more hydroxyl groups, the isocyanate functional component and the blowing agent may include any such polyols, polyisocyanates, latent polyisocyanates, or mixtures thereof, and blowing agents known in the art. Any of the foamable compositions, foamed articles, methods of preparing foamed compositions, and foamed compositions of matter may include (a) the polyol composition or residues thereof; (b) the isocyanate functional component or residues thereof; and (c) the at least one blowing agent, or residues thereof, in any relative amounts which afford the desired performance characteristics. Exemplary relative amounts of these components include those disclosed herein. Any of the foamable compositions, foamed articles, methods of preparing foamed compositions, and foamed compositions of matter may include any of the exemplary catalysts, promotors, additives, fillers, mold release agents, additional polyols, crosslinkers, chain extenders, plasticizers, and other components disclosed herein in amounts known to be suitable to those skilled in the art and include those exemplary amounts disclosed herein.

The at least one cyclic carbonate may comprise at least one hydroxyl group on a ring position of a cyclic carbonate ring, at least one hydroxyl group not on a ring position of a cyclic carbonate ring, or a combination thereof. Any cyclic carbonate comprising at least one hydroxyl group capable of reaction with the isocyanate functional component may be used. The at least one cyclic carbonate may comprise 1 or more cycloaliphatic and/or aromatic carbonate groups. The at least one cyclic carbonate may comprise 1 or more aliphatic radicals comprising 1 or more hydroxyl groups which may include hydroxylated alkyl groups. The at least one cyclic carbonate may comprise 1 or more hydroxymethyl groups. The at least one cyclic carbonate may comprise a single cyclic carbonate group or more than 1 cyclic carbonate groups. The at least one cyclic carbonate may comprise 1 or more 5, 6 or 7 membered ring cyclic carbonate groups or a mixture 2 or more thereof. The at least one cyclic carbonate may comprise glycerol carbonate, trimethylolpropane carbonate, or a mixture thereof.

Exemplary cyclic carbonates include those represented by structure VIII

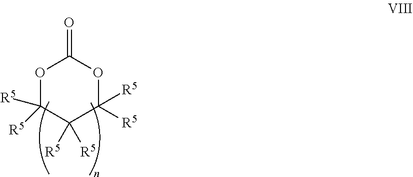

wherein R⁵ is independently at each occurrence a hydrogen atom, a hydrocarbyl group an aliphatic radical, a cycloaliphatic radical, an aromatic radical, a hydroxyl group, 2 R⁵ groups may together represent a carbonyl group, or 2 or more R⁵ groups may together form an aliphatic radical, a cycloaliphatic radical or aromatic radical and n is an integer, with the proviso that at least one R⁵ group represents a hydroxyl group or comprises a hydroxyl group.

R⁵ is independently at each occurrence a hydrogen atom, a C₁-C₆₀ aliphatic radical, a C₅-C₃₀ cycloaliphatic radical, a C₆-C₃₀ aromatic radical, a hydroxyl group, 2 R⁵ groups may together form a carbonyl group, or 2 or more R⁵ groups may together form a C₁-C₆ aliphatic radical, a C₅-C₃₀ cycloaliphatic radical or a C₆-C₃₀ aromatic radical, and n is an integer from 0 to 10, with the proviso that at least one R⁵ group is a hydroxyl group or comprises a hydroxyl group.

R⁵ is independently at each occurrence a hydrogen atom, a C₁-C₃₀ aliphatic radical, a C₅-C₂₀ cycloaliphatic radical, a C₆-C₂₀ aromatic radical, a hydroxyl group, 2 R⁵ groups may together form a carbonyl group, 2 or more R⁵ groups may together form a C₁-C₃₀ aliphatic radical, a C₆-C₂₀ cycloaliphatic radical or a C₆-C₂₀ aromatic radical, and n is an integer from 0 to 5, with the proviso that at least one R⁵ group is a hydroxyl group or comprises a hydroxyl group.

R⁵ is independently at each occurrence a hydrogen atom, a C₁-C₁₃ aliphatic radical, a C₅-C₁₄ cycloaliphatic radical, a C₆-C₁₃ aromatic radical, a hydroxyl group, 2 R⁵ groups may together form a carbonyl group, or 2 or more R⁵ groups may together form a C₁-C₁₃ aliphatic radical, a C₅-C₁₄ cycloaliphatic radical or a C₆-C₁₃ aromatic radical, and n is an integer from 0 to 3, with the proviso that at least one R⁵ group is a hydroxyl group or comprises a hydroxyl group.

Specific examples of cyclic carbonates VIII are given in Table 8.

TABLE 8
Illustrative Cyclic Carbonates VIII
Structure

| | |
|---|---|
| 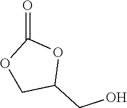 | VIIIa |
| 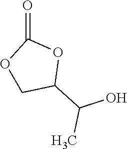 | VIIIb |
| 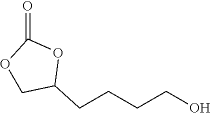 [SMILES: O=C1OCC(CCCCO)O1] | VIIIc |
| 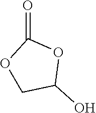 | VIIId |
| 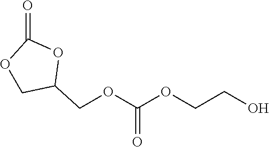 [SMILES: O=C(OCCO)OCC1COC(=O)O1] | VIIIe |
| 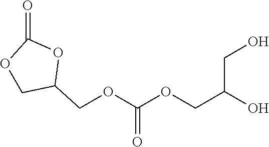 [SMILES: O=C(OCC(O)CO)OCC1COC(=O)O1] | VIIIf |
| 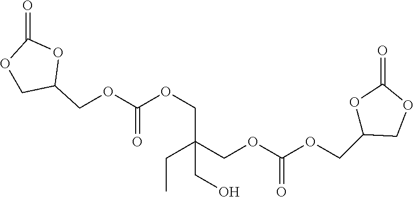 [SMILES: CCC(CO)(COC(=O)OCC1COC(=O)O1)COC(=O)OCC1COC(=O)O1] | VIIIg |
| 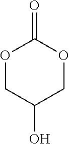 | VIIIh |
| 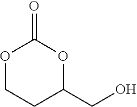 | VIIIi |
| 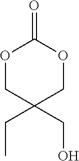 | VIIIj |
| 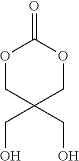 [SMILES: O=C1OCC(CO)(CO)CO1] | VIIIk |
| 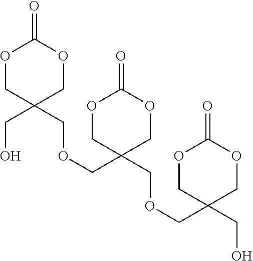 [SMILES: O=C1OCC(CO)(COCC2(COCC3(CO)COC(=O)OC3)COC(=O)OC2)CO1] | VIIIl |
| 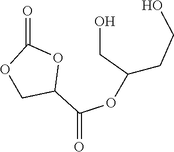 [SMILES: O=C1OCC(C(=O)OC(CO)CCO)O1] | VIIIm |
| 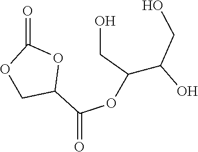 [SMILES: O=C1OCC(C(=O)OC(CO)C(O)CO)O1] | VIIIn |
| 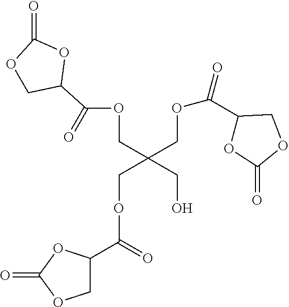 [SMILES: O=C1OCC(C(=O)OCC(CO)(COC(=O)C2COC(=O)O2)COC(=O)C2COC(=O)O2)O1] | VIIIo |
| 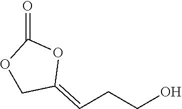 | VIIIp |
| 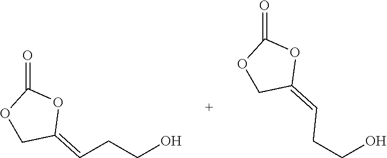 [SMILES: O=C1OC/C(=C/CCO)O1 ; O=C1OC/C(=C\CCO)O1] | VIIIq |
| 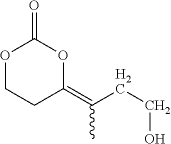 | VIIIr |
| 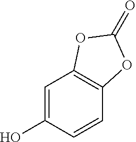 [SMILES: O=c1oc2ccc(O)cc2o1] | VIIIs |
| 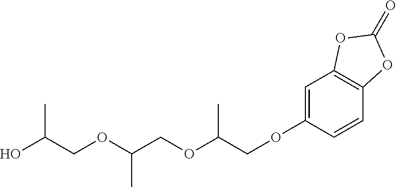 [SMILES: CC(O)COC(C)COC(C)COc1ccc2oc(=O)oc2c1] | VIIIt |
| 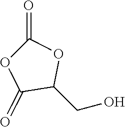 | VIIIu |
| 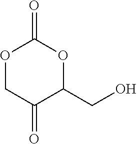 | VIIIv |
| 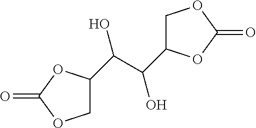 [SMILES: O=C1OCC(C(O)C(O)C2COC(=O)O2)O1] | VIIIw |

Illustrative cyclic carbonates VIIIa-VIIIw represent cyclic carbonates comprising 1 or more hydroxyl groups. Cyclic carbonates VIIId and VIIIh comprise at least one hydroxyl group on a ring position of a cyclic carbonate ring. Cyclic carbonates VIIIa-VIIIc, VIIIe-VIIIg, and VIIIi-VIIIw comprise at least one hydroxyl group not on a ring position of a cyclic carbonate ring. Cyclic carbonates VIIIa-VIIIr and VIIIu-VIIIw comprise cycloaliphatic carbonate groups. Cyclic carbonates VIIIs and VIIIt comprise aromatic carbonate groups. Cyclic carbonates VIIIa-VIIIc, VIIIe-VIIIf, VIIIi-VIIIk, VIIIm-VIIIn, VIIip-VIIir and VIIIu-VIIIv comprise 1 or more aliphatic radicals comprising 1 or more hydroxyl groups. For example, cyclic carbonate VIIIa (glycerol carbonate) relates to generic structure VIII in which n is 0, 1 of the R⁵ groups is the aliphatic radical CH₂OH, and 3 of the R⁵ groups are hydrogen. Aklyidene cyclic carbonate VIIIp relates to generic structure VIII in which n is 0, 2 R⁵ groups together form a Cₐ aliphatic radical comprising a hydroxyl group, and 2 R⁵ groups are hydrogen. Cyclic carbonates VIIIg, VIIIl and VIIIo comprise 1 or more cycloaliphatic radicals comprising 1 or more hydroxyl groups. For example, cyclic carbonate VIIIo relates to generic structure VIII in which n is 0, 1 of the R⁵ groups is a C₁₄ cycloaliphatic radical comprising 2 cyclic carbonate rings and a hydroxyl group, and 3 of the R⁵ groups are hydrogen. Cyclic carbonates VIIIs and VIIIt comprise 1 or more aromatic radicals comprising 1 or more hydroxyl groups. For example, cyclic carbonate VIIIs relates to generic structure VIII in which n is 0 and 4 of the R⁵ groups together form a C₆ aromatic radical comprising a hydroxyl group. Cyclic carbonate VIIIw is a dicarbonate of hexitol, mannitol dicarbonate, glucitol dicarbonate, allitol dicarbonate, iditol dicarbonate, galactitol dicarbonate or altritol dicarbonate.

### Experimental Part

### General

### Viscosity Measurements

Polyol viscosities were measured on a TA Instruments (New Castle, Del.) Discovery Hybrid Rheometer at steady state shear and variable temperature sweep using a 25 mm diameter parallel-plate geometry and a 1000 micron gap to provide viscosity values as a function of temperature according to the standard instrument operating protocols furnished by the manufacturer.

Exemplary polyol compositions include the monomeric polyol Pluracol PEP 450 (PEP 450) and higher polyols containing PEP 450 residues. PEP 450 has a nominal molecular weight of 368.46 g/mol but its average molecular weight is approximately 404 g/mol as determined from its manufacturer's reported hydroxyl number of 540-570 mg KOH/g. PEP 450 has a hydroxyl group content of about 16.8% by weight. Hydroxyl number is determined by ASTM E222 and is expressed as mg KOH per gram PEP 450. Dividing the molecular weight of KOH expressed in mg/mol (56,100 mg/mol) by the hydroxyl number taken here to be 555 mg/mol affords an equivalent weight of 101 g PEP 450 per equivalent of OH group. Multiplying the equivalent weight by the number of OH equivalents (4 per mol of PEP 450) affords a molecular weight of 404 g/mol.

Mol Wt PEP 450=(Mol Wt KOH (mg/mol)/(OH Number (mg KOH/g PEP))×4=404 g/mol

Exemplary foamable compositions include NIAX Silicone L-6888 surfactant from Momentive. L-6888 is a poylalkylene ether-polysiloxane copolymer, a class of silicone surfactants generally useful to assist and control nucleation sites for cell formation, to compatibilize the components of the foamable composition and to stabilize cells in the developing polyurethane foam.

Exemplary foamable compositions include 1 or more of an amine catalyst represented by NIAX A-99 (Momentive), JEFFCAT Z 130 (Huntsman), TOYOCAT DB30 and TOYOCAT DB60 (Tosoh); and/or an organometallic catalyst exemplified by K-KAT XK-614, a zinc-based catalyst (King Industries) and NIAX CATALYST LC-5636 a copper-based catalyst (Momentive).

Baydur 486, an exemplary polyisocyanate prepolymer having an isocyanate group concentration of 26.9-27.7 weight % from Covestro, is employed as the A component of a 3 part foamable composition containing in addition, a B component polyol composition as disclosed herein and a combination of a surfactant, a blowing agent and a catalyst as the C component. The C component is typically added to the B component polyol composition prior to mixing with the A component polyisocyanate, but may be added independently to a mixture of the A and B components. Surfactant-blowing agent-catalyst combinations employed are given in Table 9.

TABLE 9
Surfactant-Blowing Agent-Catalyst Combinations Employed

| Combination | | | | | |
|---|---|---|---|---|---|
| Name | BA 1 | BA 2 | Surfactant | Catalyst 1 | Catalyst 2 |
| C1 | Water | | L6888 | A99 | |
| C1.5* | Water | | L6888 | A99 | |
| C2 | Water | | L6888 | XK614 | Z130 |
| C3 | Water | | L6888 | Z130 | |
| C4 | Water | | L6888 | DB30:60 | |
| C5 | Water | | L6888 | XK614 | |
| C6 | Water | | L6888 | A99 | |
| C7 | Water | | L6888 | LC5636 | |
| C8 | Water | | L6888 | LC5636 | Z130 |
| C9 | Water | isopropanol | L6888 | LC5636 | |
| C10 | Water | isopropanol | L6888 | LC5636 | A99 |
| C11 | Water | | L6888 | LC5636 | A99 |
| N1 | Water | methyl | L6888 | LC5636 | A99 |
| | | formate | | | |
| N2 | Water | | L6888 | LC5636 | A99 |

BA 1 = blowing agent 1,
BA 2 = blowing agent 2,
L6888 = NIAX SILICONE L-6888,
A99 = NIAX A-99,
Z130 = JEFFCAT Z130 (Huntsman Corporation),
XK614 = K-KAT XK-614;
DB30:60 = an 8:2 blend of TOYOACAT DB30 and TOYOCAT DB60,
LC5636 = NIAX CATALYST LC-5636.
Combination C1.5 is a variant of Combination C1 that contains 50% additional water and 50% less L6888.
Combination “C2” included a blowing agent JEFFCAT-Z130:water.

Exemplary blowing agents include distilled water alone or distilled water in combination with isopropanol or methyl formate.

To remove any bias caused by trapped air in the polyol composition and polyisocyanate constituents of the foamable compositions, they are degassed prior to being combined to form the foamable composition. Degassing is carried out by heating the polyol composition to approximately 160° F. in a vacuum oven at slightly less than atmospheric pressure (at approximately 28 inches of mercury). The polyol composition is held within the vacuum oven until no further bubble evolution from within the liquid polyol composition is observed. This typically takes between 1 and 2 hours, depending on the polyol composition being degassed. Degassing of the polyisocyanate constituent is carried out similarly by adding a known amount of the polyisocyanate to a mixing cup and degassing separately from the polyol composition in a separate vacuum oven at 100 to 110° F. at slightly less than atmospheric pressure.

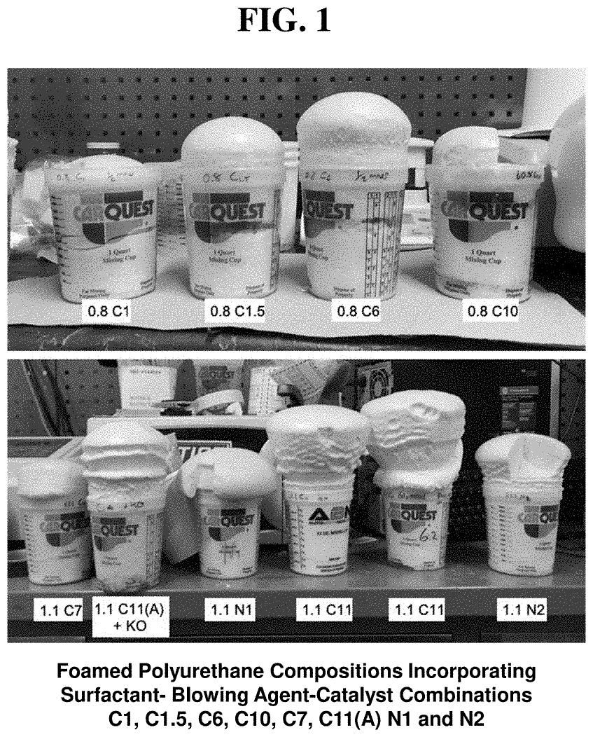

Cream time (CT), gel time (GT) and tack-free time (TFT) are used to characterize the performance of the foamed polyurethanes. The CT is a measure of the time it takes the foamable polyurethane composition to begin to rise, whereby time=0 seconds defines the time the precursors to the foamable composition are mixed together, and time=CT is the time at which the mixture begins to volumetrically expand from its initial volume. GT is defined as the time it takes the foamable composition to fully expand. GT is measured when both the lower section and the top section of the foamed polyurethane product exhibit hardness. The top section and the lower section of a typical foam are illustrated in FIG. 1 wherein the top section of the foam is the uppermost portion, or crown, of the foam in the photograph, and the lower section is that portion of the foam which has emerged from the mold but is disposed below the uppermost portion. This distinction is well illustrated in FIG. 1 by vertically foamed samples 0.8C1.5, 0.8C6, 1.1C11(A) and the 2 samples labeled 1.1C11. Sample 0.8C1 does not exhibit an accessible lower section. Hardness is considered achieved when considerable pressure must be exerted to indent the surface of the foamed polyurethane product. GT is invariably greater than the TFT. The TFT is measured using a wooden stick pressed very lightly on the accessible top and lower section surfaces of the foamed polyurethane. Typically, at time less than the TFT, the wooden stick adheres to the surface of the foamed polyurethane thereby causing a string-like feature to protrude from the surface of the foam attached to the wooden stick. This test is conducted at 30 second intervals following the complete rise of the foam. The TFT is assigned when the wooden utensil fails to adhere to the surface of the foamed polyurethane. Cream time (CT), gel time (GT) and tack-free time (TFT) are determined only for foamed polyurethane compositions prepared in open mold samples. Gel time and tack free time are not measured for closed-mold samples since the contents of the closed mold are not accessible at the relevant times. Cream time is typically measured during or just after the precursor mixing stage and prior to mold filling and is recorded for all closed-mold experiments.

Following degassing, the polyol composition is allowed to cool to just under 100° F. prior to the addition of the surfactant, catalyst and blowing agent. The polyol composition, surfactant, catalyst and blowing agent blend is mixed mechanically taking care to avoid the introduction of air. After a mixing time of approximately 30 seconds, the polyisocyanate component is added with stirring over approximately 10 seconds to the polyol composition containing the surfactant, catalyst and blowing agent and the starting time is recorded as t=0 seconds.

Compression tests are carried out according to the ASTM D1621 protocol conducted on 2 inch by 1 inch cubes cut from foamed polyurethane compositions prepared in open cups as detailed herein. Measurements are performed on an Instron 5900 (5964) series universal testing system using a 100 kN load cell (T489-73) and anvil (2501-163). All measurements are taken at a compression rate of 1.3 mm per minute at room temperature. The compressive properties presented herein are obtained from recorded stress-strain curves.

Densities of product foamed polyurethanes are measured in accordance with ASTM D1622.

### Examples 1-4 Foamed Polyurethane Compositions

Following the general procedure detailed above a series of foamed polyurethane compositions are prepared in open cups. Table 10 below illustrates the components of 4 foamable compositions in which the ratio of isocyanate groups to all hydroxyl groups, including any hydroxyl groups contributed by the blowing agent(s), is varied between 0.8 and 2.0. The polyol composition is that of Method 3 in this Experimental Section. The isocyanate component is Baydur 486. The Surfactant-Blowing Agent-Catalyst Combination is in each case combination “C1” (See Table 9 above).

TABLE 10
Foamable Compositions of Examples 1-4

| | | Mass | Mass | Mass Surfactant-Blowing |
|---|---|---|---|---|
| | | Isocyanate | Polyol | Agent-Catalyst Combination |
| Entry | Index | (g) | (g) | (g) |
| Example | 0.8 | 120 | 115.5 | 3 |
| 1 | | | | |
| Example | 1.2 | 120 | 76 | 3 |
| 2 | | | | |
| Example | 1.6 | 120 | 56.3 | 3 |
| 3 | | | | |
| Example | 2.0 | 120 | 44.4 | 3 |
| 4 | | | | |

TABLE 11
Cream Time, Gel Time and Tack Free Time for
Foamable Compositions of Examples 1-4

| | Cream Time | Gel Time | Tack Free |
|---|---|---|---|
| Entry | (seconds) | (seconds) | Time (seconds) |
| Example | 15 | 210 | 180 |
| 1 | | | |
| Example | 15 | 240 | 200-215 |
| 2 | | | |
| Example | 10-15 | 330 | 280-300 |
| 3 | | | |
| Example | 10-15 | 360 | 300-320 |
| 4 | | | |

The data in Table 11 illustrate that the foamable compositions of Examples 1-4 exhibit useful Cream, Gel and Tack Free Times.

FIG. 1 illustrates a series of foams prepared using the same polyol composition and polyisocyanate components as in Examples 1-4 at an isocyanate to hydroxyl group index of 0.8 and 1.1 but varying the surfactant-blowing agent-catalyst combinations employed. Reference to Table 9 may be made to establish the identity of the surfactant-blowing agent-catalyst combinations employed. The figure demonstrates that a wide variety of surfactant-blowing agent-catalyst combinations may be successfully employed to provide the product foamed polyurethane compositions disclosed herein.

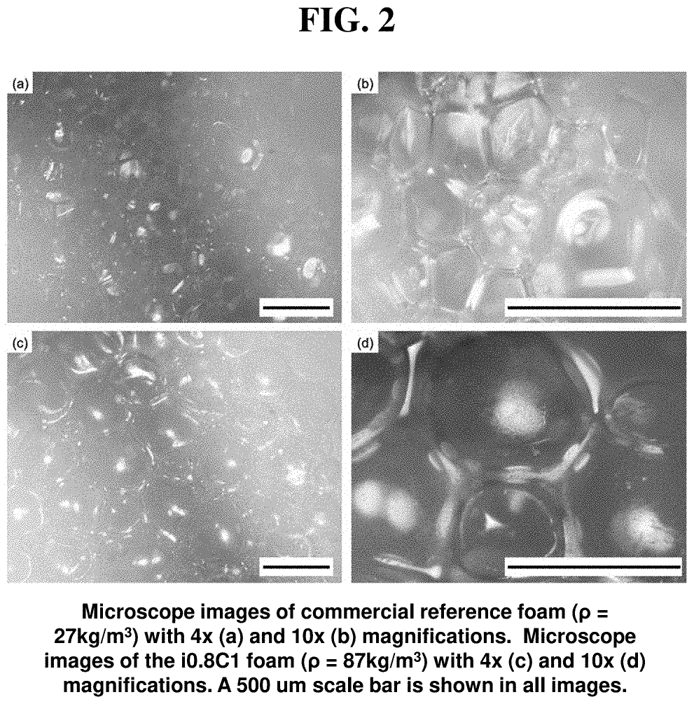

FIG. 2 shows microscope images of commercial reference foam (Comparative Example 1, Table 13 below) (density=27 kg/m³) with 4× (a) and 10× (b) magnifications compared with microscope images of the i0.8C1 foam (density=87 kg/m³) of Example 1 with 4× (c) and 10× (d) magnifications. A 500 um scale bar is shown in all images. The images demonstrate that closed cell foams having a relatively uniform cell size distribution are achievable in foams produced from the foamable compositions disclosed herein.

### Examples 5-10 Foamed Polyurethane Compositions with Variable Water to Surfactant Ratios

A series of foamed polyurethane compositions is prepared using the polyol composition of Method 3 and Baydur 486 in which the weight ratio of the blowing agent (water) to surfactant (L6888) is incrementally varied from 1:2 water to surfactant to 8:2 water to surfactant while simultaneously varying the amount of Catalyst 1 (LC5636) and Catalyst 2 (A99) as shown in Table 12. The foamable compositions are prepared with from 60 g of the polyol composition of Method 3 and the indicated amount of Baydur 486 (See column headed “Weight Iso.” in Table 12 below.)

TABLE 12
Foamable Compositions of Examples 5-10.

| | Weight | | | | |
|---|---|---|---|---|---|
| | Iso. | H₂O | L6888 | LC5636 | A99 |
| Entry | (g) | (g) | (g) | (g) | (g) |
| Example 5 | 98.6 | 1.00 | 2.00 | 0.13 | 0.13 |
| Example 6 | 106 | 1.50 | 1.50 | 0.19 | 0.19 |
| Example 7 | 110.6 | 1.80 | 1.20 | 0.23 | 0.23 |
| Example 8 | 113.5 | 2.00 | 1.00 | 0.25 | 0.25 |
| Example 9 | 115.6 | 2.14 | 0.86 | 0.27 | 0.27 |
| Example 10 | 117.3 | 2.25 | 0.75 | 0.28 | 0.28 |

Physical properties of the foamed polyurethane product compositions of Examples 5-10 and Comparative Example 1 are gathered in Table 13.

TABLE 13
Foamed Compositions Examples 5-10 and Comparative Example 1

| | | | | | Strength: |
|---|---|---|---|---|---|
| Sample | Water | | Compress | Compress | Density |
| (H₂O: | content | Density | Strength | Modulus | rate |
| surfactant) | (g) | (kgm⁻³) | (MPa) | (MPa) | (Nm kg⁻¹) |
| Comparative | Not | 30 | 0.14 | 4.92 | 4.67E+03 |
| Example 1 | applicable | | | | |
| Example 5 (1:2) | 1 | 98 | 1.65 | 10.55 | 1.68E+04 |
| Example 6 (2:2) | 1.5 | 80 | 0.34 | 12.69 | 4.25E+03 |
| Example 7 (3:2) | 1.8 | 90 | 1.55 | 101.36 | 1.72E+04 |
| Example 8 (4:2) | 2 | 59 | 1.30 | 127.56 | 2.20E+04 |
| Example 9 (5:2) | 2.14 | 48 | 1.39 | 53.64 | 2.90E+04 |
| Example 10 | 2.25 | 46 | 0.97 | 26.34 | 2.11E+04 |
| (6:2) | | | | | |

The compressive strength:density rate is significantly better for foamed polyurethane compositions prepared from the foamable compositions disclosed herein as compared with Comparative Example 1, which represents a commercially available foamed material, the microstructure of which is presented in FIG. 2 herein. The foamed polyurethane compositions of Examples 5-10 prepared from the foamable compositions disclosed herein generally exhibit between 3 and 4-times the strength to density rate shown by the Comparative Example 1.

### Example 11 Foamed Polyurethane Composition

Component A, Baydur 486, is maintained at 120° F. following degassing. Components B (the degassed polyol of Method 3) and C (water, the surfactant NIAX L6888 and the catalyst NIAX A-99) are thoroughly mixed at 180° F. Components A, B, C are then combined and mixed at 1500 RPM for 1 minute to provide a foamable composition comprising 60 parts by weight Baydur 486 and 40 parts by weight of Polyol Composition 3 and 0.10 parts by weight catalyst and 0.30% by weight of the blowing agent water based on the total weight of the Baydur 486 and the Polyol Composition 3. The foamable composition is transferred directly into a preheated open mold and cured for 20 minutes. A Tack Free Time (TFT) of approximately 1 minute and an in-mold maximum exotherm of 280° F. is observed. The product foamed polyurethane is produced as a slab and has a density of 0.2 g/cm³ and a compressive strength of 0.34 MPa.

### Example 12 Foamed Polyurethane Composition Prepared Using Commercial Meter Mixing System

Component A, Baydur 486, is maintained at 100° F. in the A side reservoir of a Baulé omega commercial meter mixing system. Component B, a polyol composition comprising a 1:1 parts by weight mixture of Polyol Composition 3 and PEP-450 containing 1.25% by weight NIAX L6888 surfactant, is maintained at 122° F. in the B side reservoir. Component C, the blowing agent (water), is maintained at ambient temperature in a first additive tank. Component D, the catalyst NIAX A-99 also at ambient temperature, is maintained in a second additive tank. Components A, B, C and D are combined in the mix head of the meter mixing system where they pass through a long dynamic mixer at 4,500 RPM at a flow rate of 2,500 g per minute to provide the foamable composition comprising 60.3 parts Component A, 39.7 parts Component B, 0.4 parts Component C and 0.2 parts Component D. The meter mixing system is calibrated to dispense 1 kg of the foamable composition into an open mold at ambient temperature. The material begins to foam in the open mold without the application of additional heat. The foamable composition exhibits a Rise Time (RT) of approximately 15 seconds, and a Tack Free Time (TFT) of approximately 3 minutes. The product foamed polyurethane composition exhibits a density of 0.104 g/cm³ and a compressive strength of 1.03 MPa.

### Polyol Compositions

Exemplary Methods 1-3 describe the preparation of Polyol Compositions 1-3 used in foamable polyurethane-forming formulations and in the preparation of foamed polyurethane compositions and articles.

Method 1: Preparation of Polyol Composition 1

To a 20-L reactor equipped with a mechanical agitator, overhead vent and nitrogen purge line is added the monomeric polyol, a propoxylated pentaerythritol, PLURACOL® PEP 450 (BASF), (8123.00 g, 22.05 mol, 67.48%), and a 20% solution of potassium hydroxide (4.2 g, 0.03%) in methanol. The contents of the reactor are stirred and heated to 150° C. A second monomeric polyol, pentaerythritol, (534.00 g, 3.92 mol, 4.44%) is added to the reactor with continued stirring. The pentaerythritol substantially dissolves within a 2 minute period. The mechanical agitator shaft speed is maintained at approximately 5000 rpm which corresponds to a linear velocity of the mixing blade of approximately 100 feet per second. Bisphenol A polycarbonate powder (3200.00 g, 26.59%), LEXAN® 105 (Sabic), is then added over a 7 minute period. After 25 minutes no polycarbonate powder remains visible in the reactor. Approximately 32 minutes after the addition of the polycarbonate is initiated, diisopropanol amine (132.00 g, 0.99 mol, 1.10%) is added to the reaction mixture. The rate of agitation is then lowered to approximately 1000 rpm and the reaction mixture is allowed to cool. When the reaction mixture reaches approximately 50° C., a phosphoric acid alkyl ester weakly acidic catalyst, Nacure 4000 (5.90 g, 0.05%) is added under stirring to quench any remaining potassium hydroxide and other basic species in the reaction mixture. After further cooling the entire contents of the reactor representing the product polyol composition are transferred to a storage vessel. The product polyol composition has a viscosity of 770 cps at 150° F.

Gel permeation chromatographic analysis (GPC) carried out by PolyAnalytik, Inc. (London, Ontario) using polystyrene molecular weight standards showed that the product Polyol Composition 1 contained an approximately 1.0 to 1.3 mixture of the starting monomeric polyol PEP-450 and a higher polyol mixture having a number average molecular weight (Mₙ) of 1335 g/mol, together with free bisphenol A. The product Polyol Composition 1 was analyzed by liquid chromatography and found to contain from about 22 to about 24% by weight free bisphenol A representing about 92 to about 94% of all bisphenol A residues present in the starting polycarbonate employed. Free bisphenol A may serve as a chain extender in subsequent reaction of the polyol composition with polyisocyanates. The remaining bisphenol A residues are believed to be present as residues bound to minor higher polyol components of the product polyol composition and as very short chain bisphenol A polycarbonate oligomers which, as evidenced by mass spectral data, appear to be present but in very low concentrations. The structures of alkoxylated monomeric polyol species such Ia, and higher polyol species such as IIa are idealized in the sense that they are in many instances mixtures of polyol species wherein the number of polyoxyalkylene units may vary from fewer than the number of such units shown to more than the number of such units shown in the nominal representations of the structure. (Contrast structure Ia (Table 1) and structure IIa (Table 2) with the variable structures Ia and IIa presented in this Experimental Part.) The structures Ia and IIa presented in Tables 1 and 2 and alkoxylated polyol structures throughout this disclosure are nominal structures in that they represent both the single structure shown as well as mixtures of closely related homologous compounds and their diastereomers.

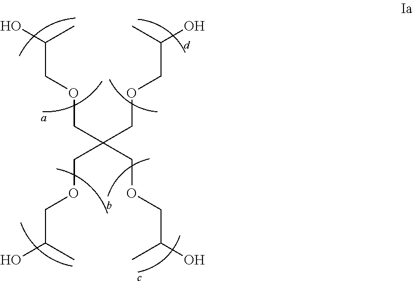

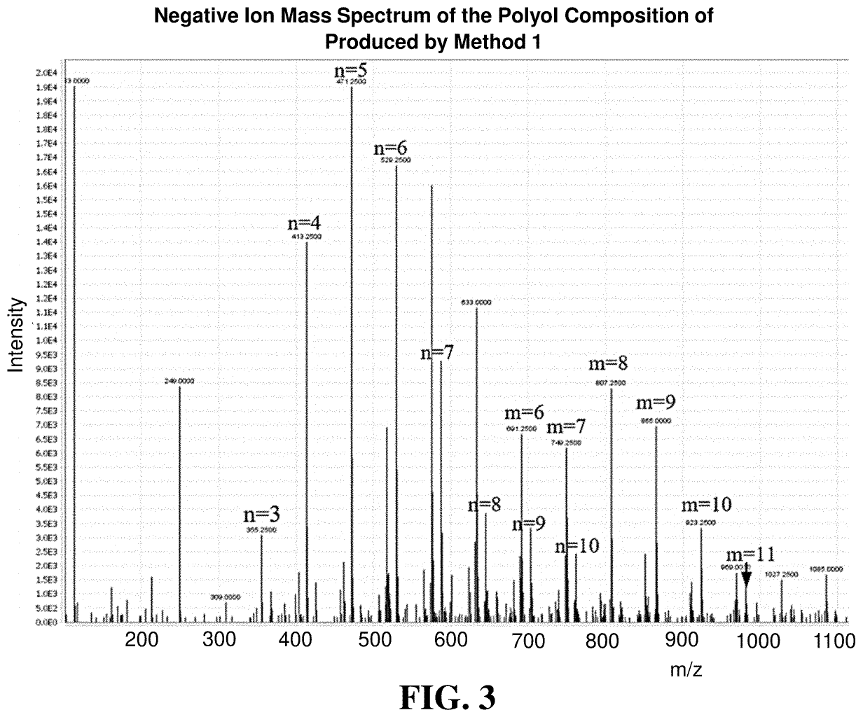

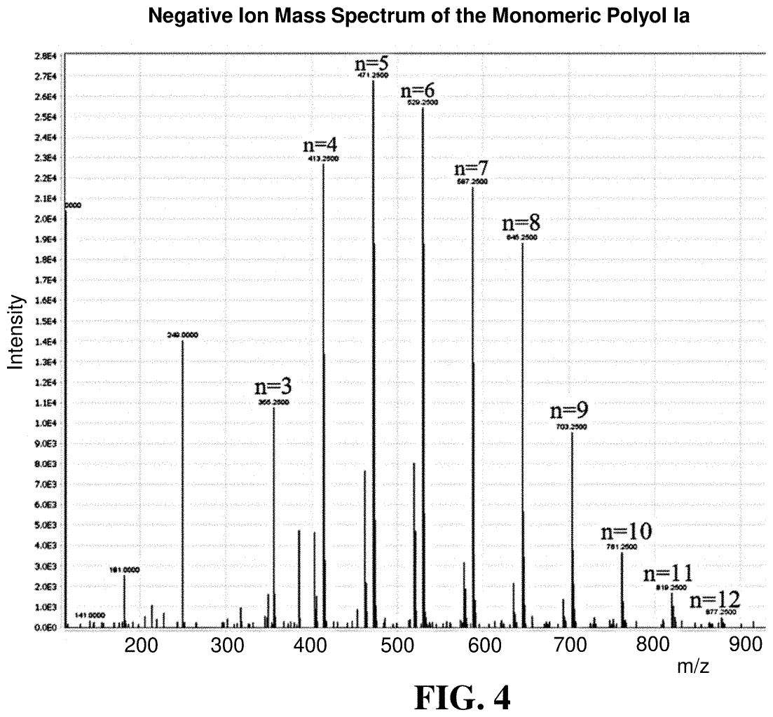

A detailed chromatographic (high pressure liquid chromatography and gel permeation chromatography) and mass spectral analysis carried out by Cambridge Polymer Group (Charlestown, Mass.) showed that the principal higher polyol component in the product polyol mixture was the monocarbonate of Pluracol PEP 450 and having nominal structure IIa, Table 2, which may also be represented by structure IIa shown here wherein subscripts a, b, c, d, e, f, g and h when summed represent the total number, m, of propylene oxide repeat units. The value of m has been determined by negative ion mass spectral analysis (FIG. 3) to range from 6 to at least one 1, however, the analytical method does not permit the identification of higher monocarbonate species IIa, for example a species wherein the sum of a-h (m) is 12. For reference, the subscripts a, b, c and d sum to an integer n which ranges from n=3 to n=12 inclusive. Negative ion mass spectral analysis (FIG. 4) of the starting monomeric polyol (PEP 450) shows it to contain a mixture of propoxylated pentaerythritol homologs Ia wherein the major components correspond to n=4, n=5, n=6, n=7 and n=8, with n=5 being the predominant species.

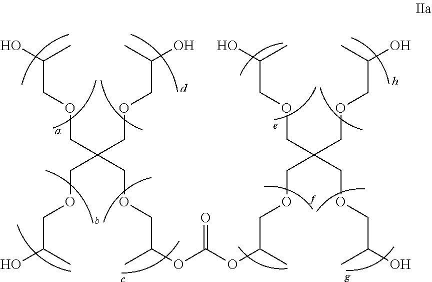

### Method 2: Preparation of Polyol Composition 2

The protocol of Method 1 is repeated on the same scale to produce polyol composition 2 using slightly more PEP 450 and slightly less bisphenol A polycarbonate. The polyol composition has a viscosity of 565 cps at 150° F.

### Method 3: Preparation of Polyol Composition 3

Following a procedure similar to that described in Method 1, but without the inclusion of diisopropanol amine and using essentially the same relative amounts of each of the other reactants; PEP-450, bisphenol A polycarbonate powder, pentaerythritol and potassium hydroxide affords Polyol Composition 3.

TABLE 14
Polyol Compositions 1-3

| Method | PEP | | | | Viscosity |
|---|---|---|---|---|---|
| of | 450 | PE | DIPA | PC | (eps) at |
| Preparation | %* | %* | %* | %* | 150° F. |
| Method 1 | 67.48 | 4.44 | 1.1 | 26.59 | 770 |
| Method 2 | 73.30 | 4.44 | 1.10 | 20.77 | 565 |
| Method 3 | 68.58 | 4.44 | 0 | 26.59 | |

*Weight % of the component based on the total weight of the product polyol composition.
PEP 450 = , PLURACOL^{R} PEP 450 (BASF),
PE = pentaerythritol,
DIPA = diisopropanol amine,
PC = bisphenol A polycarbonate.

### Method 4: Preparation Polyol Composition 4

To a 2-L glass reactor equipped with a mechanical agitator, overhead vent and nitrogen purge line is added the polyol Ia (PEP 450, 636.5 g, 1.56 mol), and (147.5 g, 1.25 mol) glycerol carbonate VIIIa. The contents of the reactor are stirred at 175° C. for 15 minutes to produce a colorless polyol composition having a viscosity significantly less than 1000 cps at 150° F. and a hydroxyl number of 519. The proton NMR spectrum is consistent with a mixture of glycerol carbonate and polyol Ia. This brief heat treatment is intended to drive out traces of methanol, dimethyl carbonate and water which are contaminants present in some commercial grades of glycerol carbonate. Such contaminants may act as undesired reactants during polyurethane formation.

Methods 5-8 are carried out analogously to Method 4. Polyol compositions 4-8 are listed in Table 15.

TABLE 15
Polyol Compositions 4-8

| | PEP | Glycerol | |
|---|---|---|---|
| Method of | 450 | Carbonate | Glycerol |
| Preparation | %* | %* | %* |
| Method 4 | 81 | 19 | 0 |
| Method 5 | 75 | 9 | 16 |
| Method 6 | 78 | 22 | 0 |
| Method 7 | 74 | 26 | 0 |
| Method 8 | 66 | 32 | 2 |

*Weight % of the component based on the total weight of the polyol composition.
PEP 450 = PLURACOL^{R} PEP 450

### Method 9: Preparation of Polyol Composition 9

The polyol of Method 3 (200 g) containing 22-24% by weight free bisphenol A is dissolved in methylene chloride and transferred into a separatory funnel and washed 5 times with 300 mL portions of a stock solution prepared from 40 g sodium hydroxide and 2 L of water and the phases are separated. The pH of the aqueous phase is monitored after each wash to assure adequate deprotonation and extraction of the free bisphenol A. The methylene chloride phase is then washed 5 times with 1% hydrochloric acid and 5 times with water. The methylene chloride phase is then dried over sodium sulfate, filtered and the methylene chloride is removed on a rotary evaporator and then dried on a vacuum manifold to constant weight. The product polyol composition contains a statistical mixture of the unreacted monomeric polyol PEP-450 and product higher polyols containing 2-5 residues of PEP-450 linked by 1-4 carbonate linkages, all of which are present in the starting polyol composition of Method 3. The product polyol composition is essentially free of free bisphenol A, is suitable for use in foamable compositions and contains about 13.5% by weight OH groups.

### Method 10: Preparation of Polyol Composition Essentially Free of Aromatic Components (Polyol Composition 10)

PEP 450 polyol (1000 g, 2.47 mol, PEP 450), diethyl carbonate (131.12 g, 1.11 mol) and catalyst (KOH or K₂CO₃, (250 ppm)) are charged to a glass reactor equipped with stirrer, reflux condenser, and internal thermometer. The mixture is heated to a temperature in a range from about 120° C. to about 140° C. As the reaction takes place ethanol is formed and reflux ensues. The reflux condenser is subsequently replaced with a still head and ethanol is distilled from the reaction mixture. The temperature of the reaction mixture is slowly raised to 160° C. The pressure is then slowly lowered to about 10 Torr. After approximately 1 hr heating is discontinued and the product polyol composition is allowed to cool. The product polyol composition contains a statistical mixture of the unreacted monomeric polyol PEP-450 and linear product higher polyols containing 2-5 residues of PEP-450 linked by 1-4 carbonate linkages and about 12.5% by weight hydroxyl groups. The product polyol is essentially free of aromatic components and is suitable for use in the preparation of polyurethanes and foamed polyurethanes.

### Method 11 Preparation of Polyol Composition 11

To the polyol composition prepared in Method 10 (500 g) is added glycerol carbonate (125 g) and PEP 450 (100 g). The mixture is stirred warmed to produce a homogeneous polyol composition comprising glycerol carbonate, the monomeric polyol PEP-450 and the higher polyol components comprising 2-5 residues of PEP-450 linked by 1-4 carbonate linkages, which is suitable for use in the preparation of polyurethanes and foamed polyurethanes. The polyol composition contains approximately 13.4% by weight hydroxyl groups.

### Method 12 Preparation of Polyol Composition 12

To a polyol composition prepared as in Method 10 (500 g) is added glycerol carbonate (150 g) and PEP 450 (50 g). The mixture is stirred warmed to produce a homogeneous polyol composition comprising glycerol carbonate, the monomeric polyol PEP-450 and the higher polyol components comprising 2-5 residues of PEP-450 linked by 1-4 carbonate linkages and is suitable for use in the preparation of polyurethanes and foamed polyurethanes. The polyol composition contains approximately 13.2% by weight OH groups.

### Method 13: Preparation of Polyol Composition 13 Comprising Monomeric Polyol, Higher Polyol and Cyclic Carbonate Components Essentially Free of Aromatic Components (Polyol Composition 13)

Pep 450 polyol (200.00 g, 0.49 mol,) and 4,4′-[carbonylbis(oxymethylene)]bis[1,3-dioxolan-2-one] (CAS No. 412312-38-0) (62.92 g, 0.24 mol) and catalyst (KOH or K₂CO₃, (50 ppm)) are charged to a glass reactor equipped with a mechanical stirrer, nitrogen inlet and exit ports and an internal thermometer. The mixture is stirred and heated to a temperature in a range from about 100° C. to about 180° C. for 2 hr to produce a polyol composition comprising unconsumed monomeric polyol PEP 450, a suite of linear carbonate-containing dimers, trimers, tetramers and pentamers comprising from 2 to 5 residues of the polyol as a statistical mixture together with liberated glycerol carbonate. The product polyol composition contains about 12.8% by weight hydroxyl groups and 21% by weight glycerol carbonate. The product polyol is essentially free of aromatic components and is suitable for use in the preparation of polyurethanes and foamed polyurethanes.

### Method 14 Preparation of Polyol Composition 14

Following the protocol of Method 10, PEP 450 (200 g, 0.49 mol) and di-t-butyl dicarbonate (52.34 g, 0.24 mol) and a catalyst (KOH or K₂CO₃, (250 ppm)) are charged to a glass reactor equipped with stirrer, reflux condenser, and internal thermometer. The mixture is stirred and heated to a temperature in a range from about 100° C. to about 140° C. As the reaction takes place carbon-dioxide and t-butanol are formed and reflux of the t-butanol ensues. The reflux condenser is subsequently replaced with a still head and t-butanol is distilled from the reaction mixture. The temperature of the reaction mixture is slowly raised to 160° C. The pressure is then slowly lowered to about 5 Torr. Heating is then discontinued and the product polyol composition is allowed to cool. The product polyol composition contains a statistical mixture of the unconsumed monomeric polyol PEP-450 and linear product higher polyols containing 2-5 residues of PEP-450 linked by 1-4 carbonate linkages. The product polyol composition contains about 16.2% by weight hydroxyl groups, is essentially free of aromatic components and is suitable for use in the preparation of polyurethanes and foamed polyurethanes.

### Examples 13-16 Foamed Polyurethane Compositions

Following the general procedure detailed above a series of foamed polyurethane compositions are prepared in open cups. Table 16 illustrates the components of 4 foamable compositions in which the ratio of isocyanate groups to all hydroxyl groups, including any hydroxyl groups contributed by the blowing agent, is varied between 0.8 and 2.0. The polyol composition employed is that of Method 4 in this Experimental Section. The isocyanate component is Baydur 486. The Surfactant-Blowing Agent-Catalyst Combination in each case is combination “C1” (See Table 9). Each foamable composition contains approximately 820 mg of water as the blowing agent, 2 g of the poylalkylene ether-polysiloxane copolymer NIAX L-6888 and 200 mg of an amine catalyst NIAX A-99. Each of foamable compositions on standing affords a foamed polyurethane composition.

TABLE 16
Foamable Compositions of Examples 13-16

| | | Mass | Mass | Mass Surfactant- |
|---|---|---|---|---|
| | | Isocyanate | Polyol | Blowing Agent-Catalyst |
| Entry | Index | (g) | (g) | Combination (g) |
| Example | 0.8 | 120 | 96.7 | 3 |
| 13 | | | | |
| Example | 1.2 | 120 | 62.9 | 3 |
| 14 | | | | |
| Example | 1.6 | 120 | 45.9 | 3 |
| 15 | | | | |
| Example | 2.0 | 120 | 35.8 | 3 |
| 16 | | | | |

### Example 17 Foamed Polyurethane Composition

Component A, Baydur 486, is maintained at 100° F. in the A side reservoir of a Baulé omega commercial meter mixing system. Component B, a degassed polyol composition comprising a 1:1 parts by weight mixture of polyol composition 3 and polyol composition 4 containing 1.25% by weight L6888 surfactant, is maintained at 122° F. in the B side reservoir. Component C, the blowing agent (water), is maintained at ambient temperature in a first additive tank. Component D, the catalyst NIAX A-99 also at ambient temperature, is maintained in a second additive tank. Components A, B, C and D are combined in the mix head of the meter mixing system where they pass through a long dynamic mixer at 4,500 RPM at a flow rate of 2,500 g per minute to provide a foamable composition comprising 60 parts Component A, 39.7 parts Component B, 0.4 parts Component C and 0.2 parts Component D. The meter mixing system is calibrated to dispense 1 kg of the foamable composition into an open mold at ambient at ambient temperature where it foams and cures to provide a foamed polyurethane composition having acceptable properties.

### Examples 18-23: Foamed Polyurethane Compositions Based on Polyol Compositions 9-14

Following the general procedures disclosed herein, each of the polyol compositions prepared as in Methods 9-14 is combined with a blowing agent, water (1.70 g), a surfactant (NIAX L6888, 1.2 g) a catalyst (NIAX A-99, 100 mg) and a polyisocyanate functional component (Baydur 486, 120 g) to form the foamable compositions 18-23 shown in Table 17 having an isocyanate to hydroxyl group index of approximately 1:1.

TABLE 17
Foamable Compositions of Examples 18-23

| | Polyol | Mass | Mass | Mass Surfactant- |
|---|---|---|---|---|
| | Composition | Isocyanate | Polyol | Blowing Agent-Catalyst |
| Entry | of Method: | (g) | (g) | Combination (g) |
| Example | 9 | 120 | 77.96 | 3 |
| 18 | | | | |
| Example | 10 | 120 | 83.64 | 3 |
| 19 | | | | |
| Example | 11 | 120 | 78.02 | 3 |
| 20 | | | | |
| Example | 12 | 120 | 79.20 | 3 |
| 21 | | | | |
| Example | 13 | 120 | 94.30 | 3 |
| 22 | | | | |
| Example | 14 | 120 | 74.50 | 3 |
| 23 | | | | |

Following the protocols disclosed herein the foamable compositions of Examples 18-23 are converted to foamed polyurethane compositions having acceptable physical properties.

### Example 24: Carbon Nanotube-Containing Foamable Composition and Foamed Polyurethane Composition

A carbon nanotube-containing polyol composition is prepared from the polyol composition of Method 1 as follows. The polyol composition (94.325 g) is charged to a reactor equipped with a mechanical stirrer and nitrogen inlet and outlet. The polyol composition is heated to 150° F. under a nitrogen atmosphere and stirred at a peripheral speed of 10 m/s. Tuball 301 (1.925 g, OCSiAI) supplied as a 10% concentrate containing single walled carbon nanotubes (SWCNTs) dispersed in an ethoxylated alcohol having a hydroxyl number of 100 mg potassium hydroxide per g and a moisture content of less than 1%, is slowly added to the polyol composition while maintaining both stirring rate and temperature. Following the addition of the carbon nanotube concentrate stirring and heating are continued for 40 minutes. An additional portion (96.25 g) of the polyol composition of Method 1 is then added and the mixture stirred and heated at 150° F. An aliquot of the mixture is analyzed according to the ISO 1524 protocol to verify that the dispersion of the SWCNTs is substantially free of SWCNT particles larger than about 20 um. The stirrer speed is lowered to approximately 100 RPM and the dispersion is allowed to defoam for 20 minutes to afford a polyol composition as a dispersion comprising 99% by weight of the polyol composition of Method 1 and 1% by weight of the carbon nanotube-containing concentrate.

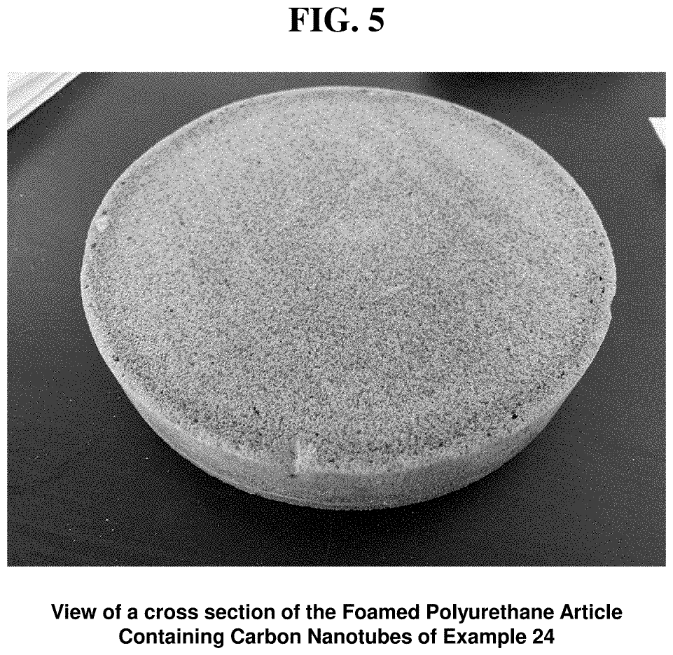

To the dispersion prepared above (192.5 g) is added 2.5 g of NIAX L-6888 surfactant, 1 g of bis(2-dimethylaminoethyl)ether catalyst and 4 g of water blowing agent. This polyol composition at 150° F. is blended for 20 seconds with Baydur-486 polyisocyanate (300 g) at 120° F. according to the general experimental protocol to afford a foamable composition which is allowed to cure and foam in a paint can under ambient conditions to provide the foamed polyurethane composition comprising carbon nanotubes shown in FIG. 5.

Foamable compositions having an isocyanate index of 1.1 comprising 60.00 g of PEP 450 (Comparative Examples 2-4) or an equivalent amount (74.12 g) of the polyol composition of Method 3 (Examples 25-30) and Baydur 486, water. L6888 surfactant and NIAX A99 catalyst in sufficient amounts to give the weight percentages indicated in Table 18 are prepared and allowed to foam in open cups as taught herein.

TABLE 18
Foamable Compositions Comprising the Polyol
Composition of Method 3 (Examples 25
30) or PEP-450 Only (Comparative Examples 2-4)

| | Mass % | Mass % | Mass % | Mass % | Mass % |
|---|---|---|---|---|---|
| Entry | Iso | Polyol | Water | Catalyst | Surfactant |
| Comparative Ex. 2 | 64.38% | 34.15% | 0.80% | 0.18% | 0.50% |
| Example 25 | 59.87% | 38.65% | 0.80% | 0.18% | 0.50% |
| Example 26 | 59.65% | 38.95% | 0.72% | 0.18% | 0.50% |
| Comparative Ex. 3 | 64.82% | 33.72% | 0.93% | 0.14% | 0.40% |
| Example 27 | 60.38% | 38.16% | 0.93% | 0.14% | 0.40% |
| Example 28 | 58.99% | 39.97% | 0.50% | 0.14% | 0.40% |
| Comparative Ex. 4 | 63.56% | 34.93% | 0.56% | 0.25% | 0.70% |
| Example 29 | 58.85% | 39.64% | 0.56% | 0.25% | 0.70% |
| Example 30 | 58.71% | 39.82% | 0.51% | 0.25% | 0.70% |

The polyurethane foams produced from each of the foamable compositions were evaluated for strength and density. Physical data are presented in Table 19.

TABLE 19
Physical Properties and Water to Catalyst Ratios

| | Mass | Mass | Water: | Foam | Compressive |
|---|---|---|---|---|---|
| | % | % | Catalyst | Density | Strength |
| Entry | Water | Catalyst | Ratio | kg/m³ | Mpa |
| Comparative Ex. 2 | 0.80% | 0.18% | 4.44 | 62 | 0.72 |
| Example 25 | 0.80% | 0.18% | 4.44 | 73 | 0.59 |
| Example 26 | 0.72% | 0.18% | 4.00 | 73 | 0.55 |
| Comparative Ex. 3 | 0.93% | 0.14% | 6.64 | 40 | 0.29 |
| Example 27 | 0.93% | 0.14% | 6.64 | 48 | 0.35 |
| Example 28 | 0.50% | 0.14% | 3.57 | 74 | 0.56 |
| Comparative Ex. 4 | 0.56% | 0.25% | 2.24 | 58 | 0.74 |
| Example 29 | 0.56% | 0.25% | 2.24 | 99 | 0.98 |
| Example 30 | 0.51% | 0.25% | 2.04 | 109 | 1.09 |

Polyurethane foams prepared using Polyol Composition of Method 3 generally outperformed the foams of the corresponding Comparative Example, with the exception of Comparative Example 2 in terms of compressive strength which unaccountably outperformed Examples 25 and 26 in this category. Examples 27, 28, 29 and 30 substantially outperformed corresponding Comparative Examples 3 and 4 in terms of compressive strength. It is noteworthy that the foamed polyurethanes of Examples outperform any of Comparative Examples 2-4 in this category.

### Numbered Embodiments

1. A foamable composition comprising:

(a) a polyol composition comprising:
(i) at least one monomeric polyol comprising 3 or more hydroxyl groups;
(ii) at least one higher polyol comprising 3 or more hydroxyl groups; and optionally
(iii) at least one polyhydroxylated aromatic compound;

(b) at least one polyisocyanate, latent polyisocyanate or mixture thereof; and

(c) at least one blowing agent;

wherein the at least one higher polyol comprises residues of either the at least one monomeric polyol or both of the at least one monomeric polyol and the polyhydroxylated aromatic compound, wherein the residues are linked by 1 or more carbonate groups, oxygen ether groups, or a combination thereof.
2. The foamable composition of Embodiment 1, wherein the polyol composition has a viscosity of less than 5000 cps at 150° F., wherein the viscosity is determined on a rheometer as disclosed herein operated at steady state shear and variable temperature sweep according to standard instrument operating protocols furnished by the manufacturer.
3. The foamable composition of any of Embodiments 1-2, wherein the at least one polyol composition (a) is present in an amount from about 10 to about 70% by weight; the at least one polyisocyanate, latent polyisocyanate or mixture thereof (b) is present in an amount from about 90 to about 30% by weight; and the at least one blowing agent (c) is present in an amount of from about 0.1% by weight to about 15% by weight; based on the total weight of the foamable composition.
4. The foamable composition of any of Embodiments 1-3, wherein the at least one monomeric polyol comprises 3 or more secondary hydroxyl groups.
5. The foamable composition of any of Embodiments 1-4, wherein the at least one monomeric polyol comprises 1 or more oxygen ether groups.
6. The foamable composition of any of Embodiments 1-5, wherein the at least one monomeric polyol is tetrafunctional comprising 4 or more hydroxyl groups.
7. The foamable composition of any of Embodiments 1-6, wherein the at least one monomeric polyol comprises 4 or more secondary hydroxyl groups.
8. The foamable composition of any of Embodiments 1-7, wherein the at least one monomeric polyol comprises a mixture of polyols having an average molecular weight of less than 500 g/mol as determined from its hydroxyl number obtained using ASTM E222.
9. The foamable composition of any of Embodiments 1-8, wherein the at least one monomeric polyol comprises an alkoxylated polyether polyol.
10. The foamable composition of any of Embodiments 1-9, wherein the at least one monomeric polyol comprises a C₂ to C₄ alkoxylated polyether polyol.
11. The foamable composition of any of Embodiments 1-10, wherein the at least one higher polyol comprises 2 or more residues of the at least one monomeric polyol.
12. The foamable composition of any of Embodiments 1-11, wherein the at least one higher polyol comprises 3 or more residues of the at least one monomeric polyol.
13. The foamable composition of any of Embodiments 1-12, wherein the at least one higher polyol comprises 4 or more residues of the at least one monomeric polyol.
14. The foamable composition of any of Embodiments 1-13, wherein at least a portion of the residues of the at least one higher polyol are linked by carbonate groups.
15. The foamable composition of any of Embodiments 1-14, wherein at least a portion of the residues of the at least one higher polyol are linked by oxygen ether groups.
16. The foamable composition of any of Embodiments 1-15, wherein the at least one higher polyol comprises 4 or more secondary hydroxyl groups.
17. The foamable composition of any of Embodiments 1-16, wherein the at least one higher polyol comprises 6 or more secondary hydroxyl groups.
18. The foamable composition of any of Embodiments 1-17, wherein the at least one monomeric polyol is present in an amount greater than 10% and less than 90% by weight based on the total weight of the polyol composition; and the at least one higher polyol is present in an amount greater than 5% by weight and less than 70% based on the total weight of the polyol composition.
19. The foamable composition of any of Embodiments 1-18, wherein the at least one polyisocyanate, latent polyisocyanate or mixture thereof comprises at least one polyisocyanate prepolymer, at least one blocked polyisocyanate, at least one monomeric polyisocyanate, at least one oligomeric polyisocyanate, at least one polymeric polyisocyanate, or a mixture thereof.
20. The foamable composition of any of Embodiments 1-19, comprising at least one polyisocyanate prepolymer.
21. The foamable composition of any of Embodiments 1-20, comprising at least one monomeric polyisocyanate.
22. The foamable composition of any of Embodiments 1-25, comprising at least one oligomeric polyisocyanate.
23. The foamable composition of any of Embodiments 1-22, comprising at least one blocked polyisocyanate.
24. The foamable composition of any of Embodiments 1-23, comprising at least one polymeric polyisocyanate.
25. The foamable composition of any of Embodiments 1-24, wherein the at least one polyisocyanate, latent polyisocyanate or mixture thereof comprises residues of 4,4′-diphenylmethane diisocyanate, free diphenylmethane diisocyanate, or a mixture thereof.
26. The foamable composition of any of Embodiments 1-25, wherein the at least one polyisocyanate, latent polyisocyanates, or a mixture thereof comprises residues of toluene diisocyanate (TDI), free toluene diisocyanate, or a mixture thereof.
27. The foamable composition of any of Embodiments 1-26, wherein the at least one polyisocyanate, latent polyisocyanates, or a mixture thereof comprises 1 or more polyisocyanurates comprising residues of bis(isocyanatophenyl)methane (MDI).
28. The foamable composition of any of Embodiments 1-27, wherein the at least one higher polyol comprises 1 or more residues of both the at least one monomeric polyol and the polyhydroxylated aromatic compound.
29. The foamable composition of any of Embodiments 1-28, wherein the at least one higher polyol comprises a first higher polyol comprising 2 or more residues of the monomeric polyol linked by 1 or more carbonate groups, and a second higher polyol comprising 1 or more residues of both the at least one monomeric polyol and the polyhydroxylated aromatic compound.
30. The foamable composition of any of Embodiments 1-29, wherein the polyol composition comprises at least one polyhydroxylated aromatic compound.
31. The foamable composition of Embodiment 30 wherein at least a portion of the polyhydroxylated aromatic compound comprises at least one bisphenol.
32. The foamable composition of any of Embodiments 30-31, wherein at least a portion of the at least one polyhydroxylated aromatic compound comprises bisphenol A.
33. The foamable composition of any of Embodiments 30-32, wherein the at least one polyhydroxylated aromatic compound is present in an amount greater than 16% by weight and less than 30% by weight based on the total weight of the polyol composition.
34. The foamable composition of any of Embodiments 1-29, wherein the polyol composition is essentially free of polyhydroxylated aromatic compound.
35. The foamable composition of any of Embodiments 1-24 and 28-34 wherein the at least one polyisocyanate, latent polyisocyanate or mixture thereof is essentially free of aromatic components.
36. The foamable composition of any of Embodiments 1-24 and 34-35 which is essentially free of aromatic components.
37. The foamable composition of any of Embodiments 1-36, wherein the polyol composition further comprises at least one cyclic carbonate comprising 1 or more hydroxyl groups.
38. The foamable composition of any of Embodiments 1-37, wherein the polyol composition has a viscosity of less than 1000 cps at 150° F., wherein the viscosity is determined on a rheometer as disclosed herein operated at steady state shear and variable temperature sweep according to standard instrument operating protocols furnished by the manufacturer.
39. A foamable composition comprising:

(a) a polyol composition comprising:
(i) at least one polyol comprising 3 or more hydroxyl groups; and
(ii) at least one cyclic carbonate comprising 1 or more hydroxyl groups;

and optionally
(iii) at least 1 polyhydroxylated aromatic compound;

(b) at least one isocyanate functional component comprising isocyanate groups, latent isocyanate groups, or a mixture thereof; and

(c) at least one blowing agent;

wherein the composition when subjected to conditions sufficient to cause the polyol composition and the isocyanate functional component to react, the composition cures by reaction of at least a portion of the hydroxyl groups of the at least one polyol and at least a portion of the hydroxyl groups of the at least one cyclic carbonate with the isocyanate groups, latent isocyanate groups, or a mixture thereof of the isocyanate functional component to form urethane linkages of a foamed polyurethane composition.
40. The foamable composition of Embodiment 39, wherein the polyol composition has a viscosity of less than 1000 cps at 150° F., wherein the viscosity is determined on a rheometer as disclosed herein operated at steady state shear and variable temperature sweep according to standard instrument operating protocols furnished by the manufacturer.
41. The foamable composition of any of Embodiments 39-40, wherein the at least one polyol composition (a) is present in an amount from about 10 to about 70% by weight; the at least one isocyanate functional component (b) is present in an amount from about 90 to about 30% by weight; and the at least one blowing agent (c) is present in an amount of from about 0.1% by weight to about 15% by weight; based on the total weight of the foamable composition.
42. The foamable composition of any of Embodiments 1-41, further comprising at least one nucleating agent.
43. The foamable composition of any of Embodiments 1-42, further comprising at least one surfactant.
44. The foamable composition of any of Embodiments 1-43, further comprising at least one flame retardant.
45. The foamable composition of any of Embodiments 1-44, further comprising at least one cell opener.
46. The foamable composition of any of Embodiments 1-45, further comprising at least one thermal stabilizer.
47. The foamable composition of any of Embodiments 1-46, further comprising at least one ultraviolet light stabilizer.
48. The foamable composition of any of Embodiments 1-47, further comprising at least one colorant.
49. The foamable composition of any of Embodiments 42-48, wherein, when present, the at least one nucleating agent, the at least one surfactant, the at least one flame retardant, the at least one cell opener, the at least one thermal stabilizer, the at least one ultraviolet light stabilizer, and the at least one colorant is individually present in an amount from about 0.01% by weight to about 15% by weight based on the total weight of the foamable composition.
50. The foamable composition of any of Embodiments 1-49, further comprising at least one filler.
51. The foamable composition of Embodiment 50 wherein the at least one filler is present in an amount from greater than 0.1 to less than 60% by weight based on the total weight of the foamable composition.
52. The foamable composition of any of Embodiments 50-51, wherein the filler comprises 1 or more clay fillers, glass flake fillers, glass fiber fillers, carbon black fillers, carbon fiber fillers, basalt fiber fillers, or a mixture thereof.
53. The foamable composition of any of Embodiments 50-52, wherein the filler comprises 1 or more of a glass or carbon continuous filament mat (CFM), a chopped strand mat (CSM), and engineered stitched mat.
54. The foamable composition of any of Embodiments 50-53, wherein the filler comprises 1 or more sizing agents.
55. The foamable composition of any of Embodiments 50-53, wherein the filler is essentially free of sizing agent.
56. The foamable composition of any of Embodiments 39-55, wherein the isocyanate functional component comprises a polyisocyanate, a latent polyisocyanate, or a mixture thereof.
57. The foamable composition of any of Embodiments 37-56, wherein the cyclic carbonate is present in an amount from about 5% to about 40% by weight based on the total weight of the polyol composition.
58. The foamable composition of any of Embodiments 37-57, wherein the at least one cyclic carbonate is present in an amount from about 10% to about 30% by weight based on the total weight of the polyol composition.
59. The foamable composition of any of Embodiments 39-58 wherein the at least one polyol comprises 3 or more secondary hydroxyl groups.
60. The foamable composition of any of Embodiments 39-59, wherein the at least one polyol comprises 1 or more ether groups.
61. The foamable composition of any of Embodiments 39-60, wherein the at least one polyol is tetrafunctional comprising 4 or more hydroxyl groups.
62. The foamable composition of any of Embodiments 39-61, wherein the at least one polyol comprises 4 or more secondary hydroxyl groups.
63. The foamable composition of any of Embodiments 39-62, wherein the at least one polyol comprises a mixture of polyols having an average molecular weight of less than 500 g/mol as determined from its hydroxyl number obtained using ASTM E222.
64. The foamable composition of any of Embodiments 39-63, wherein the at least one polyol comprises an alkoxylated polyether polyol.
65. The foamable composition of any of Embodiments 39-64, wherein the at least one polyol comprises a C₂ to C₄ alkoxylated polyether polyol.
66. The foamable composition of any of Embodiments 39-65, wherein the at least one polyol comprises 3 or more vicinal hydroxyl groups.
67. The foamable composition of any of Embodiments 39-66, wherein the at least one polyol comprises glycerol.
68. The foamable composition of any of Embodiments 39-67, wherein the at least one polyol comprises both a monomeric polyol and a higher polyol, wherein the higher polyol comprises 1 or more carbonate groups and 2 or more residues of the monomeric polyol.
69. The foamable composition of any of Embodiments 39-68, wherein the at least one polyol comprises both a monomeric polyol and a higher polyol, wherein the higher polyol comprises 1 or more carbonate groups, 1 or more ether groups and 2 or more resides of the monomeric polyol.
70. The foamable composition of any of Embodiments 39-69, wherein the at least one polyol comprises 6 or more secondary hydroxyl groups.
71. The foamable composition of any of Embodiments 37-70, wherein the at least one cyclic carbonate comprises at least one hydroxyl group on a ring position of a cyclic carbonate ring.
72. The foamable composition of any of Embodiments 37-71, wherein the at least one cyclic carbonate comprises at least one hydroxyl group not on a ring position of a cyclic carbonate ring.
73. The foamable composition of any of Embodiments 37-72, wherein the at least one cyclic carbonate comprises 1 or more cycloaliphatic carbonate groups.
74. The foamable composition of any of Embodiments 37-73, wherein the at least one cyclic carbonate comprises 1 or more aromatic carbonate groups.
75. The foamable composition of any of Embodiments 37-74, wherein the at least one cyclic carbonate comprises 1 or more aliphatic radicals comprising 1 or more hydroxyl groups.
76. The foamable composition of any of Embodiments 37-75, wherein the at least one cyclic carbonate comprises 1 or more hydroxylated alkyl groups.
77. The foamable composition of any of Embodiments 37-76, wherein the at least one cyclic carbonate comprises 1 or more hydroxymethyl groups.
78. The foamable composition of any of Embodiments 37-77, wherein the at least one cyclic carbonate comprises a single cyclic carbonate group.
79. The foamable composition of any of Embodiments 37-78, wherein the at least one cyclic carbonate comprises more than one cyclic carbonate groups.
80. The foamable composition of any of Embodiments 37-79, wherein the at least one cyclic carbonate comprises 1 or more 5 membered ring cyclic carbonate groups.
81. The foamable composition of any of Embodiments 37-80, wherein the at least one cyclic carbonate comprises 1 or more 6 membered ring cyclic carbonate groups.
82. The foamable composition of any of Embodiments 37-81, wherein the at least one cyclic carbonate comprises 1 or more 7 membered ring cyclic carbonate groups.
83. The foamable composition of any of Embodiments 37-82, wherein the at least one cyclic carbonate comprises glycerol carbonate.
84. The foamable composition of any of Embodiments 37-83, wherein the at least one cyclic carbonate comprises trimethylolpropane carbonate.
85. The foamable composition of any of Embodiments 39-84, wherein the at least one isocyanate functional component is present in an amount such that a ratio of isocyanate groups, latent isocyanate groups, or a mixture thereof to hydroxyl groups of the polyol composition is 0.8 or greater.
86. The foamable composition of any of Embodiments 39-85, wherein the at least one isocyanate functional component is present in an amount such that a ratio of isocyanate groups, latent isocyanate groups, or a mixture thereof to hydroxyl groups polyol composition is 1.2 or less.
87. The foamable composition of any of Embodiments 39-86, wherein the at least one isocyanate functional component comprises at least one polyisocyanate prepolymer, at least one blocked polyisocyanate, at least one monomeric polyisocyanate, at least one oligomeric polyisocyanate, at least one polymeric polyisocyanate, or a mixture thereof.
88. The foamable composition of any of Embodiments 39-87, wherein the at least one isocyanate functional component comprises at least one polyisocyanate prepolymer.
89. The foamable composition of any of Embodiments 39-88, wherein the at least one isocyanate functional component comprises at least one monomeric polyisocyanate.
90. The foamable composition of any of Embodiments 39-89, wherein the at least one isocyanate functional component comprises at least one oligomeric polyisocyanate.
91. The foamable composition of any of Embodiments 39-90, wherein the at least one isocyanate functional component comprises at least one blocked polyisocyanate.
92. The foamable composition of any of Embodiments 39-91, wherein the at least one isocyanate functional component comprises at least one polymeric polyisocyanate.
93. The foamable composition of any of Embodiments 39-92, wherein the at least one isocyanate functional component comprises at least one aliphatic polyisocyanate, latent aliphatic polyisocyanate, cycloaliphatic polyisocyanate, latent cycloaliphatic polyisocyanate, or a mixture thereof.
94. The foamable composition of any of Embodiments 39-93, wherein the at least one isocyanate functional component comprises hexamethylene diisocyanate, or residues of hexamethylene diisocyanate.
95. The foamable composition of any of Embodiments 39-94, wherein the at least one isocyanate functional component comprises residues of 4,4′-diphenylmethane diisocyanate, free 4,4′-diphenylmethane diisocyanate, or a mixture thereof.
96. The foamable composition of any of Embodiments 39-95, wherein the at least one isocyanate functional component comprises residues of toluene diisocyanate, free toluene diisocyanate (TDI), or a mixture thereof.
97. The foamable composition of any of Embodiments 39-96, wherein the at least one isocyanate functional component comprises 1 or more polyisocyanates comprising residues of bis(isocyanatophenyl)methane (MDI), free MDI, or a mixture thereof.
98. The foamable composition of any of Embodiments 39-97, wherein an initial ratio of isocyanate groups, latent isocyanate groups, or a mixture thereof to hydroxyl groups of the polyol composition is in a range from about 1.2 to about 0.8.
99. The foamable composition of any of Embodiments 1-85 and 87-97, wherein an initial ratio of isocyanate groups, latent isocyanate groups, or a combination thereof to hydroxyl groups is in a range from about 1 to about 8.
100. The foamable composition of any of Embodiments 1-99, wherein the at least one blowing agent comprises 1 or more of a physical blowing agent, a chemical blowing agent, or a combination thereof.
101. The foamable composition of any of Embodiments 1-100, wherein the at least one blowing agent comprises water.
102. The foamable composition of any of Embodiments 1-101, further comprising at least one catalyst.
103. The foamable composition of Embodiment 102, wherein the catalyst comprises a latent catalyst.
104. The foamable composition of any of Embodiments 102, wherein the catalyst is an organometallic catalyst.
105. The foamable composition of any of Embodiments 102-104, wherein the at least one catalyst comprises at least one amine, an amine salt, or a combination thereof.
106. The foamable composition of any of Embodiments 102-105, wherein the at least one catalyst comprises bis(dimethylaminoethyl) ether, a salt thereof, or a combination thereof.
107. The foamable composition of any of Embodiments 1-106, wherein the polyol composition comprises at least one polyhydroxylated aromatic compound.
108. The foamable composition of Embodiment 107, wherein the at least one polyhydroxylated aromatic compound comprises 1 or more bisphenols.
109. The foamable composition of any of Embodiments 107-108, wherein at least a portion of the at least one polyhydroxylated aromatic compound comprises bisphenol A.
110. The foamable composition of any of Embodiments 39-94 and 98-109 wherein the at least one isocyanate functional component is essentially free of aromatic polyisocyanates, aromatic latent polyisocyanates, residues of aromatic polyisocyanates, residues of aromatic latent polyisocyanates, or mixtures thereof.
111. The foamable composition of any of Embodiments 39-73 and 75-94, 98-106 and 110, which is essentially free of aromatic components.
112. A foamed article prepared from the foamable composition of any of Embodiments 1-111, the foamed article comprising voids within a polyurethane matrix comprising residues of the polyol composition and residues of the at least one polyisocyanate, latent polyisocyanate or mixture thereof, or residues of the at least one isocyanate functional component.
113. The foamed article of Embodiment 112, wherein at least a portion of the voids define closed cells, open cells, or a combination thereof.
114. The foamed article of any of Embodiments 112-113, wherein at least a portion of the voids define open cells.
115. The foamed article of any of Embodiments 112-114, wherein at least a portion of the voids define closed cells.
116. The foamed article of any of Embodiments 112-115, having a compressive strength of 0.3 MPa or greater.
117. The foamed article of any of Embodiments 112-116, having a compressive modulus of 10 MPa or greater.
118. The foamed article of any of Embodiments 112-117, having a density of 220 kg/m³ or less.
119. The foamed article of any of Embodiments 112-118, which is a molded article.
120. The foamed article of any of Embodiments 112-118, which is an extruded foamed sheet.
121. The foamed article of any of Embodiments 112-120, which is a component of a vehicle, a structural component of a building, or a packaging system.
122. The foamed article of any of Embodiments 112-121, wherein at least a portion of the residues of the at least one polyisocyanate, latent polyisocyanate or mixture thereof, or the residues of the isocyanate functional component are linked by urea linkages within the polyurethane matrix comprising voids.
123. A method of making a foamed polyurethane composition comprising: contacting 1 or more of the foamable compositions of Embodiments 1-38 under conditions sufficient to cause at least a portion of the hydroxyl groups of the at least one monomeric polyol, at least a portion of the hydroxyl groups of the at least one higher polyol, and when present, at least a portion of the hydroxyl groups of the at least one polyhydroxylated aromatic compound to react with isocyanate groups or latent isocyanate groups of the at least one polyisocyanate, latent polyisocyanate or mixture thereof to form urethane linkages in the presence of the at least one blowing agent to form the foamed product polyurethane composition.
124. A method of making a foamed polyurethane composition comprising: contacting 1 or more of the foamable compositions of Embodiments 39-111 under conditions sufficient to cause at least a portion of the hydroxyl groups of the at least one polyol, at least a portion of the hydroxyl groups of the at least one cyclic carbonate and, when present, at least a portion of the hydroxyl groups of the at least one polyhydroxylated aromatic compound to react with isocyanate groups, latent isocyanate groups or a mixture thereof of the at least one isocyanate functional component to form urethane linkages in the presence of the at least one blowing agent to form the foamed product polyurethane composition.
125. The method of any of Embodiments 123-124, wherein the conditions sufficient comprise heating the foamable composition at a first pressure and thereafter reducing the pressure to allow the at least one blowing agent to form voids within a polyurethane matrix.
126. The method of any of Embodiments 123-125, wherein the foamable composition is extruded from a first higher pressure zone within an extruder to a second lower pressure zone to form the foamed product polyurethane composition as an extruded foam sheet.
127. The method of any of Embodiments 123-126, wherein the conditions sufficient comprise heating the foamable composition at a temperature of about 80° F. to about 120° F. for a time period of about 1 to about 20 minutes.
128. The method of any of Embodiments 123-127, wherein the at least one blowing agent comprises 1 or more physical blowing agents.
129. The method of any of Embodiments 123-128, wherein the at least one blowing agent comprises 1 or more chemical blowing agents.
130. The method of any of Embodiments 123-129, wherein the blowing agent comprises 1 or more of fluorochlorocarbons, fluorocarbons, hydrocarbons, alcohols, ketones, esters, ethers, water, carbon dioxide, nitrogen, argon, or ammonia.
131. The method of any of Embodiments 123-130, wherein the blowing agent is present in an amount of about 0.1 to about 15% by weight based on the total weight of the foamable composition.
132. A foamed polyurethane composition prepared from 1 or more of the foamable compositions of any of Embodiments 1-38, comprising:

(a) residues of the at least one polyol composition;

(b) residues of the at least one polyisocyanate, latent polyisocyanate or mixture thereof; and optionally

(c) residues of the at least one blowing agent;

wherein at least a portion of the residues of the polyol composition and the residues of the at least one polyisocyanate, latent polyisocyanate or mixture thereof are linked by urethane linkages within a polyurethane matrix comprising voids.
133. A foamed polyurethane composition comprising:

(a) residues of at least one polyol composition comprising;
(i) residues of at least one monomeric polyol having 3 or more hydroxyl groups;
(ii) residues of at least one higher polyol; and optionally
(iii) residues of at least 1 polyhydroxylated aromatic compound;

(b) residues of at least one polyisocyanate, latent polyisocyanate or mixture thereof; and optionally

(c) residues of at least one blowing agent;

wherein the polyol composition comprises (i) at least one monomeric polyol comprising 3 or more hydroxyl groups; (ii) at least one higher polyol comprising 3 or more hydroxyl groups; and optionally (iii) at least one polyhydroxylated aromatic compound comprising 2 or more hydroxyl groups; and
wherein the at least one higher polyol comprises residues of either the at least one monomeric polyol or both of the at least one monomeric polyol and the polyhydroxylated aromatic compound linked by 1 or more carbonate groups, oxygen ether groups, or a combination thereof; and
wherein at least a portion of the residues of the polyol composition and the residues of the at least one polyisocyanate, latent polyisocyanate or mixture thereof are linked by urethane linkages within a polyurethane matrix comprising voids.
134. The foamed polyurethane composition of any of Embodiments 132-133, wherein the residues of the at least one polyol composition (a) are present in an amount from about 10 to about 70% by weight; and the residues of the at least one polyisocyanate, latent polyisocyanate or mixture thereof (b) are present in an amount from about 90 to about 30% by weight based on the total weight of the foamed polyurethane composition.
135. The foamed polyurethane composition of any of Embodiments 132-134, wherein the residues of the at least one monomeric polyol are present in an amount greater than 10% and less than 90% by weight and the residues of the at least one higher polyol are present in an amount greater than 5% by weight and less than 70% by weight based on the total weight of the residues of at least one polyol composition.
136. The foamed polyurethane composition of any of Embodiments 132-135, wherein the at least one monomeric polyol comprises 3 or more secondary hydroxyl groups.
137. The foamed polyurethane composition of any of Embodiments 132-136, wherein the at least one monomeric polyol comprises 1 or more oxygen ether groups.
138. The foamed polyurethane composition of any of Embodiments 132-137, wherein the at least one monomeric polyol comprises 4 or more hydroxyl groups.
139. The foamed polyurethane composition of any of Embodiments 132-138, wherein the at least one monomeric polyol comprises 4 or more secondary hydroxyl groups.
140. The foamed polyurethane composition of any of Embodiments 132-139, wherein the at least one monomeric polyol has an average molecular weight of less than 500 g/mol as determined from its hydroxyl number obtained using ASTM E222.
141. The foamed polyurethane composition of any of Embodiments 132-140, wherein the at least one monomeric polyol comprises at least one C₂ to C₄ alkoxylated polyether polyol.
142. The foamed polyurethane composition of any of Embodiments 132-141, wherein the at least one higher polyol comprises 2 or more residues of at least one monomeric polyol linked by 1 or more carbonate groups.
143. The foamed polyurethane composition of any of Embodiments 132-142, wherein the at least one higher polyol comprises a first higher polyol comprising 2 residues of the at least one monomeric polyol linked by a carbonate group, a second higher polyol comprising 3 residues of the at least one monomeric polyol linked by 2 carbonate groups and a third higher polyol comprising 4 residues of the at least one monomeric polyol linked by 3 carbonate groups.
144. The foamed polyurethane composition of any of Embodiments 132-143, wherein the at least one higher polyol comprises 2 or more residues of the at least one monomeric polyol linked by 1 or more oxygen ether groups.
145. The foamed polyurethane composition of any of Embodiments 132-144, wherein the at least one higher polyol comprises 4 or more secondary hydroxyl groups.
146. The foamed polyurethane composition of any of Embodiments 132-145, wherein the at least one higher polyol comprises 6 or more secondary hydroxyl groups.
147. The foamed polyurethane composition of any of Embodiments 132-146, wherein the at least one higher polyol comprises 1 or more residues of the at least one monomeric polyol and residues of the at least 1 polyhydroxylated aromatic compound.
148. The foamed polyurethane composition of any of Embodiments 132-147, wherein the residues of the at least one polyol composition comprise residues of a first higher polyol comprising 2 or more residues of a monomeric polyol linked by 1 or more carbonate groups, and residues of a second higher polyol comprising 1 or more residues of the monomeric polyol and 1 or more residues of a polyhydroxylated aromatic compound linked by 1 or more carbonate groups, 1 or more oxygen ether groups or a combination thereof.
149. The foamed polyurethane composition of any of Embodiments 132-148, wherein the polyol composition further comprises at least one cyclic carbonate comprising 1 or more hydroxyl groups.
150. A foamed polyurethane composition comprising residues of 1 or more of the foamable compositions of any of Embodiments 39-111, the residues of the foamable composition comprising:

(a) residues of the at least one polyol composition comprising:
(i) residues of the at least one polyol comprising 3 or more hydroxyl groups;
(ii) residues of the at least one cyclic carbonate comprising 1 or more hydroxyl groups; and optionally
(iii) residues of the polyhydroxylated aromatic compound;

(b) residues of the at least one isocyanate functional component; and optionally

(c) residues of the at least one blowing agent;

wherein at least a portion of the residues of the at least one polyol, at least a portion of the residues of the at least one cyclic carbonate and, when present, at least a portion of residues of the polyhydroxylated aromatic compound are bound by 1 or more urethane linkages to the residues of the at least one isocyanate functional component within a polyurethane matrix comprising voids.
151. A foamed polyurethane composition comprising:

(a) residues of at least one polyol composition comprising:
(i) residues of at least one polyol comprising 3 or more hydroxyl groups;
(ii) residues of at least one cyclic carbonate comprising 1 or more hydroxyl groups; and optionally
(iii) residues of at least one polyhydroxylated aromatic compound;

(b) residues of at least one isocyanate functional component; and optionally

(c) residues of at least one blowing agent;

wherein at least a portion of the residues of the at least one polyol, at least a portion of the residues of the at least one cyclic carbonate and, when present, at least a portion of residues of the polyhydroxylated aromatic compound are bound by 1 or more urethane linkages to the residues of the at least one isocyanate functional component within a polyurethane matrix comprising voids.
152. The foamed polyurethane composition of any of Embodiments 132-151, wherein the residues of the at least one polyol composition (a) are present in an amount from about 10 to about 70% by weight, and the residues of the polyisocyanate functional component or the at least one polyisocyanate, latent polyisocyanate or mixture thereof (b) are present in an amount from about 90 to about 30% by weight based on the total weight of the foamed polyurethane composition.
153. The foamed polyurethane composition of any of Embodiments 149-152, residues of the at least one cyclic carbonate are present in an amount from about 5% to about 40% by weight based on the total weight of the residues of the polyol composition.
154. The foamed polyurethane composition of any of Embodiments 149-153, wherein residues of the at least one cyclic carbonate are present in an amount from about 10% to about 30% by weight based on the total weight of the residues of the polyol composition.
155. The foamed polyurethane composition of any of Embodiments 132-154, wherein at least a portion of the residues of the at least one the isocyanate functional component or the residues of the at least one polyisocyanate, latent polyisocyanate or mixture thereof are linked by urea linkages within the polyurethane matrix comprising voids.
156. The foamed polyurethane composition of any of Embodiments 132-155, wherein the polyol composition has a viscosity of less than 5000 cps at 150° F., wherein the viscosity is determined on a rheometer as disclosed herein operated at steady state shear and variable temperature sweep according to standard instrument operating protocols furnished by the manufacturer.
157. The foamed polyurethane composition of any of Embodiments 132-156, wherein the polyol composition has a viscosity of less than 1000 cps at 150° F., wherein the viscosity is determined on a rheometer as disclosed herein operated at steady state shear and variable temperature sweep according to standard instrument operating protocols furnished by the manufacturer.
158. The foamed polyurethane composition of any of Embodiments 132-157, wherein at least a portion of the voids define closed cells, open cells, or a combination thereof.
159. The foamed polyurethane composition of any of Embodiments 132-158, having a density of 220 kg/m³ or less.
160. The foamed polyurethane composition of any of Embodiments 132-159, wherein at least a portion of the voids within the polyurethane matrix contain at least a portion of the 1 or more blowing agents.
161. The foamed polyurethane composition of any of Embodiments 132-160, wherein the at least one blowing agent comprises 1 or more of a physical blowing agent, a chemical blowing agent, or a combination thereof.
162. The foamed polyurethane composition of any of Embodiments 132-161, wherein the at least one blowing agent comprises water.
163. The foamed polyurethane composition of any of Embodiments 132-162, further comprising at least one nucleating agent, surfactant, flame retardant, cell opener, thermal stabilizer, ultraviolet light stabilizer, colorant, or combination thereof.
164. The foamed polyurethane composition of Embodiment 163, wherein, when present, the at least one nucleating agent, the at least one surfactant, the at least one flame retardant, the at least one cell opener, the at least one thermal stabilizer, the at least one ultraviolet light stabilizer, and the at least one colorant is individually present in an amount from about 0.01% by weight to about 15% by weight based on the total weight of the foamed polyurethane composition.
165. The foamed polyurethane composition of any of Embodiments 132-164, further comprising at least one filler.
166. The foamed polyurethane composition of Embodiment 165, wherein the at least one filler comprises an electrically conductive material.
167. The foamed polyurethane composition of Embodiment 166, wherein the electrically conductive material comprises carbon nanotubes.
168. The foamed polyurethane composition of any of Embodiments 150-167, wherein the at least one polyol comprises at least one monomeric polyol and at least one higher polyol.
169. The foamed polyurethane composition of Embodiment 168, wherein the at least one monomeric polyol comprises 3 or more secondary hydroxyl groups.
170. The foamed polyurethane composition of any of Embodiments 168-169, wherein the at least one monomeric polyol is tetrafunctional comprising 4 or more hydroxyl groups.
171. The foamed polyurethane composition of any of Embodiments 168-170, wherein the at least one monomeric polyol comprises 4 or more secondary hydroxyl groups.
172. The foamed polyurethane composition of any of Embodiments 168-171, wherein the at least one monomeric polyol comprises a mixture of polyols having an average molecular weight of less than 500 g/mol as determined from its hydroxyl number obtained using ASTM E222.
173. The foamed polyurethane composition of any of Embodiments 168-172, wherein the at least one monomeric polyol comprises an alkoxylated polyether polyol.
174. The foamed polyurethane composition of any of Embodiments 168-172, wherein the at least one monomeric polyol comprises a C₂ to C₄ alkoxylated polyether polyol.
175. The foamed polyurethane composition of any of Embodiments 168-174, wherein the at least one higher polyol comprises 1 or more carbonate groups and 2 or more residues of the at least one monomeric polyol.
176. The foamed polyurethane composition of any of Embodiments 168-175, wherein the at least one higher polyol comprises 4 or more secondary hydroxyl groups.
177. The foamed polyurethane composition of any of Embodiments 168-176, wherein the at least one higher polyol comprises 6 or more secondary hydroxyl groups.
178. The foamed polyurethane composition of any of Embodiments 168-177, wherein the at least one monomeric polyol is present the polyol composition in an amount greater than 10% and less than 90% by weight based on the total weight of the polyol composition; and the at least one higher polyol is present the polyol composition in an amount greater than 5% and less than 70% by weight based on the total weight of the polyol composition.
179. The foamed polyurethane composition of any of Embodiments 132-178, wherein the at least one isocyanate functional component, polyisocyanate, latent polyisocyanate or mixture thereof comprises at least one polyisocyanate prepolymer, at least one blocked polyisocyanate, at least one monomeric polyisocyanate, at least one oligomeric polyisocyanate, at least one polymeric polyisocyanate, or a mixture thereof.
180. The foamed polyurethane composition of any of Embodiments 132-179, wherein at least one isocyanate functional component, polyisocyanate, latent polyisocyanate or mixture thereof comprises at least one polyisocyanate prepolymer.
181. The foamed polyurethane composition of any of Embodiments 132-180, wherein at least one isocyanate functional component, polyisocyanate, latent polyisocyanate or mixture thereof comprises at least one monomeric polyisocyanate.
182. The foamed polyurethane composition of any of Embodiments 132-181, wherein at least one isocyanate functional component, polyisocyanate, latent polyisocyanate or mixture thereof comprises at least one oligomeric polyisocyanate.
183. The foamed polyurethane composition of any of Embodiments 132-182, wherein the at least one isocyanate functional component, polyisocyanate, latent polyisocyanate, or a mixture thereof comprises 1 or more polyisocyanurates comprising residues of bis(isocyanatophenyl)methane (MDI).
184. The foamed polyurethane composition of any of Embodiments 132-183, wherein a ratio of residues of isocyanate groups, latent isocyanate groups, or a combination thereof to residues hydroxyl groups is in a range from about 1 to about 8.
185. The foamed polyurethane composition of any of Embodiments 132-184, wherein the polyol composition comprises at least one polyhydroxylated aromatic compound.
186. The foamed polyurethane of Embodiment 185, wherein at least a portion of the of the polyhydroxylated aromatic compound present in the polyol composition comprises at least one bisphenol.
187. The foamed polyurethane composition of any of Embodiments 185-186, wherein the at least one polyhydroxylated aromatic compound is present in the polyol composition in an amount greater than 16% by weight and less than 30% by weight based on the total weight of the polyol composition.
188. The foamed polyurethane composition of any of Embodiments 149-187, wherein the at least one cyclic carbonate comprises at least one hydroxyl group on a ring position of a cyclic carbonate ring.
189. The foamed polyurethane composition of any of Embodiments 149-188, wherein the at least one cyclic carbonate comprises at least one hydroxyl group not on a ring position of a cyclic carbonate ring.
190. The foamed polyurethane composition of any of Embodiments 149-189, wherein the at least one cyclic carbonate comprises 1 or more cycloaliphatic carbonate groups.
191. The foamed polyurethane composition of any of Embodiments 149-190, wherein the at least one cyclic carbonate comprises 1 or more aromatic carbonate groups.
192. The foamed polyurethane composition of any of Embodiments 149-191, wherein the at least one cyclic carbonate comprises 1 or more aliphatic radicals comprising 1 or more hydroxyl groups.
193. The foamed polyurethane composition of any of Embodiments 149-192, wherein the at least one cyclic carbonate comprises 1 or more hydroxylated alkyl groups.
194. The foamed polyurethane composition of any of Embodiments 149-193, wherein the at least one cyclic carbonate comprises 1 or more hydroxymethyl groups.
195. The foamed polyurethane composition of any of Embodiments 149-194, wherein the at least one cyclic carbonate comprises a single cyclic carbonate group.
196. The foamed polyurethane composition of any of Embodiments 149-195, wherein the at least one cyclic carbonate comprises more than one cyclic carbonate groups.
197. The foamed polyurethane composition of any of Embodiments 149-196, wherein the at least one cyclic carbonate comprises 1 or more 5 membered ring cyclic carbonate groups.
198. The foamed polyurethane composition of any of Embodiments 149-197, wherein the at least one cyclic carbonate comprises 1 or more 6 membered ring cyclic carbonate groups.
199. The foamed polyurethane composition of any of Embodiments 149-198, wherein the at least one cyclic carbonate comprises 1 or more 7 membered ring cyclic carbonate groups.
200. The foamed polyurethane composition of any of Embodiments 149-199, wherein the at least one cyclic carbonate comprises glycerol carbonate.
201. The foamed polyurethane composition of any of Embodiments 149-200, wherein the at least one cyclic carbonate comprises trimethylolpropane carbonate.
202. The foamed polyurethane composition of any of Embodiments 132-185 and 188-201 wherein the polyol composition is essentially free of polyhydroxylated aromatic compound.
203. The foamed polyurethane composition of any of Embodiments 132-182 and 184-202, wherein the at least one polyisocyanate functional component, the at least one polyisocyanate, latent polyisocyanate or mixture thereof is essentially free of aromatic components.
204. The foamed polyurethane composition of any of Embodiments 132-146, 149-182, 184, 188-190 and 192-203 which is essentially free of aromatic components.
205. A method of making a foamed polyurethane composition comprising: contacting 1 or more of foamable compositions of Embodiments 1-111 under conditions sufficient to form urethane linkages of a first polymeric or oligomeric polyurethane product in a first zone of a mixing device; contacting the first polymeric or oligomeric polyurethane product in a second zone of the mixing device to form a second polymeric or oligomeric polyurethane product containing the at least one blowing agent; and causing the blowing agent expand to provide the foamed polyurethane composition.
206. The method of Embodiment 205, wherein the mixing device is a reactive extruder.
207. The method of Embodiment 205, wherein the mixing device is a meter mixing system.
208. The method of any of Embodiments 205-207 wherein the second polymeric or oligomeric polyurethane product containing the at least one blowing agent is injected into a mold to provide the foamed polyurethane composition as a molded article.
209. The method of any of Embodiments 205-208, wherein the foamed polyurethane composition is produced as a foamed sheet.

1. A foamable composition comprising:
(a) from about 10 to about 70% by weight based on the total weight of the foamable composition of a polyol composition comprising:
(i) at least one monomeric polyol comprising 3 or more hydroxyl groups;
(ii) at least one higher polyol comprising 3 or more hydroxyl groups; and
optionally
(iii) at least one polyhydroxylated aromatic compound;
(b) from about 90 to about 30% by weight based on the total weight of the foamable composition of at least one polyisocyanate, latent polyisocyanate or mixture thereof; and
(c) from about 0.1% by weight to about 15 percent by weight based on the total weight of the foamable composition of at least one blowing agent;
wherein the at least one higher polyol comprises residues of either the at least one monomeric polyol or both of the at least one monomeric polyol and the polyhydroxylated aromatic compound, wherein the residues are linked by 1 or more carbonate groups, oxygen ether groups, or a combination thereof.

2. The foamable composition of claim 1, further comprising at least one cyclic carbonate comprising 1 or more hydroxyl groups.

3. (canceled)

4. The foamable composition of claim 1, wherein the polyol composition has a viscosity of less than 1000 cps at 150° F., wherein the viscosity is determined on a rheometer operated at steady state shear and variable temperature sweep according to standard instrument operating protocols furnished by the manufacturer.

5. (canceled)

6. The foamable composition of claim 1, further comprising at least one additive selected from the group consisting of nucleating agents, surfactants, flame retardants, cell openers, thermal stabilizers, ultraviolet light stabilizers, colorants and combinations thereof.

7. The foamable composition of claim 6, wherein, when present, the at least one additive is individually present in an amount from about 0.01% by weight to about 15% by weight based on the total weight of the foamable composition.

8. The foamable composition of claim 1, further comprising at least one filler.

9. The foamable composition of claim 8, wherein the at least one filler is present in an amount from greater than 0.1 to less than 60% by weight based on the total weight of the foamable composition.

10-13. (canceled)

14. The foamable composition of claim 2, wherein the cyclic carbonate is present in an amount from about 5% to about 40% by weight based on the total weight of the polyol composition.

15. The foamable composition of claim 1, wherein the at least one monomeric polyol or polyol comprises 3 or more secondary hydroxyl groups.

16. The foamable composition of claim 1, wherein the at least one monomeric polyol or polyol comprises 1 or more ether groups.

17. The foamable composition of claim 1, wherein the at least one monomeric polyol or polyol is tetrafunctional comprising 4 or more hydroxyl groups.

18. The foamable composition of claim 1, wherein the at least one monomeric polyol or polyol comprises 4 or more secondary hydroxyl groups.

19. The foamable composition of claim 1, wherein the at least one monomeric polyol comprises a mixture of polyols having an average molecular weight of less than 500 g/mol as determined from its hydroxyl number obtained using ASTM E222.

20. (canceled)

21. (canceled)

22. The foamable composition of claim 1, wherein the at least one higher polyol or polyol comprises 2 or more residues of the at least one monomeric polyol linked by one or more carbonate groups.

23. The foamable composition of claim 2, wherein the at least one cyclic carbonate comprises at least one hydroxyl group on a ring position of a cyclic carbonate ring.

24-28. (canceled)

29. The foamable composition of claim 1, wherein the at least one blowing agent comprises 1 or more of a physical blowing agent, a chemical blowing agent, or a combination thereof.

30. (canceled)

31. The foamable composition of claim 1, further comprising at least one catalyst.

32-34. (canceled)

35. A foamed article prepared from a foamable composition comprising:
(a) from about 10 to about 70% by weight based on the total weight of the foamable composition of a polyol composition comprising:
(i) at least one monomeric polyol comprising 3 or more hydroxyl groups;
(ii) at least one higher polyol comprising 3 or more hydroxyl groups; and
optionally
(iii) at least one polyhydroxylated aromatic compound;
(b) from about 90 to about 30% by weight based on the total weight of the foamable composition of at least one polyisocyanate, latent polyisocyanate or mixture thereof; and
(c) from about 0.1% by weight to about 15 percent by weight based on the total weight of the foamable composition of at least one blowing agent;
wherein the at least one higher polyol comprises residues of either the at least one monomeric polyol or both of the at least one monomeric polyol and the polyhydroxylated aromatic compound, wherein the residues are linked by 1 or more carbonate groups, oxygen ether groups, or a combination thereof, the foamed article comprising voids within a polyurethane matrix comprising residues of the polyol composition and residues of at least one polyisocyanate, latent polyisocyanate or mixture thereof, wherein the voids define open cells, closed cells or a combination thereof.

36. The foamed article of claim 35, having a compressive strength of 0.3 MPa or greater, a compressive modulus of 10 MPa or greater, or a density of 220 kg/m³ or less.

37. The foamed article of claim 35, which is a component of a vehicle, a structural component of a building, or a packaging system.

38-47. (canceled)
